(19) United States
(12) Patent Application Publication
(10) Pub. No.: US 2015/0172120 A1
(43) Pub. Date: Jun. 18, 2015

(54) MANAGING NON-CONFORMING ENTITIES IN INFORMATION MANAGEMENT SYSTEMS, INCLUDING ENFORCING CONFORMANCE WITH A MODEL ENTITY

(71) Applicant: CommVault Systems, Inc., Oceanport, NJ (US)

(72) Inventors: Bheemesh R. Dwarampudi, Jackson, NJ (US); Parag Gokhale, Marlboro, NJ (US); Jun Lu, Tinton Falls, NJ (US); Rajesh Polimera, Freehold, NJ (US)

(73) Assignee: CommVault Systems, Inc., Oceanport, NJ (US)

(21) Appl. No.: 14/105,024

(22) Filed: Dec. 12, 2013

(51) Int. Cl. H04L 12/24

(52) U.S. Cl. CPC H04L 41/0816

(57) ABSTRACT

An exemplary entity difference management system manages one or more properties of entities that operate within an organization's information management system(s) and/or information management cell(s), such that it enforces conformance with a given model entity by ensuring that one or more non-conforming entities are reconfigured to operate in accordance with one or more preferred operational properties of the model entity. The entity difference management system may manage across a plurality of information management systems, regardless of which information management system comprises the model entity. The following entities may be managed: information management cell(s) and/or associated storage manager(s), information management policies; secondary storage devices; client computing devices; sub-clients; data agents; and/or other elements of an information management system, without limitation. The illustrative system comprises an entity difference manager that interacts functionally with one or more storage managers within the information management cell(s).

### BACKGROUND

Businesses worldwide recognize the commercial value of their data and seek reliable, cost-effective ways to protect the information stored on their computer networks while minimizing impact on productivity. Protecting information is often part of a routine process that is performed within an organization.

A company might back up critical computing systems such as databases, file servers, web servers, and so on as part of a daily, weekly, or monthly maintenance schedule. The company may similarly protect computing systems used by each of its employees, such as those used by an accounting department, marketing department, engineering department, and so forth.

Given the rapidly expanding volume of data under management, companies also continue to seek innovative techniques for managing data growth, in addition to protecting data. For instance, companies often implement migration techniques for moving data to lower cost storage over time and data reduction techniques for reducing redundant data, pruning lower priority data, etc.

Enterprises also increasingly view their stored data as a valuable asset. Along these lines, customers are looking for solutions that not only protect and manage, but also leverage their data. For instance, solutions providing data analysis capabilities, information management, improved data presentation and access features, and the like, are in increasing demand.

### SUMMARY

When an organization owns/operates a relatively large and complex information management system or many information management systems, such as systems that move and manage data from primary to secondary storage, maintaining operational control can be challenging. For example, the many configured elements that operate throughout the information management system(s) may substantially diverge in terms of their operational properties. This may happen at set-up when administrators configure inconsistent properties; or it may happen over time as non-conforming changes and updates creep gradually into the system(s). The effect of non-conformance may range from an administrative inconvenience to possibly an illegality, such as when the information management system(s) fails to protect the organization's data according to governing laws. For example, data retention periods may be mandated by law and thus mis-administering a storage policy to a shorter retention period would be illegal.

An exemplary entity difference management system advantageously solves many of these non-conformance concerns. Accordingly, the illustrative system manages one or more properties of entities that operate within an organization's information management system(s) and/or information management cell(s), such that differences in operational properties of certain entities may be identified and, if need be, corrected by the illustrative system. The exemplary entity difference management system enforces conformance with a given model entity by ensuring that one or more non-conforming entities are reconfigured to operate in accordance with one or more preferred operational properties of the model entity. The entity difference management system may manage (including tracking, reporting, controlling, and enforcing conformance) across a plurality of information management systems, regardless of which information management system comprises the model entity.

Accordingly, the following entities may be managed: information management cell(s) and/or any associated storage manager(s); information management policies; secondary storage devices; client computing devices; sub-clients; data agents; media agents; and/or other elements of an information management system, without limitation. The illustrative system comprises an entity difference manager that interacts functionally with one or more storage managers within the information management cell(s) to effectuate the functionality described herein. Also, the respective storage manager that manages the information management system in a given information management cell interacts responsively with the entity difference manager to execute scripts, respond to queries, transmit information about entities it manages, and/or implement instructions received from the entity difference manager to reconfigure non-conforming entities such that they operate in conformance with the model entity.

A method according to an illustrative embodiment comprises: controlling a plurality of entities that operate in an information management system, by a storage manager that manages the information management system, to operate according to preferred operational properties of a model entity, wherein the controlling is based on a determination, by an entity difference manager that is communicatively coupled to the storage manager, that prior to the determination the plurality of entities were operating in the information management system according to one or more respective operational properties that substantially differed from the operational properties of the model entity; and wherein the controlling comprises: receiving, by the storage manager from the entity difference manager, one or more instructions directing the storage manager to reconfigure the plurality of entities to operate according to the operational properties of the model entity, and reconfiguring, by the storage manager in response to the one or more instructions, the plurality of entities to operate according to the operational properties of the model entity. Further, the model entity is configured to operate in one of (i) the information management system, and (ii) another information management system that is managed by a second storage manager that is communicatively coupled to the entity difference manager. Further, after the reconfiguring, the second entity operates according to the same operational properties as the model entity. Further, the model entity may be an information management cell that comprises the storage manager. Further, the model entity may be a storage manager other than the storage manager that managers the information management system. Further, the model entity may be an information management policy. Further, the model entity may be a storage policy. Further, the information management system comprises a secondary storage subsystem, and further wherein the model entity may be an element of the secondary storage subsystem. Further, the model entity may be a secondary storage device. Further, the model entity may be a client. Further, the model entity may be a sub-client. Further, the model entity may be a data agent.

Another illustrative method comprises: reconfiguring, by a storage manager as instructed by an entity difference manager, a second entity in an information management system, wherein the information management system is managed by the storage manager and comprises a secondary storage subsystem; wherein the reconfiguring is based on a first operational property of a first entity that is designated a model entity; wherein the reconfiguring comprises: receiving, by the storage manager, an instruction from the entity difference manager directing the storage manager to reconfigure the second entity, and based on the received instruction, changing, by the storage manager, a second operational property of the second entity to match the first operational property of the model entity; and wherein the model entity is configured to operate in one of (i) the information management system, and (ii) another information management system that is managed by another storage manager that is communicatively coupled to the entity difference manager. The method wherein the reconfiguring further comprises: extracting, by the storage manager, based on one or more messages received from the entity difference manager, information about one or more operational properties of the second entity, and transmitting, by the storage manager, the extracted information to the entity difference manager. The method wherein the extracting comprises polling the second entity for the information about the one or more operational properties of the second entity. Further, the model entity may be an element of the secondary storage subsystem.

An illustrative system comprises: an entity difference manager that is communicatively coupled to one or more storage managers, wherein each storage manager manages a respective information management system that comprises a secondary storage subsystem; a data store associated with the entity difference manager, wherein the data store comprises information about one or more operational properties of one or more entities that are operating in the one or more respective information management systems; wherein the entity difference manager comprises an analysis module that is configured to: designate a first entity as a model entity that is configured to operate according to one or more preferred operational properties, obtain, from the data store, one or more operational properties of a second entity that has been operating in the information management system, and determine that the second entity is a non-conforming entity that has been operating in the respective information management system according to one or more operational properties that substantially differ from the one or more preferred operational properties of the model entity; and wherein the entity difference manager is configured to direct the storage manager that manages the information management system comprising the non-conforming entity that the non-conforming entity is to be reconfigured to operate according to the one or more preferred operational properties of the model entity. The system may further comprise a user interface unit that is communicatively coupled to the entity difference manager, wherein, based on a user input received via the user interface unit, the analysis module is configured to designate the first entity as the model entity.

Another illustrative system comprises: an entity difference manager; a storage manager that manages an information management system comprising a secondary storage subsystem, wherein the storage manager is communicatively coupled to the entity difference manager; wherein the entity difference manager is configured to: determine that the information management system comprises a non-conforming entity that operates according to operational properties that substantially differ from preferred operational properties of a model entity, and instruct the storage manager to reconfigure the non-conforming entity to operate according to the preferred operational properties of the model entity; and wherein the storage manager is configured to change the one or more operational properties of the non-conforming entity to match the one or more preferred operational properties of the model entity in response to one or more instructions received from the entity difference manager. Further, the model entity may be configured to operate in a different information management system from the information management system that comprises the non-conforming entity.

The illustrative method(s) may further comprise: transmitting, by the storage manager to at least one of the entity difference manager and a data store associated with the entity difference manager, information about the operational properties of the plurality of entities. The illustrative method(s) may also comprise: receiving, by the storage manager from the entity difference manager, one or more instructions directing the storage manager to collect information about the operational properties of the plurality of entities, and transmitting, by the storage manager to at least one of the entity difference manager and a data store associated with the entity difference manager, information about the operational properties of the plurality of entities. In the illustrative method(s) the changing of the second operational property of the second entity to match the first operational property of the model entity may comprise changing a value of the second operational property to another value according to the first operational property. In the illustrative method(s) the changing of the second operational property of the second entity to match the first operational property of the model entity may comprise replacing the second operational property of the second entity with the first operational property. In the illustrative method(s) the reconfiguring may further comprise: extracting, by the storage manager, information about one or more operational properties of the second entity, and transmitting, by the storage manager, the extracted information to the entity difference manager. In the illustrative method(s) and system(s), the model entity may be an audit policy and/or a provisioning policy.

Another illustrative method comprises: designating, by an entity difference manager, a first entity as a model entity, wherein the model entity is configured to operate in a first information management system managed by a first storage manager, and further wherein the model entity is configured to operate according to one or more preferred operational properties; identifying, by the entity difference manager, a second entity as a non-conforming entity, wherein the second entity is currently operating according to one or more operational properties that substantially differ from the one or more preferred operational properties of the model entity; when the non-conforming entity operates in the first information management system managed by the first storage manager, transmitting by the entity difference manager one or more instructions to the first storage manager to reconfigure the second entity to operate according to the preferred operational properties of the model entity; and when the non-conforming entity operates in a second information management system managed by a second storage manager, transmitting by the entity difference manager one or more instructions to the second storage manager to reconfigure the second entity to operate according to the preferred operational properties of the model entity. The method may further comprise wherein, in response to receiving the one or more instructions from the entity difference manager, the one or more operational properties of the non-conforming entity are changed, by the respective first or second storage manager, to match the one or more operational properties of the model entity.

Another illustrative method comprises: ensuring, by an entity difference manager, that one or more non-conforming entities are reconfigured in a first information management system to operate according to one or more preferred operational properties of a model entity, wherein the ensuring comprises: designating the model entity, by the entity difference manager, wherein the model entity is configured to operate in an information management system; identifying, by the entity difference manager, the one or more non-conforming entities when the one or more operational properties thereof substantially differ from the one or more preferred operational properties of the model entity; composing, by the entity difference manager, one or more instructions to a first storage manager that managers the first information management system to reconfigure the one or more non-conforming entities to operate according to the preferred operational properties of the model entity; transmitting the one or more instructions, by the entity difference manager to the first storage manager. The method may further comprise: wherein the ensuring further comprises: receiving, by the first storage manager, the one or more instructions from the entity difference manager, and based on the one or more instructions, changing, by the first storage manager, one or more operational properties of the one or more non-conforming entities to match the one or more operational properties of the model entity. Further, the model entity may be configured to operate in at least one of (i) the first information management system, and (ii) a second information management system that is managed by a second storage manager that is communicatively coupled to the entity difference manager.

An illustrative system comprises: an information management system wherein a plurality of entities are controlled to operate in the information management system according to preferred operational properties of a model entity, based on: a previous determination, by an entity difference manager that is communicatively coupled to a storage manager that manages the information management system, that the plurality of entities operated according to one or more respective operational properties that substantially differed from the preferred operational properties of the model entity, one or more instructions received by the storage manager from the entity difference manager, the one or more instructions directing the storage manager to reconfigure the plurality of entities to operate according to the operational properties of the model entity, and one or more administrative operations, performed by the storage manager in response to the one or more received instructions, wherein the one or more administrative operations reconfigured the plurality of entities to operate according to the operational properties of the model entity. The system may further comprise: the entity difference manager; and a data store associated with the entity difference manager, wherein the data store comprises information about the operational properties of the plurality of entities received from the storage manager. In the system, the storage manager may be configured to periodically transmit information about the operational properties of the plurality of entities to the entity difference manager. In the system, the control over the plurality of entities may be further based on: one or more instructions, received by the storage manager from the entity difference manager, the instructions directing the storage manager to collect information about the operational properties of the plurality of entities, and wherein the storage manager is configured to transmit the collected information about the operational properties of the plurality of entities to the entity difference manager.

An illustrative computer-readable storage medium whose contents cause a computing device to perform a method comprising: controlling a plurality of entities that operate in an information management system, by a storage manager that manages the information management system, to operate according to preferred operational properties of a model entity, wherein the controlling is based on a determination, by an entity difference manager that is communicatively coupled to the storage manager, that prior to the determination the plurality of entities were operating in the information management system according to one or more respective operational properties that substantially differed from the operational properties of the model entity; and wherein the controlling comprises: receiving, by the storage manager from the entity difference manager, one or more instructions directing the storage manager to reconfigure the plurality of entities to operate according to the operational properties of the model entity, and reconfiguring, by the storage manager in response to the one or more instructions, the plurality of entities to operate according to the operational properties of the model entity.

An illustrative computer-readable storage medium whose contents cause a computing device to perform a method comprising: reconfiguring, by a storage manager as instructed by an entity difference manager, a second entity in an information management system, wherein the information management system is managed by the storage manager and comprises a secondary storage subsystem; wherein the reconfiguring is based on a first operational property of a first entity that is designated a model entity; wherein the reconfiguring comprises: receiving, by the storage manager, an instruction from the entity difference manager directing the storage manager to reconfigure the second entity, and based on the received instruction, changing, by the storage manager, a second operational property of the second entity to match the first operational property of the model entity; and wherein the model entity is configured to operate in one of (i) the information management system, and (ii) another information management system that is managed by another storage manager that is communicatively coupled to the entity difference manager.

### BRIEF DESCRIPTION OF THE DRAWINGS

FIG. 1A is a block diagram illustrating an exemplary information management system.

FIG. 1B is a detailed view of a primary storage device, a secondary storage device, and some examples of primary data and secondary copy data.

FIG. 1C is a block diagram of an exemplary information management system including a storage manager, one or more data agents, and one or more media agents.

FIG. 1D is a block diagram illustrating a scalable information management system.

FIG. 1E illustrates certain secondary copy operations according to an exemplary storage policy.

FIGS. 1F-1H are block diagrams illustrating suitable data structures that may be employed by the information management system.

FIG. 2 depicts an exemplary entity difference management system 200 according to an illustrative embodiment of the present invention.

FIG. 3 depicts an illustrative detail view of information management cell 203-1 comprising storage manager 140-1 that is communicatively coupled to entity difference manager 201.

FIG. 4A depicts an illustrative detail view of storage manager 140-1, which is communicatively coupled to entity difference manager 201 via communication link 205-1

FIG. 4B depicts an illustrative detail view of storage managers 140-1 and 140-2, each of which is communicatively coupled to entity difference manager 201 via communication links 205-1 and 205-2, respectively.

FIG. 5 depicts an illustrative detail view of entity difference manager 201, which is communicatively coupled to one or more storage managers 140 via respective communication links 205.

FIG. 6 depicts some salient operations of exemplary method 600 according to an illustrative embodiment. Illustratively, method 600 is performed by entity difference manager 201, including one or more constituent modules thereof.

FIG. 7 depicts some salient operations of block 607 in method 600.

FIG. 8 depicts some salient operations of block 609 in method 600.

FIG. 9 depicts some salient operations of exemplary method 900 according to an illustrative embodiment.

FIG. 10A depicts an exemplary visual presentation on display/user interface 507 that reports on an exemplary audit of entities that are storage policies.

FIG. 10B depicts an exemplary visual presentation on display/user interface 507 that reports entity-by-entity details on non-conforming storage policies in a given information management cell, according to an exemplary entity audit.

FIG. 11A depicts an exemplary visual presentation on display/user interface 507 that reports on an exemplary entity audit of entities that are libraries.

FIG. 11B depicts an exemplary visual presentation on display/user interface 507 that reports entity-by-entity details on non-conforming libraries in a given information management cell, according to an exemplary entity audit.

FIG. 12 depicts an exemplary visual presentation on display/user interface 507 that reports on an exemplary audit of entities that are media agents.

### DETAILED DESCRIPTION

### Information Management System Overview

With the increasing importance of protecting and leveraging data, organizations simply cannot afford to take the risk of losing critical data. Moreover, runaway data growth and other modern realities make protecting and managing data an increasingly difficult task. There is therefore a need for efficient, powerful, and user-friendly solutions for protecting and managing data.

Depending on the size of the organization, there are typically many data production sources which are under the purview of tens, hundreds, or even thousands of employees or other individuals. In the past, individual employees were sometimes responsible for managing and protecting their data. A patchwork of hardware and software point solutions has been applied in other cases. These solutions were often provided by different vendors and had limited or no interoperability.

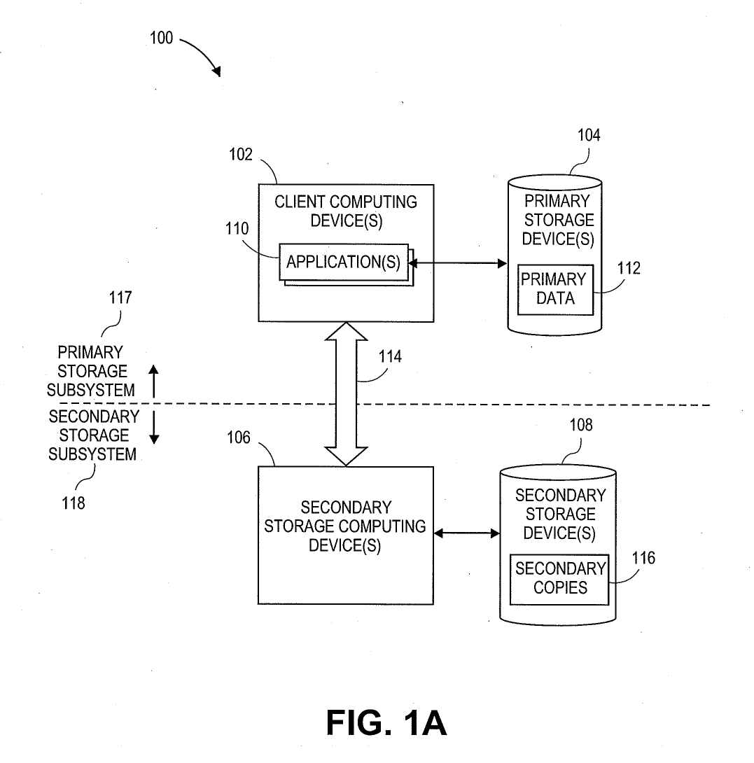

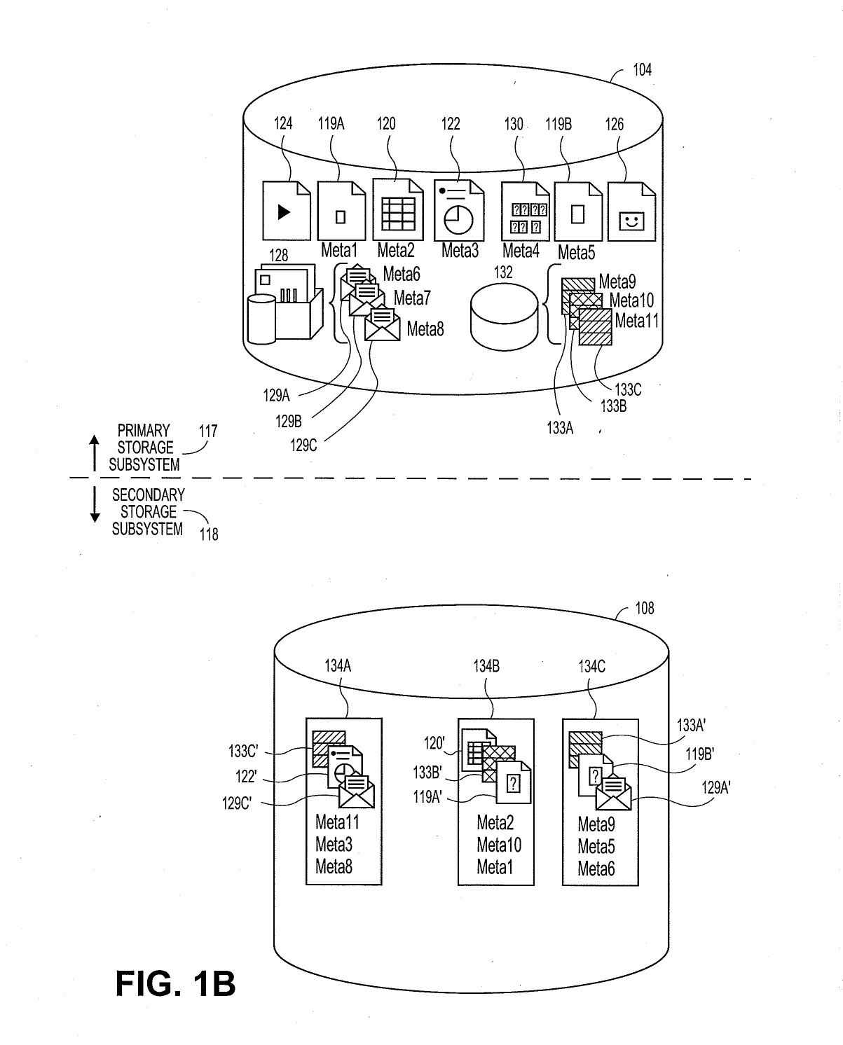

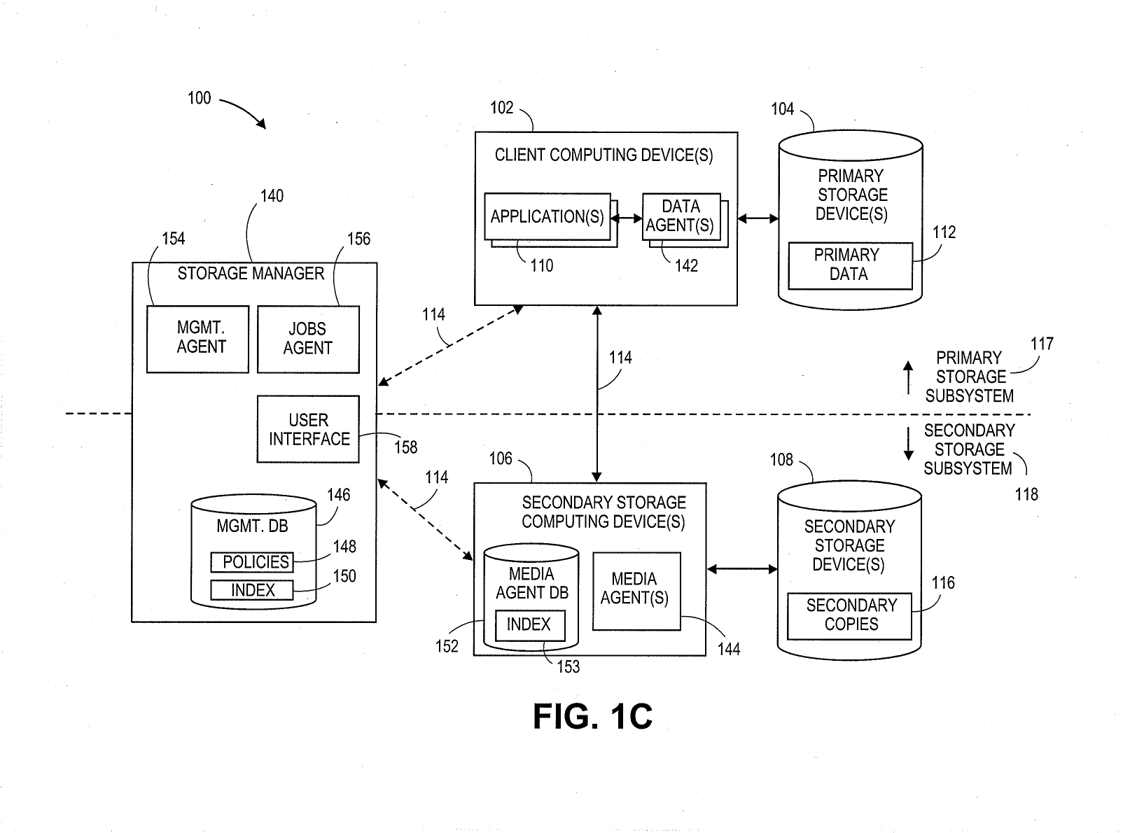

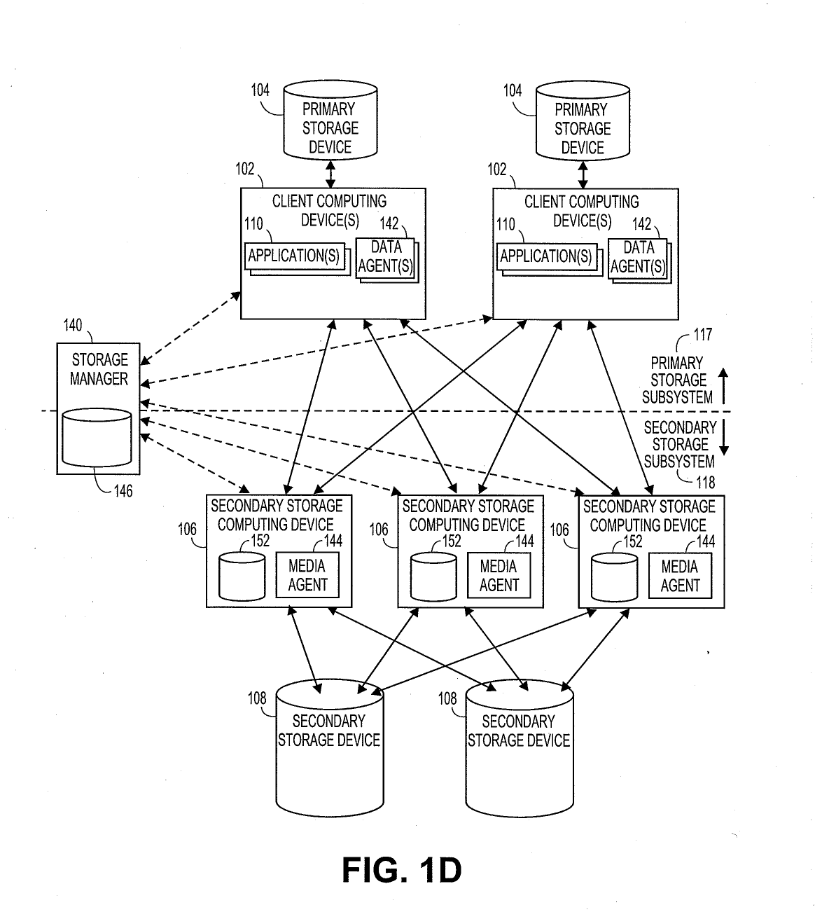

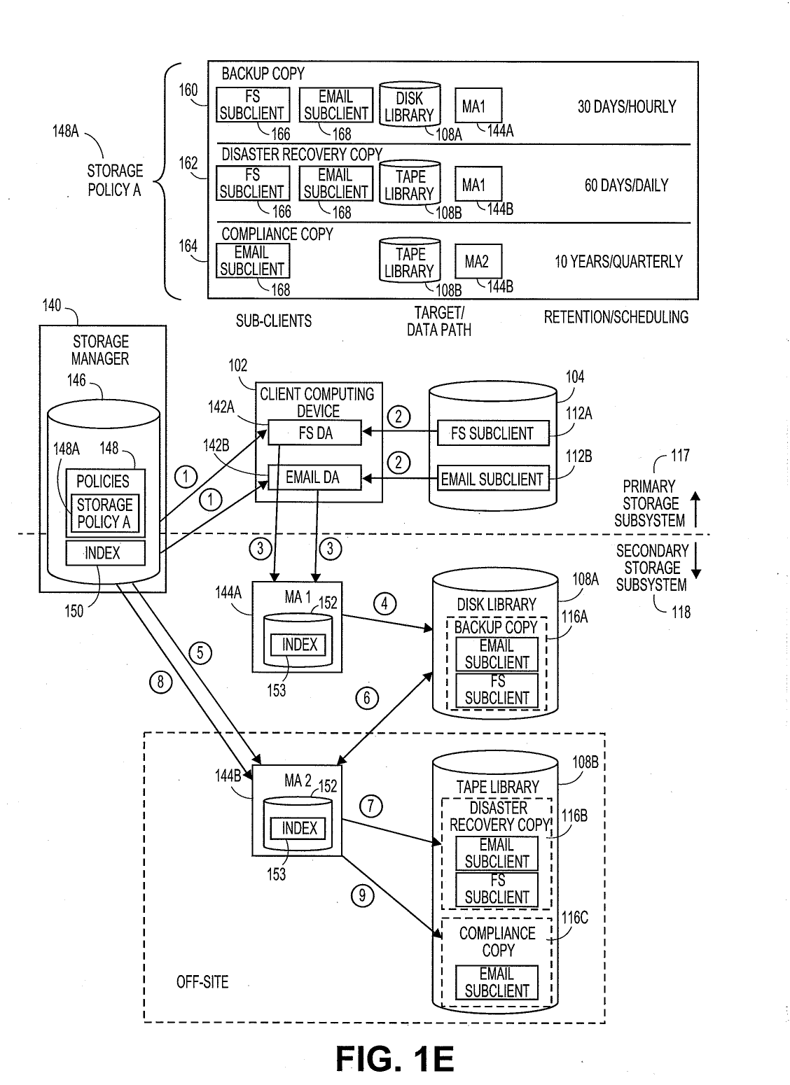

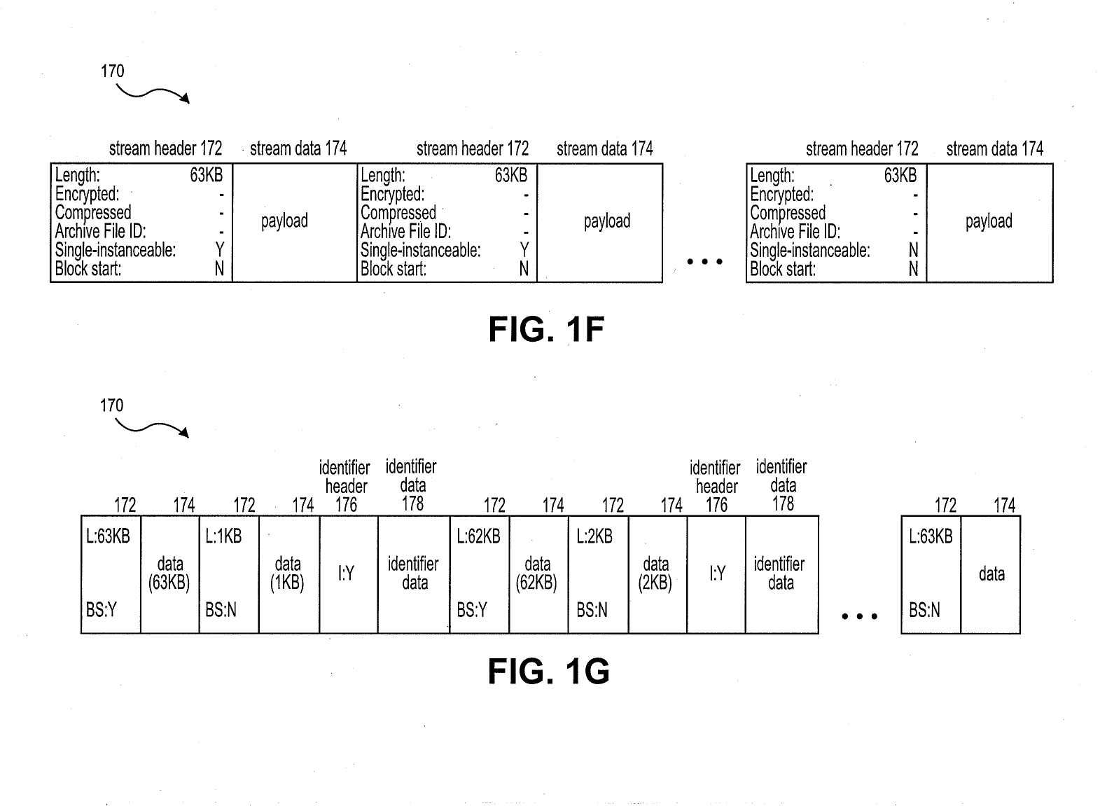

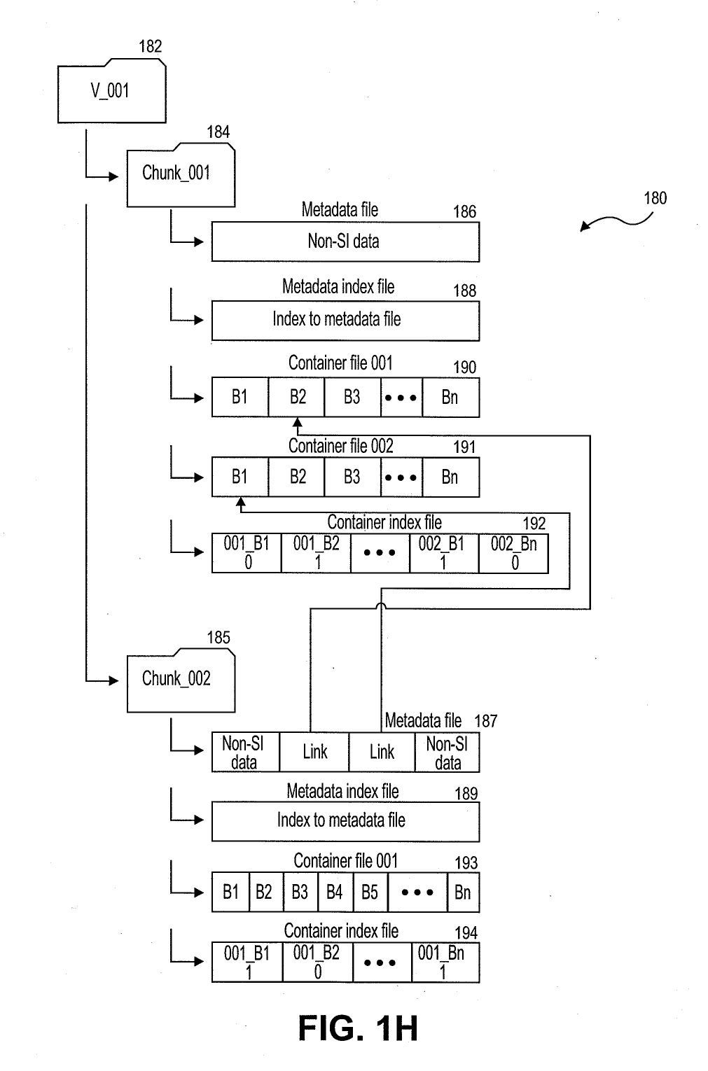

Certain embodiments described herein provide systems and methods capable of addressing these and other shortcomings of prior approaches by implementing unified, organization-wide information management. FIG. 1A shows one such information management system 100, which generally includes combinations of hardware and software configured to protect and manage data and metadata generated and used by the various computing devices in the information management system 100.

The organization which employs the information management system 100 may be a corporation or other business entity, non-profit organization, educational institution, household, governmental agency, or the like.

Generally, the systems and associated components described herein may be compatible with and/or provide some or all of the functionality of the systems and corresponding components described in one or more of the following U.S. patents and patent application publications assigned to CommVault Systems, Inc., each of which is hereby incorporated in its entirety by reference herein:
U.S. Pat. No. 8,285,681, entitled “Data Object Store and Server for a Cloud Storage Environment, Including Data Deduplication and Data Management Across Multiple Cloud Storage Sites”;
U.S. Pat. No. 8,307,177, entitled “Systems And Methods For Management Of Virtualization Data”;
U.S. Pat. No. 7,035,880, entitled “Modular Backup and Retrieval System Used in Conjunction With a Storage Area Network”;
U.S. Pat. No. 7,343,453, entitled “Hierarchical Systems and Methods for Providing a Unified View of Storage Information”;
U.S. Pat. No. 7,395,282, entitled “Hierarchical Backup and Retrieval System”;
U.S. Pat. No. 7,246,207, entitled “System and Method for Dynamically Performing Storage Operations in a Computer Network”;
U.S. Pat. No. 7,747,579, entitled “Metabase for Facilitating Data Classification”;
U.S. Pat. No. 8,229,954, entitled “Managing Copies of Data”;
U.S. Pat. No. 7,617,262, entitled “System and Methods for Monitoring Application Data in a Data Replication System”;
U.S. Pat. No. 7,529,782, entitled “System and Methods for Performing a Snapshot and for Restoring Data”;
U.S. Pat. No. 8,230,195, entitled “System And Method For Performing Auxiliary Storage Operations”;
U.S. Pat. No. 7,315,923, entitled “System And Method For Combining Data Streams In Pipelined Storage Operations In A Storage Network”;
U.S. Pat. No. 8,364,652, entitled “Content-Aligned, Block-Based Deduplication”;
U.S. Pat. Pub. No. 2006/0224846, entitled “System and Method to Support Single Instance Storage Operations”;
U.S. Pat. Pub. No. 2010/0299490, entitled “Block-Level Single Instancing”;
U.S. Pat. Pub. No. 2009/0319534, entitled “Application-Aware and Remote Single Instance Data Management”;
U.S. Pat. Pub. No. 2012/0150826, entitled “Distributed Deduplicated Storage System”;
U.S. Pat. Pub. No. 2012/0150818, entitled “Client-Side Repository in a Networked Deduplicated Storage System”;
U.S. Pat. No. 8,170,995, entitled “Method and System for Offline Indexing of Content and Classifying Stored Data”;
U.S. Pat. No. 7,107,298, entitled “System And Method For Archiving Objects In An Information Store”;
U.S. Pat. No. 8,230,195, entitled “System And Method For Performing Auxiliary Storage Operations”;
U.S. Pat. No. 8,229,954, entitled “Managing Copies Of Data”; and
U.S. Pat. No. 8,156,086, entitled “Systems And Methods For Stored Data Verification”.

The information management system 100 can include a variety of different computing devices. For instance, as will be described in greater detail herein, the information management system 100 can include one or more client computing devices 102 and secondary storage computing devices 106.

Computing devices can include, without limitation, one or more: workstations, personal computers, desktop computers, or other types of generally fixed computing systems such as mainframe computers and minicomputers.

Other computing devices can include mobile or portable computing devices, such as one or more laptops, tablet computers, personal data assistants, mobile phones (such as smartphones), and other mobile or portable computing devices such as embedded computers, set top boxes, vehicle-mounted devices, wearable computers, etc. Computing devices can include servers, such as mail servers, file servers, database servers, and web servers.

In some cases, a computing device includes virtualized and/or cloud computing resources. For instance, one or more virtual machines may be provided to the organization by a third-party cloud service vendor. Or, in some embodiments, computing devices can include one or more virtual machine(s) running on a physical host computing device (or “host machine”) operated by the organization. As one example, the organization may use one virtual machine as a database server and another virtual machine as a mail server, both virtual machines operating on the same host machine.

A virtual machine includes an operating system and associated virtual resources, and is hosted simultaneously with another operating system on a physical host computer (or host machine). A hypervisor (typically software, and also known in the art as a virtual machine monitor or a virtual machine manager or “VMM”) sits between the virtual machine and the hardware of the physical host computer. One example of hypervisor as virtualization software is ESX Server, by VMware, Inc. of Palo Alto, Calif.; other examples include Microsoft Virtual Server and Microsoft Windows Server Hyper-V, both by Microsoft Corporation of Redmond, Wash., and Sun xVM by Oracle America Inc. of Santa Clara, Calif. In some embodiments, the hypervisor may be firmware or hardware or a combination of software and/or firmware and/or hardware.

The hypervisor provides to each virtual operating system virtual resources, such as a virtual processor, virtual memory, a virtual network device, and a virtual disk. Each virtual machine has one or more virtual disks. The hypervisor typically stores the data of virtual disks in files on the file system of the physical host computer, called virtual machine disk files (in the case of VMware virtual servers) or virtual hard disk image files (in the case of Microsoft virtual servers). For example, VMware's ESX Server provides the Virtual Machine File System (VMFS) for the storage of virtual machine disk files. A virtual machine reads data from and writes data to its virtual disk much the same way that an actual physical machine reads data from and writes data to an actual disk.

Examples of techniques for implementing information management techniques in a cloud computing environment are described in U.S. Pat. No. 8,285,681, which is incorporated by reference herein. Examples of techniques for implementing information management techniques in a virtualized computing environment are described in U.S. Pat. No. 8,307,177, also incorporated by reference herein.

The information management system 100 can also include a variety of storage devices, including primary storage devices 104 and secondary storage devices 108, for example. Storage devices can generally be of any suitable type including, without limitation, disk drives, hard-disk arrays, semiconductor memory (e.g., solid state storage devices), network attached storage (NAS) devices, tape libraries or other magnetic, non-tape storage devices, optical media storage devices, DNA/RNA-based memory technology, combinations of the same, and the like. In some embodiments, storage devices can form part of a distributed file system. In some cases, storage devices are provided in a cloud (e.g., a private cloud or one operated by a third-party vendor). A storage device in some cases comprises a disk array or portion thereof.

The illustrated information management system 100 includes one or more client computing device 102 having at least one application 110 executing thereon, and one or more primary storage devices 104 storing primary data 112. The client computing device(s) 102 and the primary storage devices 104 may generally be referred to in some cases as a primary storage subsystem 117. A computing device in an information management system 100 that has a data agent 142 installed on it is generally referred to as a client computing device 102 (or, in the context of a component of the information management system 100 simply as a “client”).

Depending on the context, the term “information management system” can refer to generally all of the illustrated hardware and software components. Or, in other instances, the term may refer to only a subset of the illustrated components.

For instance, in some cases, the information management system 100 generally refers to a combination of specialized components used to protect, move, manage, manipulate, analyze, and/or process data and metadata generated by the client computing devices 102. However, the information management system 100 in some cases does not include the underlying components that generate and/or store the primary data 112, such as the client computing devices 102 themselves, the applications 110 and operating system residing on the client computing devices 102, and the primary storage devices 104. As an example, “information management system” may sometimes refer to one or more of the following components and corresponding data structures: storage managers, data agents, and media agents. These components will be described in further detail below.

### Client Computing Devices

There are typically a variety of sources in an organization that produce data to be protected and managed. As just one illustrative example, in a corporate environment such data sources can be employee workstations and company servers such as a mail server, a web server, or the like. In the information management system 100, the data generation sources include the one or more client computing devices 102.

The client computing devices 102 may include any of the types of computing devices described above, without limitation, and in some cases the client computing devices 102 are associated with one or more users and/or corresponding user accounts, of employees or other individuals.

The information management system 100 generally addresses and handles the data management and protection needs for the data generated by the client computing devices 102. However, the use of this term does not imply that the client computing devices 102 cannot be “servers” in other respects. For instance, a particular client computing device 102 may act as a server with respect to other devices, such as other client computing devices 102. As just a few examples, the client computing devices 102 can include mail servers, file servers, database servers, and web servers.

Each client computing device 102 may have one or more applications 110 (e.g., software applications) executing thereon which generate and manipulate the data that is to be protected from loss and managed.

The applications 110 generally facilitate the operations of an organization (or multiple affiliated organizations), and can include, without limitation, mail server applications (e.g., Microsoft Exchange Server), file server applications, mail client applications (e.g., Microsoft Exchange Client), database applications (e.g., SQL, Oracle, SAP, Lotus Notes Database), word processing applications (e.g., Microsoft Word), spreadsheet applications, financial applications, presentation applications, browser applications, mobile applications, entertainment applications, and so on.

The client computing devices 102 can have at least one operating system (e.g., Microsoft Windows, Mac OS X, iOS, IBM z/OS, Linux, other Unix-based operating systems, etc.) installed thereon, which may support or host one or more file systems and other applications 110.

As shown, the client computing devices 102 and other components in the information management system 100 can be connected to one another via one or more communication pathways 114. The communication pathways 114 can include one or more networks or other connection types including as any of following, without limitation: the Internet, a wide area network (WAN), a local area network (LAN), a Storage Area Network (SAN), a Fibre Channel connection, a Small Computer System Interface (SCSI) connection, a virtual private network (VPN), a token ring or TCP/IP based network, an intranet network, a point-to-point link, a cellular network, a wireless data transmission system, a two-way cable system, an interactive kiosk network, a satellite network, a broadband network, a baseband network, a neural network, a mesh network, an ad hoc network, other appropriate wired, wireless, or partially wired/wireless computer or telecommunications networks, combinations of the same or the like. The communication pathways 114 in some cases may also include application programming interfaces (APIs) including, e.g., cloud service provider APIs, virtual machine management APIs, and hosted service provider APIs.

### Primary Data and Exemplary Primary Storage Devices

Primary data 112 according to some embodiments is production data or other “live” data generated by the operating system and other applications 110 residing on a client computing device 102. The primary data 112 is generally stored on the primary storage device(s) 104 and is organized via a file system supported by the client computing device 102. For instance, the client computing device(s) 102 and corresponding applications 110 may create, access, modify, write, delete, and otherwise use primary data 112. In some cases, some or all of the primary data 112 can be stored in cloud storage resources.

Primary data 112 is generally in the native format of the source application 110. According to certain aspects, primary data 112 is an initial or first (e.g., created before any other copies or before at least one other copy) stored copy of data generated by the source application 110. Primary data 112 in some cases is created substantially directly from data generated by the corresponding source applications 110.

The primary data 112 may sometimes be referred to as a “primary copy” in the sense that it is a discrete set of data. However, the use of this term does not necessarily imply that the “primary copy” is a copy in the sense that it was copied or otherwise derived from another stored version.

The primary storage devices 104 storing the primary data 112 may be relatively fast and/or expensive (e.g., a disk drive, a hard-disk array, solid state memory, etc.). In addition, primary data 112 may be intended for relatively short term retention (e.g., several hours, days, or weeks).

According to some embodiments, the client computing device 102 can access primary data 112 from the primary storage device 104 by making conventional file system calls via the operating system. Primary data 112 representing files may include structured data (e.g., database files), unstructured data (e.g., documents), and/or semi-structured data. Some specific examples are described below with respect to FIG. 1B.

It can be useful in performing certain tasks to organize the primary data 112 into units of different granularities. In general, primary data 112 can include files, directories, file system volumes, data blocks, extents, or any other hierarchies or organizations of data objects. As used herein, a “data object” can refer to both (1) any file that is currently addressable by a file system or that was previously addressable by the file system (e.g., an archive file) and (2) a subset of such a file (e.g., a data block).

As will be described in further detail, it can also be useful in performing certain functions of the information management system 100 to access and modify metadata within the primary data 112. Metadata generally includes information about data objects or characteristics associated with the data objects.

Metadata can include, without limitation, one or more of the following: the data owner (e.g., the client or user that generates the data), the last modified time (e.g., the time of the most recent modification of the data object), a data object name (e.g., a file name), a data object size (e.g., a number of bytes of data), information about the content (e.g., an indication as to the existence of a particular search term), user-supplied tags, to/from information for email (e.g., an email sender, recipient, etc.), creation date, file type (e.g., format or application type), last accessed time, application type (e.g., type of application that generated the data object), location/network (e.g., a current, past or future location of the data object and network pathways to/from the data object), geographic location (e.g., GPS coordinates), frequency of change (e.g., a period in which the data object is modified), business unit (e.g., a group or department that generates, manages or is otherwise associated with the data object), aging information (e.g., a schedule, such as a time period, in which the data object is migrated to secondary or long term storage), boot sectors, partition layouts, file location within a file folder directory structure, user permissions, owners, groups, access control lists [ACLs]), system metadata (e.g., registry information), combinations of the same or the other similar information related to the data object.

In addition to metadata generated by or related to file systems and operating systems, some of the applications 110 and/or other components of the information management system 100 maintain indices of metadata for data objects, e.g., metadata associated with individual email messages. Thus, each data object may be associated with corresponding metadata. The use of metadata to perform classification and other functions is described in greater detail below.

Each of the client computing devices 102 are generally associated with and/or in communication with one or more of the primary storage devices 104 storing corresponding primary data 112. A client computing device 102 may be considered to be “associated with” or “in communication with” a primary storage device 104 if it is capable of one or more of: routing and/or storing data to the particular primary storage device 104, coordinating the routing and/or storing of data to the particular primary storage device 104, retrieving data from the particular primary storage device 104, coordinating the retrieval of data from the particular primary storage device 104, and modifying and/or deleting data retrieved from the particular primary storage device 104.

The primary storage devices 104 can include any of the different types of storage devices described above, or some other kind of suitable storage device. The primary storage devices 104 may have relatively fast I/O times and/or are relatively expensive in comparison to the secondary storage devices 108. For example, the information management system 100 may generally regularly access data and metadata stored on primary storage devices 104, whereas data and metadata stored on the secondary storage devices 108 is accessed relatively less frequently.

In some cases, each primary storage device 104 is dedicated to an associated client computing device 102. For instance, a primary storage device 104 in one embodiment is a local disk drive of a corresponding client computing device 102. In other cases, one or more primary storage devices 104 can be shared by multiple client computing devices 102, e.g., via a network such as in a cloud storage implementation. As one example, a primary storage device 104 can be a disk array shared by a group of client computing devices 102, such as one of the following types of disk arrays: EMC Clariion, EMC Symmetrix, EMC Celerra, Dell EqualLogic, IBM XIV, NetApp FAS, HP EVA, and HP 3PAR.

The information management system 100 may also include hosted services (not shown), which may be hosted in some cases by an entity other than the organization that employs the other components of the information management system 100. For instance, the hosted services may be provided by various online service providers to the organization. Such service providers can provide services including social networking services, hosted email services, or hosted productivity applications or other hosted applications).

Hosted services may include software-as-a-service (SaaS), platform-as-a-service (PaaS), application service providers (ASPs), cloud services, or other mechanisms for delivering functionality via a network. As it provides services to users, each hosted service may generate additional data and metadata under management of the information management system 100, e.g., as primary data 112. In some cases, the hosted services may be accessed using one of the applications 110. As an example, a hosted mail service may be accessed via browser running on a client computing device 102. The hosted services may be implemented in a variety of computing environments. In some cases, they are implemented in an environment having a similar arrangement to the information management system 100, where various physical and logical components are distributed over a network.

### Secondary Copies and Exemplary Secondary Storage Devices

The primary data 112 stored on the primary storage devices 104 may be compromised in some cases, such as when an employee deliberately or accidentally deletes or overwrites primary data 112 during their normal course of work. Or the primary storage devices 104 can be damaged or otherwise corrupted.

For recovery and/or regulatory compliance purposes, it is therefore useful to generate copies of the primary data 112. Accordingly, the information management system 100 includes one or more secondary storage computing devices 106 and one or more secondary storage devices 108 configured to create and store one or more secondary copies 116 of the primary data 112 and associated metadata. The secondary storage computing devices 106 and the secondary storage devices 108 may sometimes be referred to as a secondary storage subsystem 118.

Creation of secondary copies 116 can help in search and analysis efforts and meet other information management goals, such as: restoring data and/or metadata if an original version (e.g., of primary data 112) is lost (e.g., by deletion, corruption, or disaster); allowing point-in-time recovery; complying with regulatory data retention and electronic discovery (e-discovery) requirements; reducing utilized storage capacity; facilitating organization and search of data; improving user access to data files across multiple computing devices and/or hosted services; and implementing data retention policies.

The client computing devices 102 access or receive primary data 112 and communicate the data, e.g., over the communication pathways 114, for storage in the secondary storage device(s) 108.

A secondary copy 116 can comprise a separate stored copy of application data that is derived from one or more earlier-created, stored copies (e.g., derived from primary data 112 or another secondary copy 116). Secondary copies 116 can include point-in-time data, and may be intended for relatively long-term retention (e.g., weeks, months or years), before some or all of the data is moved to other storage or is discarded.

In some cases, a secondary copy 116 is a copy of application data created and stored subsequent to at least one other stored instance (e.g., subsequent to corresponding primary data 112 or to another secondary copy 116), in a different storage device than at least one previous stored copy, and/or remotely from at least one previous stored copy. In some other cases, secondary copies can be stored in the same storage device as primary data 112 and/or other previously stored copies. For example, in one embodiment a disk array capable of performing hardware snapshots stores primary data 112 and creates and stores hardware snapshots of the primary data 112 as secondary copies 116. Secondary copies 116 may be stored in relatively slow and/or low cost storage (e.g., magnetic tape). A secondary copy 116 may be stored in a backup or archive format, or in some other format different than the native source application format or other primary data format.

In some cases, secondary copies 116 are indexed so users can browse and restore at another point in time. After creation of a secondary copy 116 representative of certain primary data 112, a pointer or other location indicia (e.g., a stub) may be placed in primary data 112, or be otherwise associated with primary data 112 to indicate the current location on the secondary storage device(s) 108.

Since an instance of a data object or metadata in primary data 112 may change over time as it is modified by an application 110 (or hosted service or the operating system), the information management system 100 may create and manage multiple secondary copies 116 of a particular data object or metadata, each representing the state of the data object in primary data 112 at a particular point in time. Moreover, since an instance of a data object in primary data 112 may eventually be deleted from the primary storage device 104 and the file system, the information management system 100 may continue to manage point-in-time representations of that data object, even though the instance in primary data 112 no longer exists.

For virtualized computing devices the operating system and other applications 110 of the client computing device(s) 102 may execute within or under the management of virtualization software (e.g., a VMM), and the primary storage device(s) 104 may comprise a virtual disk created on a physical storage device. The information management system 100 may create secondary copies 116 of the files or other data objects in a virtual disk file and/or secondary copies 116 of the entire virtual disk file itself (e.g., of an entire .vmdk file).

Secondary copies 116 may be distinguished from corresponding primary data 112 in a variety of ways, some of which will now be described. First, as discussed, secondary copies 116 can be stored in a different format (e.g., backup, archive, or other non-native format) than primary data 112. For this or other reasons, secondary copies 116 may not be directly useable by the applications 110 of the client computing device 102, e.g., via standard system calls or otherwise without modification, processing, or other intervention by the information management system 100.

Secondary copies 116 are also in some embodiments stored on a secondary storage device 108 that is inaccessible to the applications 110 running on the client computing devices 102 (and/or hosted services). Some secondary copies 116 may be “offline copies,” in that they are not readily available (e.g., not mounted to tape or disk). Offline copies can include copies of data that the information management system 100 can access without human intervention (e.g., tapes within an automated tape library, but not yet mounted in a drive), and copies that the information management system 100 can access only with at least some human intervention (e.g., tapes located at an offsite storage site).

### The Use of Intermediate Devices for Creating Secondary Copies

Creating secondary copies can be a challenging task. For instance, there can be hundreds or thousands of client computing devices 102 continually generating large volumes of primary data 112 to be protected. Also, there can be significant overhead involved in the creation of secondary copies 116. Moreover, secondary storage devices 108 may be special purpose components, and interacting with them can require specialized intelligence.

In some cases, the client computing devices 102 interact directly with the secondary storage device 108 to create the secondary copies 116. However, in view of the factors described above, this approach can negatively impact the ability of the client computing devices 102 to serve the applications 110 and produce primary data 112. Further, the client computing devices 102 may not be optimized for interaction with the secondary storage devices 108.

Thus, in some embodiments, the information management system 100 includes one or more software and/or hardware components which generally act as intermediaries between the client computing devices 102 and the secondary storage devices 108. In addition to off-loading certain responsibilities from the client computing devices 102, these intermediate components can provide other benefits. For instance, as discussed further below with respect to FIG. 1D, distributing some of the work involved in creating secondary copies 116 can enhance scalability.

The intermediate components can include one or more secondary storage computing devices 106 as shown in FIG. 1A and/or one or more media agents, which can be software modules residing on corresponding secondary storage computing devices 106 (or other appropriate devices). Media agents are discussed below (e.g., with respect to FIGS. 1C-1E).

The secondary storage computing device(s) 106 can comprise any of the computing devices described above, without limitation. In some cases, the secondary storage computing device(s) 106 include specialized hardware and/or software componentry for interacting with the secondary storage devices 108.

To create a secondary copy 116 involving the copying of data from the primary storage subsystem 117 to the secondary storage subsystem 118, the client computing device 102 in some embodiments communicates the primary data 112 to be copied (or a processed version thereof) to the designated secondary storage computing device 106, via the communication pathway 114. The secondary storage computing device 106 in turn conveys the received data (or a processed version thereof) to the secondary storage device 108. In some such configurations, the communication pathway 114 between the client computing device 102 and the secondary storage computing device 106 comprises a portion of a LAN, WAN or SAN. In other cases, at least some client computing devices 102 communicate directly with the secondary storage devices 108 (e.g., via Fibre Channel or SCSI connections). In some other cases, one or more secondary copies 116 are created from existing secondary copies, such as in the case of an auxiliary copy operation, described in greater detail below.

### Exemplary Primary Data and an Exemplary Secondary Copy

FIG. 1B is a detailed view showing some specific examples of primary data stored on the primary storage device(s) 104 and secondary copy data stored on the secondary storage device(s) 108, with other components in the system removed for the purposes of illustration. Stored on the primary storage device(s) 104 are primary data objects including word processing documents 119A-B, spreadsheets 120, presentation documents 122, video files 124, image files 126, email mailboxes 128 (and corresponding email messages 129A-C), html/xml or other types of markup language files 130, databases 132 and corresponding tables or other data structures 133A-133C).

Some or all primary data objects are associated with corresponding metadata (e.g., “Meta1-11”), which may include file system metadata and/or application specific metadata. Stored on the secondary storage device(s) 108 are secondary copy data objects 134A-C which may include copies of or otherwise represent corresponding primary data objects and metadata.

As shown, the secondary copy data objects 134A-C can individually represent more than one primary data object. For example, secondary copy data object 134A represents three separate primary data objects 133C, 122 and 129C (represented as 133C′, 122′ and 129C′, respectively, and accompanied by the corresponding metadata Meta11, Meta3, and Meta8, respectively). Moreover, as indicated by the prime mark (′), a secondary copy object may store a representation of a primary data object or metadata differently than the original format, e.g., in a compressed, encrypted, deduplicated, or other modified format. Likewise, secondary data object 134B represents primary data objects 120, 133B, and 119A as 120′, 133B′, and 119A′, respectively and accompanied by corresponding metadata Meta2, Meta10, and Meta1, respectively. Also, secondary data object 134C represents primary data objects 133A, 119B, and 129A as 133A′, 119B′, and 129A′, respectively, accompanied by corresponding metadata Meta9, Meta5, and Meta6, respectively.

### Exemplary Information Management System Architecture

The information management system 100 can incorporate a variety of different hardware and software components, which can in turn be organized with respect to one another in many different configurations, depending on the embodiment. There are critical design choices involved in specifying the functional responsibilities of the components and the role of each component in the information management system 100. For instance, as will be discussed, such design choices can impact performance as well as the adaptability of the information management system 100 to data growth or other changing circumstances.

FIG. 1C shows an information management system 100 designed according to these considerations and which includes: storage manager 140, a centralized storage and/or information manager that is configured to perform certain control functions, one or more data agents 142 executing on the client computing device(s) 102 configured to process primary data 112, and one or more media agents 144 executing on the one or more secondary storage computing devices 106 for performing tasks involving the secondary storage devices 108. While distributing functionality amongst multiple computing devices can have certain advantages, in other contexts it can be beneficial to consolidate functionality on the same computing device. As such, in various other embodiments, one or more of the components shown in FIG. 1C as being implemented on separate computing devices are implemented on the same computing device. In one configuration, a storage manager 140, one or more data agents 142, and one or more media agents 144 are all implemented on the same computing device. In another embodiment, one or more data agents 142 and one or more media agents 144 are implemented on the same computing device, while the storage manager 140 is implemented on a separate computing device.

### Storage Manager

As noted, the number of components in the information management system 100 and the amount of data under management can be quite large. Managing the components and data is therefore a significant task, and a task that can grow in an often unpredictable fashion as the quantity of components and data scale to meet the needs of the organization.

For these and other reasons, according to certain embodiments, responsibility for controlling the information management system 100, or at least a significant portion of that responsibility, is allocated to the storage manager 140.

By distributing control functionality in this manner, the storage manager 140 can be adapted independently according to changing circumstances. Moreover, a computing device for hosting the storage manager 140 can be selected to best suit the functions of the storage manager 140. These and other advantages are described in further detail below with respect to FIG. 1D.

The storage manager 140 may be a software module or other application. In some embodiments, storage manager 140 is a computing device comprising circuitry for executing computer instructions and performs the functions described herein. The storage manager generally initiates, performs, coordinates and/or controls storage and other information management operations performed by the information management system 100, e.g., to protect and control the primary data 112 and secondary copies 116 of data and metadata.

As shown by the dashed arrowed lines 114, the storage manager 140 may communicate with and/or control some or all elements of the information management system 100, such as the data agents 142 and media agents 144. Thus, in certain embodiments, control information originates from the storage manager 140, whereas payload data and payload metadata is generally communicated between the data agents 142 and the media agents 144 (or otherwise between the client computing device(s) 102 and the secondary storage computing device(s) 106), e.g., at the direction of the storage manager 140. Control information can generally include parameters and instructions for carrying out information management operations, such as, without limitation, instructions to perform a task associated with an operation, timing information specifying when to initiate a task associated with an operation, data path information specifying what components to communicate with or access in carrying out an operation, and the like. Payload data, on the other hand, can include the actual data involved in the storage operation, such as content data written to a secondary storage device 108 in a secondary copy operation. Payload metadata can include any of the types of metadata described herein, and may be written to a storage device along with the payload content data (e.g., in the form of a header).

In other embodiments, some information management operations are controlled by other components in the information management system 100 (e.g., the media agent(s) 144 or data agent(s) 142), instead of or in combination with the storage manager 140.

According to certain embodiments, the storage manager 140 provides one or more of the following functions:
initiating execution of secondary copy operations;
managing secondary storage devices 108 and inventory/capacity of the same;
reporting, searching, and/or classification of data in the information management system 100;
allocating secondary storage devices 108 for secondary storage operations;
monitoring completion of and providing status reporting related to secondary storage operations;
tracking age information relating to secondary copies 116, secondary storage devices 108, and comparing the age information against retention guidelines;
tracking movement of data within the information management system 100;
tracking logical associations between components in the information management system 100;
protecting metadata associated with the information management system 100; and
implementing operations management functionality.

The storage manager 140 may maintain a database 146 (or “storage manager database 146” or “management database 146”) of management-related data and information management policies 148. The database 146 may include a management index 150 (or “index 150”) or other data structure that stores logical associations between components of the system, user preferences and/or profiles (e.g., preferences regarding encryption, compression, or deduplication of primary or secondary copy data, preferences regarding the scheduling, type, or other aspects of primary or secondary copy or other operations, mappings of particular information management users or user accounts to certain computing devices or other components, etc.), management tasks, media containerization, or other useful data. For example, the storage manager 140 may use the index 150 to track logical associations between media agents 144 and secondary storage devices 108 and/or movement of data from primary storage devices 104 to secondary storage devices 108. For instance, the index 150 may store data associating a client computing device 102 with a particular media agent 144 and/or secondary storage device 108, as specified in an information management policy 148 (e.g., a storage policy, which is defined in more detail below).

Administrators and other employees may be able to manually configure and initiate certain information management operations on an individual basis. But while this may be acceptable for some recovery operations or other relatively less frequent tasks, it is often not workable for implementing on-going organization-wide data protection and management.

Thus, the information management system 100 may utilize information management policies 148 for specifying and executing information management operations (e.g., on an automated basis). Generally, an information management policy 148 can include a data structure or other information source that specifies a set of parameters (e.g., criteria and rules) associated with storage or other information management operations.

The storage manager database 146 may maintain the information management policies 148 and associated data, although the information management policies 148 can be stored in any appropriate location. For instance, an information management policy 148 such as a storage policy may be stored as metadata in a media agent database 152 or in a secondary storage device 108 (e.g., as an archive copy) for use in restore operations or other information management operations, depending on the embodiment. Information management policies 148 are described further below.

According to certain embodiments, the storage manager database 146 comprises a relational database (e.g., an SQL database) for tracking metadata, such as metadata associated with secondary copy operations (e.g., what client computing devices 102 and corresponding data were protected). This and other metadata may additionally be stored in other locations, such as at the secondary storage computing devices 106 or on the secondary storage devices 108, allowing data recovery without the use of the storage manager 140.

As shown, the storage manager 140 may include a jobs agent 156, a user interface 158, and a management agent 154, all of which may be implemented as interconnected software modules or application programs.

The jobs agent 156 in some embodiments initiates, controls, and/or monitors the status of some or all storage or other information management operations previously performed, currently being performed, or scheduled to be performed by the information management system 100. For instance, the jobs agent 156 may access information management policies 148 to determine when and how to initiate and control secondary copy and other information management operations, as will be discussed further.

The user interface 158 may include information processing and display software, such as a graphical user interface (“GUI”), an application program interface (“API”), or other interactive interface(s) through which users and system processes can retrieve information about the status of information management operations (e.g., storage operations) or issue instructions to the information management system 100 and its constituent components.

Via the user interface 158, users may optionally issue instructions to the components in the information management system 100 regarding performance of storage and recovery operations. For example, a user may modify a schedule concerning the number of pending secondary copy operations. As another example, a user may employ the GUI to view the status of pending storage operations or to monitor the status of certain components in the information management system 100 (e.g., the amount of capacity left in a storage device).

An information management “cell” may generally include a logical and/or physical grouping of a combination of hardware and software components associated with performing information management operations on electronic data, typically one storage manager 140 and at least one client computing device 102 (comprising data agent(s) 142) and at least one media agent 144. For instance, the components shown in FIG. 1C may together form an information management cell. Multiple cells may be organized hierarchically. With this configuration, cells may inherit properties from hierarchically superior cells or be controlled by other cells in the hierarchy (automatically or otherwise). Alternatively, in some embodiments, cells may inherit or otherwise be associated with information management policies, preferences, information management metrics, or other properties or characteristics according to their relative position in a hierarchy of cells. Cells may also be delineated and/or organized hierarchically according to function, geography, architectural considerations, or other factors useful or desirable in performing information management operations. A first cell may represent a geographic segment of an enterprise, such as a Chicago office, and a second cell may represent a different geographic segment, such as a New York office. Other cells may represent departments within a particular office. Where delineated by function, a first cell may perform one or more first types of information management operations (e.g., one or more first types of secondary or other copies), and a second cell may perform one or more second types of information management operations (e.g., one or more second types of secondary or other copies).

The storage manager 140 may also track information that permits it to select, designate, or otherwise identify content indices, deduplication databases, or similar databases or resources or data sets within its information management cell (or another cell) to be searched in response to certain queries. Such queries may be entered by the user via interaction with the user interface 158. In general, the management agent 154 allows multiple information management cells to communicate with one another. For example, the information management system 100 in some cases may be one information management cell of a network of multiple cells adjacent to one another or otherwise logically related in a WAN or LAN. With this arrangement, the cells may be connected to one another through respective management agents 154.

For instance, the management agent 154 can provide the storage manager 140 with the ability to communicate with other components within the information management system 100 (and/or other cells within a larger information management system) via network protocols and application programming interfaces (“APIs”) including, e.g., HTTP, HTTPS, FTP, REST, virtualization software APIs, cloud service provider APIs, and hosted service provider APIs. Inter-cell communication and hierarchy is described in greater detail in U.S. Pat. Nos. 7,747,579 and 7,343,453, which are incorporated by reference herein.

### Data Agents

As discussed, a variety of different types of applications 110 can reside on a given client computing device 102, including operating systems, database applications, e-mail applications, and virtual machines, just to name a few. And, as part of the process of creating and restoring secondary copies 116, the client computing devices 102 may be tasked with processing and preparing the primary data 112 from these various different applications 110. Moreover, the nature of the processing/preparation can differ across clients and application types, e.g., due to inherent structural and formatting differences between applications 110.

The one or more data agent(s) 142 are therefore advantageously configured in some embodiments to assist in the performance of information management operations based on the type of data that is being protected, at a client-specific and/or application-specific level.

The data agent 142 may be a software module or component that is generally responsible for managing, initiating, or otherwise assisting in the performance of information management operations. For instance, the data agent 142 may take part in performing data storage operations such as the copying, archiving, migrating, replicating of primary data 112 stored in the primary storage device(s) 104. The data agent 142 may receive control information from the storage manager 140, such as commands to transfer copies of data objects, metadata, and other payload data to the media agents 144.

In some embodiments, a data agent 142 may be distributed between the client computing device 102 and storage manager 140 (and any other intermediate components) or may be deployed from a remote location or its functions approximated by a remote process that performs some or all of the functions of data agent 142. In addition, a data agent 142 may perform some functions provided by a media agent 144, or may perform other functions such as encryption and deduplication.

As indicated, each data agent 142 may be specialized for a particular application 110, and the system can employ multiple application-specific data agents 142, each of which may perform information management operations (e.g., perform backup, migration, and data recovery) associated with a different application 110. For instance, different individual data agents 142 may be designed to handle Microsoft Exchange data, Lotus Notes data, Microsoft Windows file system data, Microsoft Active Directory Objects data, SQL Server data, SharePoint data, Oracle database data, SAP database data, virtual machines and/or associated data, and other types of data.

A file system data agent, for example, may handle data files and/or other file system information. If a client computing device 102 has two or more types of data, one data agent 142 may be used for each data type to copy, archive, migrate, and restore the client computing device 102 data. For example, to backup, migrate, and restore all of the data on a Microsoft Exchange server, the client computing device 102 may use one Microsoft Exchange Mailbox data agent 142 to backup the Exchange mailboxes, one Microsoft Exchange Database data agent 142 to backup the Exchange databases, one Microsoft Exchange Public Folder data agent 142 to backup the Exchange Public Folders, and one Microsoft Windows File System data agent 142 to backup the file system of the client computing device 102. In such embodiments, these data agents 142 may be treated as four separate data agents 142 even though they reside on the same client computing device 102.

Other embodiments may employ one or more generic data agents 142 that can handle and process data from two or more different applications 110, or that can handle and process multiple data types, instead of or in addition to using specialized data agents 142. For example, one generic data agent 142 may be used to back up, migrate and restore Microsoft Exchange Mailbox data and Microsoft Exchange Database data while another generic data agent may handle Microsoft Exchange Public Folder data and Microsoft Windows File System data.

Each data agent 142 may be configured to access data and/or metadata stored in the primary storage device(s) 104 associated with the data agent 142 and process the data as appropriate. For example, during a secondary copy operation, the data agent 142 may arrange or assemble the data and metadata into one or more files having a certain format (e.g., a particular backup or archive format) before transferring the file(s) to a media agent 144 or other component. The file(s) may include a list of files or other metadata. Each data agent 142 can also assist in restoring data or metadata to primary storage devices 104 from a secondary copy 116. For instance, the data agent 142 may operate in conjunction with the storage manager 140 and one or more of the media agents 144 to restore data from secondary storage device(s) 108.

### Media Agents

As indicated above with respect to FIG. 1A, off-loading certain responsibilities from the client computing devices 102 to intermediate components such as the media agent(s) 144 can provide a number of benefits including improved client computing device 102 operation, faster secondary copy operation performance, and enhanced scalability. As one specific example which will be discussed below in further detail, the media agent 144 can act as a local cache of copied data and/or metadata that it has stored to the secondary storage device(s) 108, providing improved restore capabilities.

Generally speaking, a media agent 144 may be implemented as a software module that manages, coordinates, and facilitates the transmission of data, as directed by the storage manager 140, between a client computing device 102 and one or more secondary storage devices 108. Whereas the storage manager 140 controls the operation of the information management system 100, the media agent 144 generally provides a portal to secondary storage devices 108. For instance, other components in the system interact with the media agents 144 to gain access to data stored on the secondary storage devices 108, whether it be for the purposes of reading, writing, modifying, or deleting data. Moreover, as will be described further, media agents 144 can generate and store information relating to characteristics of the stored data and/or metadata, or can generate and store other types of information that generally provides insight into the contents of the secondary storage devices 108.

Media agents 144 can comprise separate nodes in the information management system 100 (e.g., nodes that are separate from the client computing devices 102, storage manager 140, and/or secondary storage devices 108). In general, a node within the information management system 100 can be a logically and/or physically separate component, and in some cases is a component that is individually addressable or otherwise identifiable. In addition, each media agent 144 may reside on a dedicated secondary storage computing device 106 in some cases, while in other embodiments a plurality of media agents 144 reside on the same secondary storage computing device 106.

A media agent 144 (and corresponding media agent database 152) may be considered to be “associated with” a particular secondary storage device 108 if that media agent 144 is capable of one or more of: routing and/or storing data to the particular secondary storage device 108, coordinating the routing and/or storing of data to the particular secondary storage device 108, retrieving data from the particular secondary storage device 108, coordinating the retrieval of data from a particular secondary storage device 108, and modifying and/or deleting data retrieved from the particular secondary storage device 108.

While media agent(s) 144 are generally associated with one or more secondary storage devices 108, one or more media agents 144 in certain embodiments are physically separate from the secondary storage devices 108. For instance, the media agents 144 may reside on secondary storage computing devices 106 having different housings or packages than the secondary storage devices 108. In one example, a media agent 144 resides on a first server computer and is in communication with a secondary storage device(s) 108 residing in a separate, rack-mounted RAID-based system.

Where the information management system 100 includes multiple media agents 144 (FIG. 1D), a first media agent 144 may provide failover functionality for a second, failed media agent 144. In addition, media agents 144 can be dynamically selected for storage operations to provide load balancing. Failover and load balancing are described in greater detail below.

In operation, a media agent 144 associated with a particular secondary storage device 108 may instruct the secondary storage device 108 to perform an information management operation. For instance, a media agent 144 may instruct a tape library to use a robotic arm or other retrieval means to load or eject a certain storage media, and to subsequently archive, migrate, or retrieve data to or from that media, e.g., for the purpose of restoring the data to a client computing device 102. As another example, a secondary storage device 108 may include an array of hard disk drives or solid state drives organized in a RAID configuration, and the media agent 144 may forward a logical unit number (LUN) and other appropriate information to the array, which uses the received information to execute the desired storage operation. The media agent 144 may communicate with a secondary storage device 108 via a suitable communications link, such as a SCSI or Fiber Channel link.

As shown, each media agent 144 may maintain an associated media agent database 152. The media agent database 152 may be stored in a disk or other storage device (not shown) that is local to the secondary storage computing device 106 on which the media agent 144 resides. In other cases, the media agent database 152 is stored remotely from the secondary storage computing device 106.

The media agent database 152 can include, among other things, an index 153 including data generated during secondary copy operations and other storage or information management operations. The index 153 provides a media agent 144 or other component with a fast and efficient mechanism for locating secondary copies 116 or other data stored in the secondary storage devices 108. In some cases, the index 153 does not form a part of and is instead separate from the media agent database 152.

A media agent index 153 or other data structure associated with the particular media agent 144 may include information about the stored data. For instance, for each secondary copy 116, the index 153 may include metadata such as a list of the data objects (e.g., files/subdirectories, database objects, mailbox objects, etc.), a path to the secondary copy 116 on the corresponding secondary storage device 108, location information indicating where the data objects are stored in the secondary storage device 108, when the data objects were created or modified, etc. Thus, the index 153 includes metadata associated with the secondary copies 116 that is readily available for use in storage operations and other activities without having to be first retrieved from the secondary storage device 108. In yet further embodiments, some or all of the data in the index 153 may instead or additionally be stored along with the data in a secondary storage device 108, e.g., with a copy of the index 153. In some embodiments, the secondary storage devices 108 can include sufficient information to perform a “bare metal restore”, where the operating system of a failed client computing device 102 or other restore target is automatically rebuilt as part of a restore operation.

Because the index 153 maintained in the media agent database 152 may operate as a cache, it can also be referred to as “an index cache.” In such cases, information stored in the index cache 153 typically comprises data that reflects certain particulars about storage operations that have occurred relatively recently. After some triggering event, such as after a certain period of time elapses, or the index cache 153 reaches a particular size, the index cache 153 may be copied or migrated to a secondary storage device(s) 108. This information may need to be retrieved and uploaded back into the index cache 153 or otherwise restored to a media agent 144 to facilitate retrieval of data from the secondary storage device(s) 108. In some embodiments, the cached information may include format or containerization information related to archives or other files stored on the storage device(s) 108. In this manner, the index cache 153 allows for accelerated restores.

In some alternative embodiments the media agent 144 generally acts as a coordinator or facilitator of storage operations between client computing devices 102 and corresponding secondary storage devices 108, but does not actually write the data to the secondary storage device 108. For instance, the storage manager 140 (or the media agent 144) may instruct a client computing device 102 and secondary storage device 108 to communicate with one another directly. In such a case the client computing device 102 transmits the data directly or via one or more intermediary components to the secondary storage device 108 according to the received instructions, and vice versa. In some such cases, the media agent 144 may still receive, process, and/or maintain metadata related to the storage operations. Moreover, in these embodiments, the payload data can flow through the media agent 144 for the purposes of populating the index cache 153 maintained in the media agent database 152, but not for writing to the secondary storage device 108.

The media agent 144 and/or other components such as the storage manager 140 may in some cases incorporate additional functionality, such as data classification, content indexing, deduplication, encryption, compression, and the like. Further details regarding these and other functions are described below.

### Distributed, Scalable Architecture

As described, certain functions of the information management system 100 can be distributed amongst various physical and/or logical components in the system. For instance, one or more of the storage manager 140, data agents 142, and media agents 144 may reside on computing devices that are physically separate from one another. This architecture can provide a number of benefits.

For instance, hardware and software design choices for each distributed component can be targeted to suit its particular function. The secondary computing devices 106 on which the media agents 144 reside can be tailored for interaction with associated secondary storage devices 108 and provide fast index cache operation, among other specific tasks. Similarly, the client computing device(s) 102 can be selected to effectively service the applications 110 residing thereon, in order to efficiently produce and store primary data 112.

Moreover, in some cases, one or more of the individual components in the information management system 100 can be distributed to multiple, separate computing devices. As one example, for large file systems where the amount of data stored in the database 146 is relatively large, the database 146 may be migrated to or otherwise reside on a specialized database server (e.g., an SQL server) separate from a server that implements the other functions of the storage manager 140. This configuration can provide added protection because the database 146 can be protected with standard database utilities (e.g., SQL log shipping or database replication) independent from other functions of the storage manager 140. The database 146 can be efficiently replicated to a remote site for use in the event of a disaster or other data loss incident at the primary site. Or the database 146 can be replicated to another computing device within the same site, such as to a higher performance machine in the event that a storage manager host device can no longer service the needs of a growing information management system 100.

The distributed architecture also provides both scalability and efficient component utilization. FIG. 1D shows an embodiment of the information management system 100 including a plurality of client computing devices 102 and associated data agents 142 as well as a plurality of secondary storage computing devices 106 and associated media agents 144.

Additional components can be added or subtracted based on the evolving needs of the information management system 100. For instance, depending on where bottlenecks are identified, administrators can add additional client computing devices 102, secondary storage computing devices 106 (and corresponding media agents 144), and/or secondary storage devices 108. Moreover, where multiple fungible components are available, load balancing can be implemented to dynamically address identified bottlenecks. As an example, the storage manager 140 may dynamically select which media agents 144 and/or secondary storage devices 108 to use for storage operations based on a processing load analysis of the media agents 144 and/or secondary storage devices 108, respectively.

Moreover, each client computing device 102 in some embodiments can communicate with, among other components, any of the media agents 144, e.g., as directed by the storage manager 140. And each media agent 144 may be able to communicate with, among other components, any of the secondary storage devices 108, e.g., as directed by the storage manager 140. Thus, operations can be routed to the secondary storage devices 108 in a dynamic and highly flexible manner, to provide load balancing, failover, and the like. Further examples of scalable systems capable of dynamic storage operations, and of systems capable of performing load balancing and fail over are provided in U.S. Pat. No. 7,246,207, which is incorporated by reference herein.

In alternative configurations, certain components are not distributed and may instead reside and execute on the same computing device. For example, in some embodiments one or more data agents 142 and the storage manager 140 reside on the same client computing device 102. In another embodiment, one or more data agents 142 and one or more media agents 144 reside on a single computing device.

### Exemplary Types of Information Management Operations

In order to protect and leverage stored data, the information management system 100 can be configured to perform a variety of information management operations. As will be described, these operations can generally include secondary copy and other data movement operations, processing and data manipulation operations, analysis, reporting, and management operations. The operations described herein may be performed on any type of computing platform, e.g., between two computers connected via a LAN, to a mobile client telecommunications device connected to a server via a WLAN, to any manner of client device coupled to a cloud storage target.

### Data Movement Operations

Data movement operations according to certain embodiments are generally operations that involve the copying or migration of data (e.g., payload data) between different locations in the information management system 100 in an original/native and/or one or more different formats. For example, data movement operations can include operations in which stored data is copied, migrated, or otherwise transferred from one or more first storage devices to one or more second storage devices, such as from primary storage device(s) 104 to secondary storage device(s) 108, from secondary storage device(s) 108 to different secondary storage device(s) 108, from secondary storage devices 108 to primary storage devices 104, or from primary storage device(s) 104 to different primary storage device(s) 104.

Data movement operations can include by way of example, backup operations, archive operations, information lifecycle management operations such as hierarchical storage management operations, replication operations (e.g., continuous data replication operations), snapshot operations, deduplication or single-instancing operations, auxiliary copy operations, and the like. As will be discussed, some of these operations involve the copying, migration or other movement of data, without actually creating multiple, distinct copies. Nonetheless, some or all of these operations are referred to as “copy” operations for simplicity.

Backup Operations

A backup operation creates a copy of a version of data (e.g., one or more files or other data units) in primary data 112 at a particular point in time. Each subsequent backup copy may be maintained independently of the first. Further, a backup copy in some embodiments is generally stored in a form that is different than the native format, e.g., a backup format. This can be in contrast to the version in primary data 112 from which the backup copy is derived, and which may instead be stored in a native format of the source application(s) 110. In various cases, backup copies can be stored in a format in which the data is compressed, encrypted, deduplicated, and/or otherwise modified from the original application format. For example, a backup copy may be stored in a backup format that facilitates compression and/or efficient long-term storage.

Backup copies can have relatively long retention periods as compared to primary data 112, and may be stored on media with slower retrieval times than primary data 112 and certain other types of secondary copies 116. On the other hand, backups may have relatively shorter retention periods than some other types of secondary copies 116, such as archive copies (described below). Backups may sometimes be stored at on offsite location.

Backup operations can include full, synthetic or incremental backups. A full backup in some embodiments is generally a complete image of the data to be protected. However, because full backup copies can consume a relatively large amount of storage, it can be useful to use a full backup copy as a baseline and only store changes relative to the full backup copy for subsequent backup copies.

For instance, a differential backup operation (or cumulative incremental backup operation) tracks and stores changes that have occurred since the last full backup. Differential backups can grow quickly in size, but can provide relatively efficient restore times because a restore can be completed in some cases using only the full backup copy and the latest differential copy.

An incremental backup operation generally tracks and stores changes since the most recent backup copy of any type, which can greatly reduce storage utilization. In some cases, however, restore times can be relatively long in comparison to full or differential backups because completing a restore operation may involve accessing a full backup in addition to multiple incremental backups.

Any of the above types of backup operations can be at the volume-level, file-level, or block-level. Volume level backup operations generally involve the copying of a data volume (e.g., a logical disk or partition) as a whole. In a file-level backup, the information management system 100 may generally track changes to individual files at the file-level, and includes copies of files in the backup copy. In the case of a block-level backup, files are broken into constituent blocks, and changes are tracked at the block-level. Upon restore, the information management system 100 reassembles the blocks into files in a transparent fashion.

Far less data may actually be transferred and copied to the secondary storage devices 108 during a file-level copy than a volume-level copy. Likewise, a block-level copy may involve the transfer of less data than a file-level copy, resulting in faster execution times. However, restoring a relatively higher-granularity copy can result in longer restore times. For instance, when restoring a block-level copy, the process of locating constituent blocks can sometimes result in longer restore times as compared to file-level backups. Similar to backup operations, the other types of secondary copy operations described herein can also be implemented at either the volume-level, file-level, or block-level.

Archive Operations

Because backup operations generally involve maintaining a version of the copied data in primary data 112 and also maintaining backup copies in secondary storage device(s) 108, they can consume significant storage capacity. To help reduce storage consumption, an archive operation according to certain embodiments creates a secondary copy 116 by both copying and removing source data. Or, seen another way, archive operations can involve moving some or all of the source data to the archive destination. Thus, data satisfying criteria for removal (e.g., data of a threshold age or size) from the source copy may be removed from source storage. Archive copies are sometimes stored in an archive format or other non-native application format. The source data may be primary data 112 or a secondary copy 116, depending on the situation. As with backup copies, archive copies can be stored in a format in which the data is compressed, encrypted, deduplicated, and/or otherwise modified from the original application format.

In addition, archive copies may be retained for relatively long periods of time (e.g., years) and, in some cases, are never deleted. Archive copies are generally retained for longer periods of time than backup copies, for example. In certain embodiments, archive copies may be made and kept for extended periods in order to meet compliance regulations.

Moreover, when primary data 112 is archived, in some cases the archived primary data 112 or a portion thereof is deleted when creating the archive copy. Thus, archiving can serve the purpose of freeing up space in the primary storage device(s) 104. Similarly, when a secondary copy 116 is archived, the secondary copy 116 may be deleted, and an archive copy can therefore serve the purpose of freeing up space in secondary storage device(s) 108. In contrast, source copies often remain intact when creating backup copies. Examples of compatible data archiving operations are provided in U.S. Pat. No. 7,107,298, which is incorporated by reference herein.

Snapshot Operations

Snapshot operations can provide a relatively lightweight, efficient mechanism for protecting data. From an end-user viewpoint, a snapshot may be thought of as an “instant” image of the primary data 112 at a given point in time. In one embodiment, a snapshot may generally capture the directory structure of an object in primary data 112 such as a file or volume or other data set at a particular moment in time and may also preserve file attributes and contents. A snapshot in some cases is created relatively quickly, e.g., substantially instantly, using a minimum amount of file space, but may still function as a conventional file system backup.

A “hardware” snapshot operation can be a snapshot operation where a target storage device (e.g., a primary storage device 104 or a secondary storage device 108) performs the snapshot operation in a self-contained fashion, substantially independently, using hardware, firmware and/or software residing on the storage device itself. For instance, the storage device may be capable of performing snapshot operations upon request, generally without intervention or oversight from any of the other components in the information management system 100. In this manner, using hardware snapshots can off-load processing involved in snapshot creation and management from other components in the system 100.

A “software” snapshot operation, on the other hand, can be a snapshot operation in which one or more other components in the system (e.g., the client computing devices 102, data agents 142, etc.) implement a software layer that manages the snapshot operation via interaction with the target storage device. For instance, the component implementing the snapshot management software layer may derive a set of pointers and/or data that represents the snapshot. The snapshot management software layer may then transmit the same to the target storage device, along with appropriate instructions for writing the snapshot.

Some types of snapshots do not actually create another physical copy of all the data as it existed at the particular point in time, but may simply create pointers that are able to map files and directories to specific memory locations (e.g., to specific disk blocks) where the data resides, as it existed at the particular point in time. For example, a snapshot copy may include a set of pointers derived from the file system or an application. In some other cases, the snapshot may be created at the block-level, such as where creation of the snapshot occurs without awareness of the file system. Each pointer points to a respective stored data block, so collectively, the set of pointers reflect the storage location and state of the data object (e.g., file(s) or volume(s) or data set(s)) at a particular point in time when the snapshot copy was created.

Once a snapshot has been taken, subsequent changes to the file system typically do not overwrite the blocks in use at the time of the snapshot. Therefore, the initial snapshot may use only a small amount of disk space needed to record a mapping or other data structure representing or otherwise tracking the blocks that correspond to the current state of the file system. Additional disk space is usually required only when files and directories are actually later modified. Furthermore, when files are modified, typically only the pointers which map to blocks are copied, not the blocks themselves. In some embodiments, for example in the case of “copy-on-write” snapshots, when a block changes in primary storage, the block is copied to secondary storage or cached in primary storage before the block is overwritten in primary storage, and the pointer to that block changed to reflect the new location of that block. The snapshot mapping of file system data may also be updated to reflect the changed block(s) at that particular point in time. In some other cases, a snapshot includes a full physical copy of all or substantially all of the data represented by the snapshot. Further examples of snapshot operations are provided in U.S. Pat. No. 7,529,782, which is incorporated by reference herein.

A snapshot copy in many cases can be made quickly and without significantly impacting primary computing resources because large amounts of data need not be copied or moved. In some embodiments, a snapshot may exist as a virtual file system, parallel to the actual file system. Users in some cases gain read-only access to the record of files and directories of the snapshot. By electing to restore primary data 112 from a snapshot taken at a given point in time, users may also return the current file system to the state of the file system that existed when the snapshot was taken.

Replication Operations

Another type of secondary copy operation is a replication operation. Some types of secondary copies 116 are used to periodically capture images of primary data 112 at particular points in time (e.g., backups, archives, and snapshots). However, it can also be useful for recovery purposes to protect primary data 112 in a more continuous fashion, by replicating the primary data 112 substantially as changes occur. In some cases a replication copy can be a mirror copy, for instance, where changes made to primary data 112 are mirrored or substantially immediately copied to another location (e.g., to secondary storage device(s) 108). By copying each write operation to the replication copy, two storage systems are kept synchronized or substantially synchronized so that they are virtually identical at approximately the same time. Where entire disk volumes are mirrored, however, mirroring can require significant amount of storage space and utilizes a large amount of processing resources.

According to some embodiments storage operations are performed on replicated data that represents a recoverable state, or “known good state” of a particular application running on the source system. For instance, in certain embodiments, known good replication copies may be viewed as copies of primary data 112. This feature allows the system to directly access, copy, restore, backup or otherwise manipulate the replication copies as if the data was the “live”, primary data 112. This can reduce access time, storage utilization, and impact on source applications 110, among other benefits.

Based on known good state information, the information management system 100 can replicate sections of application data that represent a recoverable state rather than rote copying of blocks of data. Examples of compatible replication operations (e.g., continuous data replication) are provided in U.S. Pat. No. 7,617,262, which is incorporated by reference herein.

Deduplication/Single-Instancing Operations

Another type of data movement operation is deduplication or single-instance storage, which is useful to reduce the amount of data within the system. For instance, some or all of the above-described secondary storage operations can involve deduplication in some fashion. New data is read, broken down into portions (e.g., sub-file level blocks, files, etc.) of a selected granularity, compared with blocks that are already stored, and only the new blocks are stored. Blocks that already exist are represented as pointers to the already stored data.

In order to streamline the comparison process, the information management system 100 may calculate and/or store signatures (e.g., hashes or cryptographically unique IDs) corresponding to the individual data blocks in a database and compare the signatures instead of comparing entire data blocks. In some cases, only a single instance of each element is stored, and deduplication operations may therefore be referred to interchangeably as “single-instancing” operations. Depending on the implementation, however, deduplication or single-instancing operations can store more than one instance of certain data blocks, but nonetheless significantly reduce data redundancy.

Depending on the embodiment, deduplication blocks can be of fixed or variable length. Using variable length blocks can provide enhanced deduplication by responding to changes in the data stream, but can involve complex processing. In some cases, the information management system 100 utilizes a technique for dynamically aligning deduplication blocks (e.g., fixed-length blocks) based on changing content in the data stream, as described in U.S. Pat. No. 8,364,652, which is incorporated by reference herein.

The information management system 100 can perform deduplication in a variety of manners at a variety of locations in the information management system 100. For instance, in some embodiments, the information management system 100 implements “target-side” deduplication by deduplicating data (e.g., secondary copies 116) stored in the secondary storage devices 108. In some such cases, the media agents 144 are generally configured to manage the deduplication process. For instance, one or more of the media agents 144 maintain a corresponding deduplication database that stores deduplication information (e.g., datablock signatures). Examples of such a configuration are provided in U.S. Pat. Pub. No. 2012/0150826, which is incorporated by reference herein. Instead of or in combination with “target-side” deduplication, deduplication can also be performed on the “source-side” (or “client-side”), e.g., to reduce the amount of traffic between the media agents 144 and the client computing device(s) 102 and/or reduce redundant data stored in the primary storage devices 104. According to various implementations, one or more of the storage devices of the target-side, source-side, or client-side of an operation can be cloud-based storage devices. Thus, the target-side, source-side, and/or client-side deduplication can be cloud-based deduplication. In particular, as discussed previously, the storage manager 140 may communicate with other components within the information management system 100 via network protocols and cloud service provider APIs to facilitate cloud-based deduplication/single instancing. Examples of such deduplication techniques are provided in U.S. Pat. Pub. No. 2012/0150818, which is incorporated by reference herein. Some other compatible deduplication/single instancing techniques are described in U.S. Pat. Pub. Nos. 2006/0224846 and 2009/0319534, which are incorporated by reference herein.

Information Lifecycle Management and Hierarchical Storage Management Operations

In some embodiments, files and other data over their lifetime move from more expensive, quick access storage to less expensive, slower access storage. Operations associated with moving data through various tiers of storage are sometimes referred to as information lifecycle management (ILM) operations.

One type of ILM operation is a hierarchical storage management (HSM) operation. A HSM operation is generally an operation for automatically moving data between classes of storage devices, such as between high-cost and low-cost storage devices. For instance, an HSM operation may involve movement of data from primary storage devices 104 to secondary storage devices 108, or between tiers of secondary storage devices 108. With each tier, the storage devices may be progressively relatively cheaper, have relatively slower access/restore times, etc. For example, movement of data between tiers may occur as data becomes less important over time.

In some embodiments, an HSM operation is similar to an archive operation in that creating an HSM copy may (though not always) involve deleting some of the source data, e.g., according to one or more criteria related to the source data. For example, an HSM copy may include data from primary data 112 or a secondary copy 116 that is larger than a given size threshold or older than a given age threshold and that is stored in a backup format.

Often, and unlike some types of archive copies, HSM data that is removed or aged from the source copy is replaced by a logical reference pointer or stub. The reference pointer or stub can be stored in the primary storage device 104 (or other source storage device, such as a secondary storage device 108) to replace the deleted data in primary data 112 (or other source copy) and to point to or otherwise indicate the new location in a secondary storage device 108.

According to one example, files are generally moved between higher and lower cost storage depending on how often the files are accessed. When a user requests access to the HSM data that has been removed or migrated, the information management system 100 uses the stub to locate the data and often make recovery of the data appear transparent, even though the HSM data may be stored at a location different from the remaining source data. In this manner, the data appears to the user (e.g., in file system browsing windows and the like) as if it still resides in the source location (e.g., in a primary storage device 104). The stub may also include some metadata associated with the corresponding data, so that a file system and/or application can provide some information about the data object and/or a limited-functionality version (e.g., a preview) of the data object.

An HSM copy may be stored in a format other than the native application format (e.g., where the data is compressed, encrypted, deduplicated, and/or otherwise modified from the original application format). In some cases, copies which involve the removal of data from source storage and the maintenance of stub or other logical reference information on source storage may be referred to generally as “on-line archive copies”. On the other hand, copies which involve the removal of data from source storage without the maintenance of stub or other logical reference information on source storage may be referred to as “off-line archive copies”. Examples of HSM and ILM techniques are provided in U.S. Pat. No. 7,343,453, which is incorporated by reference herein.

Auxiliary Copy and Disaster Recovery Operations

An auxiliary copy is generally a copy operation in which a copy is created of an existing secondary copy 116. For instance, an initial secondary copy 116 may be generated using or otherwise be derived from primary data 112 (or other data residing in the secondary storage subsystem 118), whereas an auxiliary copy is generated from the initial secondary copy 116. Auxiliary copies can be used to create additional standby copies of data and may reside on different secondary storage devices 108 than the initial secondary copies 116. Thus, auxiliary copies can be used for recovery purposes if initial secondary copies 116 become unavailable. Exemplary compatible auxiliary copy techniques are described in further detail in U.S. Pat. No. 8,230,195, which is incorporated by reference herein.

The information management system 100 may also perform disaster recovery operations that make or retain disaster recovery copies, often as secondary, high-availability disk copies. The information management system 100 may create secondary disk copies and store the copies at disaster recovery locations using auxiliary copy or replication operations, such as continuous data replication technologies. Depending on the particular data protection goals, disaster recovery locations can be remote from the client computing devices 102 and primary storage devices 104, remote from some or all of the secondary storage devices 108, or both.

Data Analysis, Reporting, and Management Operations

Data analysis, reporting, and management operations can be different than data movement operations in that they do not necessarily involve the copying, migration or other transfer of data (e.g., primary data 112 or secondary copies 116) between different locations in the system. For instance, data analysis operations may involve processing (e.g., offline processing) or modification of already stored primary data 112 and/or secondary copies 116. However, in some embodiments data analysis operations are performed in conjunction with data movement operations. Some data analysis operations include content indexing operations and classification operations which can be useful in leveraging the data under management to provide enhanced search and other features. Other data analysis operations such as compression and encryption can provide data reduction and security benefits, respectively.

Classification Operations/Content Indexing

In some embodiments, the information management system 100 analyzes and indexes characteristics, content, and metadata associated with the data stored within the primary data 112 and/or secondary copies 116, providing enhanced search and management capabilities for data discovery and other purposes. The content indexing can be used to identify files or other data objects having pre-defined content (e.g., user-defined keywords or phrases, other keywords/phrases that are not defined by a user, etc.), and/or metadata (e.g., email metadata such as “to”, “from”, “cc”, “bcc”, attachment name, received time, etc.).

The information management system 100 generally organizes and catalogues the results in a content index, which may be stored within the media agent database 152, for example. The content index can also include the storage locations of (or pointer references to) the indexed data in the primary data 112 or secondary copies 116, as appropriate. The results may also be stored, in the form of a content index database or otherwise, elsewhere in the information management system 100 (e.g., in the primary storage devices 104, or in the secondary storage device 108). Such index data provides the storage manager 140 or another component with an efficient mechanism for locating primary data 112 and/or secondary copies 116 of data objects that match particular criteria.

For instance, search criteria can be specified by a user through user interface 158 of the storage manager 140. In some cases, the information management system 100 analyzes data and/or metadata in secondary copies 116 to create an “off-line” content index, without significantly impacting the performance of the client computing devices 102. Depending on the embodiment, the system can also implement “on-line” content indexing, e.g., of primary data 112. Examples of compatible content indexing techniques are provided in U.S. Pat. No. 8,170,995, which is incorporated by reference herein.

In order to further leverage the data stored in the information management system 100 to perform these and other tasks, one or more components can be configured to scan data and/or associated metadata for classification purposes to populate a database (or other data structure) of information (which can be referred to as a “data classification database” or a “metabase”). Depending on the embodiment, the data classification database(s) can be organized in a variety of different ways, including centralization, logical sub-divisions, and/or physical sub-divisions. For instance, one or more centralized data classification databases may be associated with different subsystems or tiers within the information management system 100. As an example, there may be a first centralized metabase associated with the primary storage subsystem 117 and a second centralized metabase associated with the secondary storage subsystem 118. In other cases, there may be one or more metabases associated with individual components. For instance, there may be a dedicated metabase associated with some or all of the client computing devices 102 and/or media agents 144. In some embodiments, a data classification database may reside as one or more data structures within management database 146, or may be otherwise associated with storage manager 140.

In some cases, the metabase(s) may be included in separate database(s) and/or on separate storage device(s) from primary data 112 and/or secondary copies 116, such that operations related to the metabase do not significantly impact performance on other components in the information management system 100. In other cases, the metabase(s) may be stored along with primary data 112 and/or secondary copies 116. Files or other data objects can be associated with identifiers (e.g., tag entries, etc.) in the media agent 144 (or other indices) to facilitate searches of stored data objects. Among a number of other benefits, the metabase can also allow efficient, automatic identification of files or other data objects to associate with secondary copy or other information management operations (e.g., in lieu of scanning an entire file system). Examples of compatible metabases and data classification operations are provided in U.S. Pat. Nos. 8,229,954 and 7,747,579, which are incorporated by reference herein.

Encryption Operations

The information management system 100 in some cases is configured to process data (e.g., files or other data objects, secondary copies 116, etc.), according to an appropriate encryption algorithm (e.g., Blowfish, Advanced Encryption Standard [AES], Triple Data Encryption Standard [3-DES], etc.) to limit access and provide data security in the information management system 100.

The information management system 100 in some cases encrypts the data at the client level, such that the client computing devices 102 (e.g., the data agents 142) encrypt the data prior to forwarding the data to other components, e.g., before sending the data to media agents 144 during a secondary copy operation. In such cases, the client computing device 102 may maintain or have access to an encryption key or passphrase for decrypting the data upon restore. Encryption can also occur when creating copies of secondary copies, e.g., when creating auxiliary copies or archive copies. In yet further embodiments, the secondary storage devices 108 can implement built-in, high performance hardware encryption.

Management and Reporting Operations

Certain embodiments leverage the integrated, ubiquitous nature of the information management system 100 to provide useful system-wide management and reporting functions. Examples of some compatible management and reporting techniques are provided in U.S. Pat. No. 7,343,453, which is incorporated by reference herein.

Operations management can generally include monitoring and managing the health and performance of information management system 100 by, without limitation, performing error tracking, generating granular storage/performance metrics (e.g., job success/failure information, deduplication efficiency, etc.), generating storage modeling and costing information, and the like.

As an example, a storage manager 140 or other component in the information management system 100 may analyze traffic patterns and suggest or automatically route data via a particular route to e.g., certain facilitate storage and minimize congestion. In some embodiments, the system can generate predictions relating to storage operations or storage operation information. Such predictions described may be based on a trending analysis that may be used to predict various network operations or use of network resources such as network traffic levels, storage media use, use of bandwidth of communication links, use of media agent components, etc. Further examples of traffic analysis, trend analysis, prediction generation, and the like are described in U.S. Pat. No. 7,343,453, which is incorporated by reference herein.

In some configurations, a master storage manager 140 may track the status of a set of associated storage operation cells in a hierarchy of information management cells, such as the status of jobs, system components, system resources, and other items, by communicating with storage managers 140 (or other components) in the respective storage operation cells. Moreover, the master storage manager 140 may track the status of its associated storage operation cells and associated information management operations by receiving periodic status updates from the storage managers 140 (or other components) in the respective cells regarding jobs, system components, system resources, and other items. In some embodiments, a master storage manager 140 may store status information and other information regarding its associated storage operation cells and other system information in its index 150 (or other location).

The master storage manager 140 or other component in the system may also determine whether a storage-related criteria or other criteria is satisfied, and perform an action or trigger event (e.g., data migration) in response to the criteria being satisfied, such as where a storage threshold is met for a particular volume, or where inadequate protection exists for certain data. For instance, in some embodiments, the system uses data from one or more storage operation cells to advise users of risks or indicates actions that can be used to mitigate or otherwise minimize these risks, and in some embodiments, dynamically takes action to mitigate or minimize these risks. For example, an information management policy may specify certain requirements (e.g., that a storage device should maintain a certain amount of free space, that secondary copies should occur at a particular interval, that data should be aged and migrated to other storage after a particular period, that data on a secondary volume should always have a certain level of availability and be able to be restored within a given time period, that data on a secondary volume may be mirrored or otherwise migrated to a specified number of other volumes, etc.). If a risk condition or other criteria is triggered, the system can notify the user of these conditions and may suggest (or automatically implement) an action to mitigate or otherwise address the condition or minimize risk. For example, the system may indicate that data from a primary copy 112 should be migrated to a secondary storage device 108 to free space on the primary storage device 104. Examples of the use of risk factors and other triggering criteria are described in U.S. Pat. No. 7,343,453, which is incorporated by reference herein.

In some embodiments, the system 100 may also determine whether a metric or other indication satisfies a particular storage criteria and, if so, perform an action. For example, as previously described, a storage policy or other definition might indicate that a storage manager 140 should initiate a particular action if a storage metric or other indication drops below or otherwise fails to satisfy specified criteria such as a threshold of data protection. Examples of such metrics are described in U.S. Pat. No. 7,343,453, which is incorporated by reference herein.

In some embodiments, risk factors may be quantified into certain measurable service or risk levels for ease of comprehension. For example, certain applications and associated data may be considered to be more important by an enterprise than other data and services. Financial compliance data, for example, may be of greater importance than marketing materials, etc. Network administrators may assign priorities or “weights” to certain data or applications, corresponding to its importance (priority value). The level of compliance with the storage operations specified for these applications may also be assigned a certain value. Thus, the health, impact and overall importance of a service on an enterprise may be determined, for example, by measuring the compliance value and calculating the product of the priority value and the compliance value to determine the “service level” and comparing it to certain operational thresholds to determine if the operation is being performed within a specified data protection service level. Further examples of the service level determination are provided in U.S. Pat. No. 7,343,453, which is incorporated by reference herein.

The system 100 may additionally calculate data costing and data availability associated with information management operation cells according to an embodiment of the invention. For instance, data received from the cell may be used in conjunction with hardware-related information and other information about network elements to generate indications of costs associated with storage of particular data in the system or the availability of particular data in the system. In general, components in the system are identified and associated information is obtained (dynamically or manually). Characteristics or metrics associated with the network elements may be identified and associated with that component element for further use generating an indication of storage cost or data availability. Exemplary information generated could include how fast a particular department is using up available storage space, how long data would take to recover over a particular network pathway from a particular secondary storage device, costs over time, etc. Moreover, in some embodiments, such information may be used to determine or predict the overall cost associated with the storage of certain information. The cost associated with hosting a certain application may be based, at least in part, on the type of media on which the data resides. Storage devices may be assigned to a particular cost category which is indicative of the cost of storing information on that device. Further examples of costing techniques are described in U.S. Pat. No. 7,343,453, which is incorporated by reference herein.

Any of the above types of information (e.g., information related to trending, predictions, job, cell or component status, risk, service level, costing, etc.) can generally be provided to users via the user interface 158 in a single, integrated view or console. The console may support a reporting capability that allows for the generation of a variety of reports, which may be tailored to a particular aspect of information management. Report types may include: scheduling, event management, media management and data aging. Available reports may also include backup history, data aging history, auxiliary copy history, job history, library and drive, media in library, restore history, and storage policy. Such reports may be specified and created at a certain point in time as a network analysis, forecasting, or provisioning tool. Integrated reports may also be generated that illustrate storage and performance metrics, risks and storage costing information. Moreover, users may create their own reports based on specific needs.

The integrated user interface 158 can include an option to show a “virtual view” of the system that graphically depicts the various components in the system using appropriate icons. As one example, the user interface 158 may provide a graphical depiction of one or more primary storage devices 104, the secondary storage devices 108, data agents 142 and/or media agents 144, and their relationship to one another in the information management system 100. The operations management functionality can facilitate planning and decision-making. For example, in some embodiments, a user may view the status of some or all jobs as well as the status of each component of the information management system 100. Users may then plan and make decisions based on this data. For instance, a user may view high-level information regarding storage operations for the information management system 100, such as job status, component status, resource status (e.g., network pathways, etc.), and other information. The user may also drill down or use other means to obtain more detailed information regarding a particular component, job, or the like.

Further examples of some reporting techniques and associated interfaces providing an integrated view of an information management system are provided in U.S. Pat. No. 7,343,453, which is incorporated by reference herein.

The information management system 100 can also be configured to perform system-wide e-discovery operations in some embodiments. In general, e-discovery operations provide a unified collection and search capability for data in the system, such as data stored in the secondary storage devices 108 (e.g., backups, archives, or other secondary copies 116). For example, the information management system 100 may construct and maintain a virtual repository for data stored in the information management system 100 that is integrated across source applications 110, different storage device types, etc. According to some embodiments, e-discovery utilizes other techniques described herein, such as data classification and/or content indexing.

### Information Management Policies

As indicated previously, an information management policy 148 can include a data structure or other information source that specifies a set of parameters (e.g., operational properties, criteria and/or rules) associated with secondary copy or other information management operations.

One type of information management policy 148 is a storage policy. According to certain embodiments, a storage policy generally comprises a data structure or other information source that defines (or includes information sufficient to determine) a set of preferences or other criteria for performing information management operations. Storage policies can include one or more of the following items: (1) what data will be associated with the storage policy; (2) a destination to which the data will be stored; (3) datapath information specifying how the data will be communicated to the destination; (4) the type of storage operation to be performed; and (5) retention information specifying how long the data will be retained at the destination.

As an illustrative example, data associated with a storage policy can be logically organized into groups. In some cases, these logical groupings can be referred to as “sub-clients”. A sub-client may represent static or dynamic associations of portions of a data volume. Sub-clients may represent mutually exclusive portions. Thus, in certain embodiments, a portion of data may be given a label and the association is stored as a static entity in an index, database or other storage location.

Sub-clients may also be used as an effective administrative scheme of organizing data according to data type, department within the enterprise, storage preferences, or the like. Depending on the configuration, sub-clients can correspond to files, folders, virtual machines, databases, etc. In one exemplary scenario, an administrator may find it preferable to separate e-mail data from financial data using two different sub-clients.

A storage policy can define where data is stored by specifying a target or destination storage device (or group of storage devices). For instance, where the secondary storage device 108 includes a group of disk libraries, the storage policy may specify a particular disk library for storing the sub-clients associated with the policy. As another example, where the secondary storage devices 108 include one or more tape libraries, the storage policy may specify a particular tape library for storing the sub-clients associated with the storage policy, and may also specify a drive pool and a tape pool defining a group of tape drives and a group of tapes, respectively, for use in storing the sub-client data. While information in the storage policy can be statically assigned in some cases, some or all of the information in the storage policy can also be dynamically determined based on criteria, which can be set forth in the storage policy. For instance, based on such criteria, a particular destination storage device(s) (or other parameter of the storage policy) may be determined based on characteristics associated with the data involved in a particular storage operation, device availability (e.g., availability of a secondary storage device 108 or a media agent 144), network status and conditions (e.g., identified bottlenecks), user credentials, and the like).

Datapath information can also be included in the storage policy. For instance, the storage policy may specify network pathways and components to utilize when moving the data to the destination storage device(s). In some embodiments, the storage policy specifies one or more media agents 144 for conveying data (e.g., one or more sub-clients) associated with the storage policy between the source (e.g., one or more host client computing devices 102) and destination (e.g., a particular target secondary storage device 108).

A storage policy can also specify the type(s) of operations associated with the storage policy, such as a backup, archive, snapshot, auxiliary copy, or the like. Retention information can specify how long the data will be kept, depending on organizational needs (e.g., a number of days, months, years, etc.)

The information management policies 148 may also include one or more scheduling policies specifying when and how often to perform operations. Scheduling information may specify with what frequency (e.g., hourly, weekly, daily, event-based, etc.) or under what triggering conditions secondary copy or other information management operations will take place. Scheduling policies in some cases are associated with particular components, such as particular logical groupings of data associated with a storage policy (e.g., a sub-client), client computing device 102, and the like. In one configuration, a separate scheduling policy is maintained for particular logical groupings of data on a client computing device 102. The scheduling policy specifies that those logical groupings are to be moved to secondary storage devices 108 every hour according to storage policies associated with the respective sub-clients.

When adding a new client computing device 102, administrators can manually configure information management policies 148 and/or other settings, e.g., via the user interface 158. However, this can be an involved process resulting in delays, and it may be desirable to begin data protecting operations quickly.

Thus, in some embodiments, the information management system 100 automatically applies a default configuration to client computing device 102. As one example, when one or more data agent(s) 142 are installed on one or more client computing devices 102, the installation script may register the client computing device 102 with the storage manager 140, which in turn applies the default configuration to the new client computing device 102. In this manner, data protection operations can begin substantially immediately. The default configuration can include a default storage policy, for example, and can specify any appropriate information sufficient to begin data protection operations. This can include a type of data protection operation, scheduling information, a target secondary storage device 108, data path information (e.g., a particular media agent 144), and the like.

Other types of information management policies 148 are possible. For instance, the information management policies 148 can also include one or more audit or security policies. An audit policy is a set of preferences, rules and/or criteria that protect sensitive data in the information management system 100. For example, an audit policy may define “sensitive objects” as files or objects that contain particular keywords (e.g., “confidential,” or “privileged”) and/or are associated with particular keywords (e.g., in metadata) or particular flags (e.g., in metadata identifying a document or email as personal, confidential, etc.).

An audit policy may further specify rules for handling sensitive objects. As an example, an audit policy may require that a reviewer approve the transfer of any sensitive objects to a cloud storage site, and that if approval is denied for a particular sensitive object, the sensitive object should be transferred to a local primary storage device 104 instead. To facilitate this approval, the audit policy may further specify how a secondary storage computing device 106 or other system component should notify a reviewer that a sensitive object is slated for transfer.

In some implementations, the information management policies 148 may include one or more provisioning policies. A provisioning policy can include a set of preferences, priorities, rules, and/or criteria that specify how client computing devices 102 (or groups thereof) may utilize system resources, such as available storage on cloud storage and/or network bandwidth. A provisioning policy specifies, for example, data quotas for particular client computing devices 102 (e.g., a number of gigabytes that can be stored monthly, quarterly or annually). The storage manager 140 or other components may enforce the provisioning policy. For instance, the media agents 144 may enforce the policy when transferring data to secondary storage devices 108. If a client computing device 102 exceeds a quota, a budget for the client computing device 102 (or associated department) is adjusted accordingly or an alert may trigger.

While the above types of information management policies 148 have been described as separate policies, one or more of these can be generally combined into a single information management policy 148. For instance, a storage policy may also include or otherwise be associated with one or more scheduling, audit, or provisioning policies. Moreover, while storage policies are typically associated with moving and storing data, other policies may be associated with other types of information management operations. The following is a non-exhaustive list of items the information management policies 148 may specify, e.g., operational properties:
schedules or other timing information, e.g., specifying when and/or how often to perform information management operations;
the type of copy 116 (e.g., type of secondary copy) and/or copy format (e.g., snapshot, backup, archive, HSM, etc.);
a location or a class or quality of storage for storing secondary copies 116 (e.g., one or more particular secondary storage devices 108);
preferences regarding whether and how to encrypt, compress, deduplicate, or otherwise modify or transform secondary copies 116;
which system components and/or network pathways (e.g., preferred media agents 144) should be used to perform secondary storage operations;
resource allocation between different computing devices or other system components used in performing information management operations (e.g., bandwidth allocation, available storage capacity, etc.);
whether and how to synchronize or otherwise distribute files or other data objects across multiple computing devices or hosted services; and
retention information specifying the length of time primary data 112 and/or secondary copies 116 should be retained, e.g., in a particular class or tier of storage devices, or within the information management system 100.

Policies can additionally specify or depend on a variety of historical or current criteria (e.g., operational properties) that may be used to determine which rules to apply to a particular data object, system component, or information management operation, such as:
frequency with which primary data 112 or a secondary copy 116 of a data object or metadata has been or is predicted to be used, accessed, or modified;
time-related factors (e.g., aging information such as time since the creation or modification of a data object);
deduplication information (e.g., hashes, data blocks, deduplication block size, deduplication efficiency or other metrics);
an estimated or historic usage or cost associated with different components (e.g., with secondary storage devices 108);
the identity of users, applications 110, client computing devices 102 and/or other computing devices that created, accessed, modified, or otherwise utilized primary data 112 or secondary copies 116;
a relative sensitivity (e.g., confidentiality) of a data object, e.g., as determined by its content and/or metadata;
the current or historical storage capacity of various storage devices;
the current or historical network capacity of network pathways connecting various components within the storage operation cell;
access control lists or other security information; and
the content of a particular data object (e.g., its textual content) or of metadata associated with the data object.

### Exemplary Storage Policy and Secondary Storage Operations

FIG. 1E shows a data flow data diagram depicting performance of storage operations by an embodiment of an information management system 100, according to an exemplary storage policy 148A. The information management system 100 includes a storage manger 140, a client computing device 102 having a file system data agent 142A and an email data agent 142B residing thereon, a primary storage device 104, two media agents 144A, 144B, and two secondary storage devices 108A, 108B: a disk library 108A and a tape library 108B. As shown, the primary storage device 104 includes primary data 112A, 112B associated with a logical grouping of data associated with a file system) and a logical grouping of data associated with email data, respectively. Although for simplicity the logical grouping of data associated with the file system is referred to as a file system sub-client, and the logical grouping of data associated with the email data is referred to as an email sub-client, the techniques described with respect to FIG. 1E can be utilized in conjunction with data that is organized in a variety of other manners.

As indicated by the dashed box, the second media agent 144B and the tape library 108B are “off-site”, and may therefore be remotely located from the other components in the information management system 100 (e.g., in a different city, office building, etc.). Indeed, “off-site” may refer to a magnetic tape located in storage, which must be manually retrieved and loaded into a tape drive to be read. In this manner, information stored on the tape library 108B may provide protection in the event of a disaster or other failure.

The file system sub-client and its associated primary data 112A in certain embodiments generally comprise information generated by the file system and/or operating system of the client computing device 102, and can include, for example, file system data (e.g., regular files, file tables, mount points, etc.), operating system data (e.g., registries, event logs, etc.), and the like. The e-mail sub-client, on the other hand, and its associated primary data 112B, include data generated by an e-mail client application operating on the client computing device 102, and can include mailbox information, folder information, emails, attachments, associated database information, and the like. As described above, the sub-clients can be logical containers, and the data included in the corresponding primary data 112A, 1126 may or may not be stored contiguously.

The exemplary storage policy 148A includes backup copy preferences or rule set 160, disaster recovery copy preferences rule set 162, and compliance copy preferences or rule set 164. The backup copy rule set 160 specifies that it is associated with a file system sub-client 166 and an email sub-client 168. Each of these sub-clients 166, 168 are associated with the particular client computing device 102. The backup copy rule set 160 further specifies that the backup operation will be written to the disk library 108A, and designates a particular media agent 144A to convey the data to the disk library 108A. Finally, the backup copy rule set 160 specifies that backup copies created according to the rule set 160 are scheduled to be generated on an hourly basis and to be retained for 30 days. In some other embodiments, scheduling information is not included in the storage policy 148A, and is instead specified by a separate scheduling policy.

The disaster recovery copy rule set 162 is associated with the same two sub-clients 166, 168. However, the disaster recovery copy rule set 162 is associated with the tape library 108B, unlike the backup copy rule set 160. Moreover, the disaster recovery copy rule set 162 specifies that a different media agent 144B than the media agent 144A associated with the backup copy rule set 160 will be used to convey the data to the tape library 108B. As indicated, disaster recovery copies created according to the rule set 162 will be retained for 60 days, and will be generated on a daily basis. Disaster recovery copies generated according to the disaster recovery copy rule set 162 can provide protection in the event of a disaster or other data-loss event that would affect the backup copy 116A maintained on the disk library 108A.

The compliance copy rule set 164 is only associated with the email sub-client 168, and not the file system sub-client 166. Compliance copies generated according to the compliance copy rule set 164 will therefore not include primary data 112A from the file system sub-client 166. For instance, the organization may be under an obligation to store and maintain copies of email data for a particular period of time (e.g., 10 years) to comply with state or federal regulations, while similar regulations do not apply to the file system data. The compliance copy rule set 164 is associated with the same tape library 108B and media agent 144B as the disaster recovery copy rule set 162, although a different storage device or media agent could be used in other embodiments. Finally, the compliance copy rule set 164 specifies that copies generated under the compliance copy rule set 164 will be retained for 10 years, and will be generated on a quarterly basis.

At step 1, the storage manager 140 initiates a backup operation according to the backup copy rule set 160. For instance, a scheduling service running on the storage manager 140 accesses scheduling information from the backup copy rule set 160 or a separate scheduling policy associated with the client computing device 102, and initiates a backup copy operation on an hourly basis. Thus, at the scheduled time slot the storage manager 140 sends instructions to the client computing device 102 to begin the backup operation.

At step 2, the file system data agent 142A and the email data agent 142B residing on the client computing device 102 respond to the instructions received from the storage manager 140 by accessing and processing the primary data 112A, 112B involved in the copy operation from the primary storage device 104. Because the operation is a backup copy operation, the data agent(s) 142A, 142B may format the data into a backup format or otherwise process the data.

At step 3, the client computing device 102 communicates the retrieved, processed data to the first media agent 144A, as directed by the storage manager 140, according to the backup copy rule set 160. In some other embodiments, the information management system 100 may implement a load-balancing, availability-based, or other appropriate algorithm to select from the available set of media agents 144A, 144B. Regardless of the manner the media agent 144A is selected, the storage manager 140 may further keep a record in the storage manager database 146 of the association between the selected media agent 144A and the client computing device 102 and/or between the selected media agent 144A and the backup copy 116A.

The target media agent 144A receives the data from the client computing device 102, and at step 4 conveys the data to the disk library 108A to create the backup copy 116A, again at the direction of the storage manager 140 and according to the backup copy rule set 160. The secondary storage device 108A can be selected in other ways. For instance, the media agent 144A may have a dedicated association with a particular secondary storage device(s), or the storage manager 140 or media agent 144A may select from a plurality of secondary storage devices, e.g., according to availability, using one of the techniques described in U.S. Pat. No. 7,246,207, which is incorporated by reference herein.

The media agent 144A can also update its index 153 to include data and/or metadata related to the backup copy 116A, such as information indicating where the backup copy 116A resides on the disk library 108A, data and metadata for cache retrieval, etc. After the 30 day retention period expires, the storage manager 140 instructs the media agent 144A to delete the backup copy 116A from the disk library 108A. The storage manager 140 may similarly update its index 150 to include information relating to the storage operation, such as information relating to the type of storage operation, a physical location associated with one or more copies created by the storage operation, the time the storage operation was performed, status information relating to the storage operation, the components involved in the storage operation, and the like. In some cases, the storage manager 140 may update its index 150 to include some or all of the information stored in the index 153 of the media agent 144A.

At step 5, the storage manager 140 initiates the creation of a disaster recovery copy 1166 according to the disaster recovery copy rule set 162. For instance, at step 6, based on instructions received from the storage manager 140 at step 5, the specified media agent 144B retrieves the most recent backup copy 116A from the disk library 108A.

At step 7, again at the direction of the storage manager 140 and as specified in the disaster recovery copy rule set 162, the media agent 144B uses the retrieved data to create a disaster recovery copy 1166 on the tape library 1086. In some cases, the disaster recovery copy 1166 is a direct, mirror copy of the backup copy 116A, and remains in the backup format. In other embodiments, the disaster recovery copy 116B may be generated in some other manner, such as by using the primary data 112A, 112B from the primary storage device 104 as source data. The disaster recovery copy operation is initiated once a day and the disaster recovery copies 1166 are deleted after 60 days.

At step 8, the storage manager 140 initiates the creation of a compliance copy 116C, according to the compliance copy rule set 164. For instance, the storage manager 140 instructs the media agent 144B to create the compliance copy 116C on the tape library 108B at step 9, as specified in the compliance copy rule set 164. In the example, the compliance copy 116C is generated using the disaster recovery copy 1166. In other embodiments, the compliance copy 116C is instead generated using either the primary data 112B corresponding to the email sub-client or using the backup copy 116A from the disk library 108A as source data. As specified, in the illustrated example, compliance copies 116C are created quarterly, and are deleted after ten years.

While not shown in FIG. 1E, at some later point in time, a restore operation can be initiated involving one or more of the secondary copies 116A, 1166, 116C. As one example, a user may manually initiate a restore of the backup copy 116A by interacting with the user interface 158 of the storage manager 140. The storage manager 140 then accesses data in its index 150 (and/or the respective storage policy 148A) associated with the selected backup copy 116A to identify the appropriate media agent 144A and/or secondary storage device 108A.

In other cases, a media agent may be selected for use in the restore operation based on a load balancing algorithm, an availability based algorithm, or other criteria. The selected media agent 144A retrieves the data from the disk library 108A. For instance, the media agent 144A may access its index 153 to identify a location of the backup copy 116A on the disk library 108A, or may access location information residing on the disk 108A itself.

When the backup copy 116A was recently created or accessed, the media agent 144A accesses a cached version of the backup copy 116A residing in the index 153, without having to access the disk library 108A for some or all of the data. Once it has retrieved the backup copy 116A, the media agent 144A communicates the data to the source client computing device 102. Upon receipt, the file system data agent 142A and the email data agent 142B may unpackage (e.g., restore from a backup format to the native application format) the data in the backup copy 116A and restore the unpackaged data to the primary storage device 104.

Exemplary Applications of Storage Policies

The storage manager 140 may permit a user to specify aspects of the storage policy 148A. For example, the storage policy can be modified to include information governance policies to define how data should be managed in order to comply with a certain regulation or business objective. The various policies may be stored, for example, in the database 146. An information governance policy may comprise a classification policy, which is described herein. An information governance policy may align with one or more compliance tasks that are imposed by regulations or business requirements. Examples of information governance policies might include a Sarbanes-Oxley policy, a HIPAA policy, an electronic discovery (E-Discovery) policy, and so on.

Information governance policies allow administrators to obtain different perspectives on all of an organization's online and offline data, without the need for a dedicated data silo created solely for each different viewpoint. As described previously, the data storage systems herein build a centralized index that reflects the contents of a distributed data set that spans numerous clients and storage devices, including both primary and secondary copies, and online and offline copies. An organization may apply multiple information governance policies in a top-down manner over that unified data set and indexing schema in order to permit an organization to view and manipulate the single data set through different lenses, each of which is adapted to a particular compliance or business goal. Thus, for example, by applying an E-discovery policy and a Sarbanes-Oxley policy, two different groups of users in an organization can conduct two very different analyses of the same underlying physical set of data copies, which may be distributed throughout the organization.

A classification policy defines a taxonomy of classification terms or tags relevant to a compliance task and/or business objective. A classification policy may also associate a defined tag with a classification rule. A classification rule defines a particular combination of data criteria, such as users who have created, accessed or modified a document or data object; file or application types; content or metadata keywords; clients or storage locations; dates of data creation and/or access; review status or other status within a workflow (e.g., reviewed or un-reviewed); modification times or types of modifications; and/or any other data attributes. A classification rule may also be defined using other classification tags in the taxonomy. The various criteria used to define a classification rule may be combined in any suitable fashion, for example, via Boolean operators, to define a complex classification rule. As an example, an E-discovery classification policy might define a classification tag “privileged” that is associated with documents or data objects that (1) were created or modified by legal department staff, (2) were sent to or received from outside counsel via email, and/or (3) contain one of the following keywords: “privileged” or “attorney,” “counsel”, or other terms.

One specific type of classification tag, which may be added to an index at the time of indexing, is an entity tag. An entity tag may be, for example, any content that matches a defined data mask format. Examples of entity tags might include, e.g., social security numbers (e.g., any numerical content matching the formatting mask XXX-XX-XXXX), credit card numbers (e.g., content having a 13-16 digit string of numbers), SKU numbers, product numbers, etc.

A user may define a classification policy by indicating criteria, parameters or descriptors of the policy via a graphical user interface that provides facilities to present information and receive input data, such as a form or page with fields to be filled in, pull-down menus or entries allowing one or more of several options to be selected, buttons, sliders, hypertext links or other known user interface tools for receiving user input. For example, a user may define certain entity tags, such as a particular product number or project ID code that is relevant in the organization.

In some implementations, the classification policy can be implemented using cloud-based techniques. For example, the storage devices may be cloud storage devices, and the storage manager 140 may execute cloud service provider API over a network to classify data stored on cloud storage devices.

### Exemplary Secondary Copy Formatting

The formatting and structure of secondary copies 116 can vary, depending on the embodiment. In some cases, secondary copies 116 are formatted as a series of logical data units or “chunks” (e.g., 512 MB, 1 GB, 2 GB, 4 GB, or 8 GB chunks). This can facilitate efficient communication and writing to secondary storage devices 108, e.g., according to resource availability. For example, a single secondary copy 116 may be written on a chunk-by-chunk basis to a single secondary storage device 108 or across multiple secondary storage devices 108. In some cases, users can select different chunk sizes, e.g., to improve throughput to tape storage devices.

Generally, each chunk can include a header and a payload. The payload can include files (or other data units) or subsets thereof included in the chunk, whereas the chunk header generally includes metadata relating to the chunk, some or all of which may be derived from the payload. For example, during a secondary copy operation, the media agent 144, storage manager 140, or other component may divide the associated files into chunks and generate headers for each chunk by processing the constituent files.

The headers can include a variety of information such as file identifier(s), volume(s), offset(s), or other information associated with the payload data items, a chunk sequence number, etc. Importantly, in addition to being stored with the secondary copy 116 on the secondary storage device 108, the chunk headers can also be stored to the index 153 of the associated media agent(s) 144 and/or the index 150. This is useful in some cases for providing faster processing of secondary copies 116 during restores or other operations. In some cases, once a chunk is successfully transferred to a secondary storage device 108, the secondary storage device 108 returns an indication of receipt, e.g., to the media agent 144 and/or storage manager 140, which may update their respective indexes 153, 150 accordingly. During restore, chunks may be processed (e.g., by the media agent 144) according to the information in the chunk header to reassemble the files.

Data can also be communicated within the information management system 100 in data channels that connect the client computing devices 102 to the secondary storage devices 108. These data channels can be referred to as “data streams”, and multiple data streams can be employed to parallelize an information management operation, improving data transfer rate, among providing other advantages. Example data formatting techniques including techniques involving data streaming, chunking, and the use of other data structures in creating copies (e.g., secondary copies) are described in U.S. Pat. Nos. 7,315,923 and 8,156,086, and U.S. Pat. Pub. No. 2010/0299490, each of which is incorporated by reference herein.

FIGS. 1F and 1G are diagrams of example data streams 170 and 171, respectively, which may be employed for performing data storage operations. Referring to FIG. 1F, the data agent 142 forms the data stream 170 from the data associated with a client computing device 102 (e.g., primary data 112). The data stream 170 is composed of multiple pairs of stream header 172 and stream data (or stream payload) 174. The data streams 170 and 171 shown in the illustrated example are for a single-instanced storage operation, and a stream payload 174 therefore may include both single-instance (“SI”) data and/or non-SI data. A stream header 172 includes metadata about the stream payload 174. This metadata may include, for example, a length of the stream payload 174, an indication of whether the stream payload 174 is encrypted, an indication of whether the stream payload 174 is compressed, an archive file identifier (ID), an indication of whether the stream payload 174 is single instanceable, and an indication of whether the stream payload 174 is a start of a block of data.

Referring to FIG. 1G, the data stream 171 has the stream header 172 and stream payload 174 aligned into multiple data blocks. In this example, the data blocks are of size 64 KB. The first two stream header 172 and stream payload 174 pairs comprise a first data block of size 64 KB. The first stream header 172 indicates that the length of the succeeding stream payload 174 is 63 KB and that it is the start of a data block. The next stream header 172 indicates that the succeeding stream payload 174 has a length of 1 KB and that it is not the start of a new data block. Immediately following stream payload 174 is a pair comprising an identifier header 176 and identifier data 178. The identifier header 176 includes an indication that the succeeding identifier data 178 includes the identifier for the immediately previous data block. The identifier data 178 includes the identifier that the data agent 142 generated for the data block. The data stream 171 also includes other stream header 172 and stream payload 174 pairs, which may be for SI data and/or for non-SI data.

FIG. 1H is a diagram illustrating the data structures 180 that may be used to store blocks of SI data and non-SI data on the storage device (e.g., secondary storage device 108). According to certain embodiments, the data structures 180 do not form part of a native file system of the storage device. The data structures 180 include one or more volume folders 182, one or more chunk folders 184/185 within the volume folder 182, and multiple files within the chunk folder 184. Each chunk folder 184/185 includes a metadata file 186/187, a metadata index file 188/189, one or more container files 190/191/193, and a container index file 192/194. The metadata file 186/187 stores non-SI data blocks as well as links to SI data blocks stored in container files. The metadata index file 188/189 stores an index to the data in the metadata file 186/187. The container files 190/191/193 store SI data blocks. The container index file 192/194 stores an index to the container files 190/191/193. Among other things, the container index file 192/194 stores an indication of whether a corresponding block in a container file 190/191/193 is referred to by a link in a metadata file 186/187. For example, data block B2 in the container file 190 is referred to by a link in the metadata file 187 in the chunk folder 185. Accordingly, the corresponding index entry in the container index file 192 indicates that the data block B2 in the container file 190 is referred to. As another example, data block B1 in the container file 191 is referred to by a link in the metadata file 187, and so the corresponding index entry in the container index file 192 indicates that this data block is referred to.

As an example, the data structures 180 illustrated in FIG. 1H may have been created as a result of two storage operations involving two client computing devices 102. For example, a first storage operation on a first client computing device 102 could result in the creation of the first chunk folder 184, and a second storage operation on a second client computing device 102 could result in the creation of the second chunk folder 185. The container files 190/191 in the first chunk folder 184 would contain the blocks of SI data of the first client computing device 102. If the two client computing devices 102 have substantially similar data, the second storage operation on the data of the second client computing device 102 would result in the media agent 144 storing primarily links to the data blocks of the first client computing device 102 that are already stored in the container files 190/191. Accordingly, while a first storage operation may result in storing nearly all of the data subject to the storage operation, subsequent storage operations involving similar data may result in substantial data storage space savings, because links to already stored data blocks can be stored instead of additional instances of data blocks.

If the operating system of the secondary storage computing device 106 on which the media agent 144 resides supports sparse files, then when the media agent 144 creates container files 190/191/193, it can create them as sparse files. As previously described, a sparse file is type of file that may include empty space (e.g., a sparse file may have real data within it, such as at the beginning of the file and/or at the end of the file, but may also have empty space in it that is not storing actual data, such as a contiguous range of bytes all having a value of zero). Having the container files 190/191/193 be sparse files allows the media agent 144 to free up space in the container files 190/191/193 when blocks of data in the container files 190/191/193 no longer need to be stored on the storage devices. In some examples, the media agent 144 creates a new container file 190/191/193 when a container file 190/191/193 either includes 100 blocks of data or when the size of the container file 190 exceeds 50 MB. In other examples, the media agent 144 creates a new container file 190/191/193 when a container file 190/191/193 satisfies other criteria (e.g., it contains from approximately 100 to approximately 1000 blocks or when its size exceeds approximately 50 MB to 1 GB).

In some cases, a file on which a storage operation is performed may comprise a large number of data blocks. For example, a 100 MB file may be comprised in 400 data blocks of size 256 KB. If such a file is to be stored, its data blocks may span more than one container file, or even more than one chunk folder. As another example, a database file of 20 GB may comprise over 40,000 data blocks of size 512 KB. If such a database file is to be stored, its data blocks will likely span multiple container files, multiple chunk folders, and potentially multiple volume folders. As described in detail herein, restoring such files may thus requiring accessing multiple container files, chunk folders, and/or volume folders to obtain the requisite data blocks.

Exemplary Entity Difference Management System

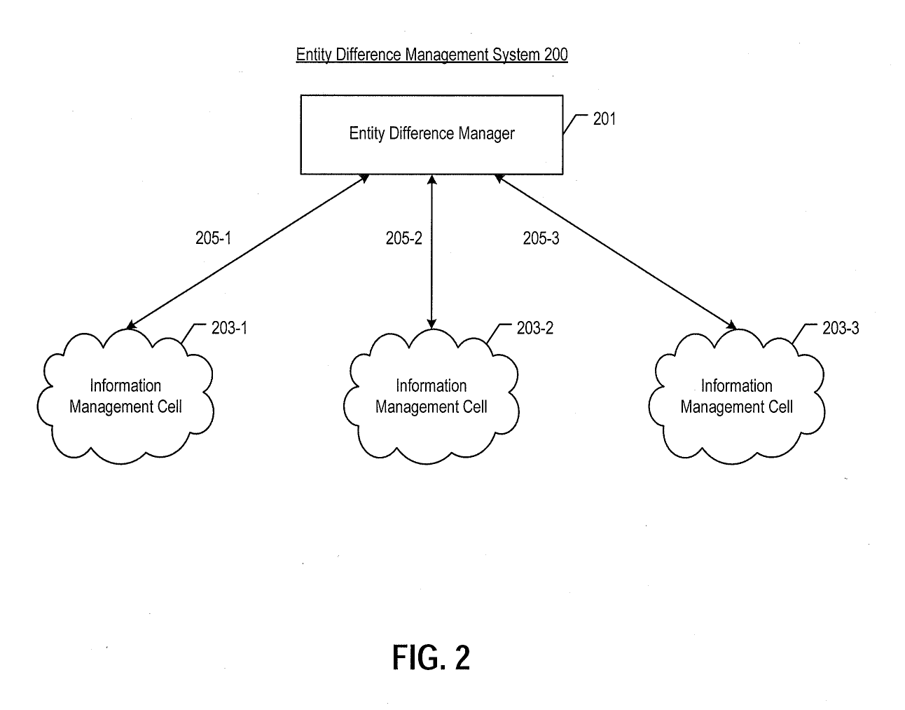

FIG. 2 depicts an exemplary entity difference management system 200 according to an illustrative embodiment of the present invention. System 200 comprises: entity difference manager 201 and information management cells 203-1, 203-2, and 203-3 communicatively coupled as shown by communication links 205-1, 205-2, 205-3, respectively. Information management cells 203 may be communicatively coupled to each other via communication links (not shown). In some embodiments, one or more information management cells 203 are communicatively coupled with, but are not part of, system 200.

Illustratively, the entity difference management system 200 may manage entities (including tracking, reporting, controlling, reconfiguring, and/or enforcing conformance) across a plurality of information management systems. Accordingly, system 200 may manage one or more of the following types of entities:
Information management cell 203,
Storage manager 140,
Information management policies 148, e.g., storage policy 148A,
Media agent 144,
Secondary storage devices 108, e.g., disk library 108A, tape library 108B,
Client computing device 102,
Sub-client, e.g., sub-clients 166 and 168,
Data agent 142,
Etc., without limitation.

An “entity” according to the illustrative embodiment is a component or element of an information management system 100 that can be configured and/or administered to operate within system 100 according to certain operational properties. As can be seen from the list above, an entity may be a logical and/or physical element of the information management system. An “operational property” is one or more rules (and/or preferences, criteria, parameters, configuration options, characteristics, and/or features) that apply to how an entity is to operate within information management system 100 and/or information management cell 203. Exemplary operational properties in reference to a storage policy entity are described above in regard to FIG. 1E, in particular reference to storage policy 148A (the entity) and applicable rule sets 160, 162, and 164 (operational properties for the entity). In regard to FIG. 1E, the use of disk library 108A for the backup copy is an example of an operational property of storage policy 148A; likewise, the use of tape library 108B for the disaster recovery copy is another exemplary operational property of storage policy 148B. In further regard to FIG. 1E and storage policy 148A, the 30-day retention rule for the backup copy is another exemplary operational property of storage policy 148A; likewise, the hourly copy rule for the backup copy is yet another exemplary operational property of storage policy 148A.

A “model entity” (or “template entity”) is defined as an entity having one or more preferred operational properties that are to be enforced across other entities. An entity having one or more operational properties that substantially differ from the preferred operational properties of the model entity is defined as a “non-conforming entity” (or “divergent entity”). In some embodiments, the non-conforming entity is further defined as an entity that is in current operation in an information management system, prior to any determination that it is non-conforming, such that the non-conforming entity must be reconfigured to conform with the model entity. This scenario is in contrast to an initial default configuration that enables some data protection operations to begin immediately for a newly installed element (as described above in paragraph[00207]), but which is neither based on enforcing preferred operational properties nor applies to a broad range of entities that are in current operation before they are determined to be non-conforming and consequently require reconfiguration.

Entity difference manager 201 (or “manager 201” for short) comprises functionality that is described in more detail below and in the accompanying figures. Manager 201 interacts functionally with one or more storage managers 140 within the information management cell(s) 203 to effectuate the functionality of entity difference management system 200 described herein. Entity difference manager 201 may be software and/or firmware that executes on a host computing device comprising electronic circuitry for executing computer instructions and which computing device is configured to enable and also to perform the functionality of manager 201; in some embodiments, manager 201 is itself a computing device that comprises electronic circuitry for executing computer instructions and which computing device is configured to enable and also to perform the functionality described herein.

Information management cells 203 are described in more detail above, at least in paragraph[00113], each cell 203 comprising an information management system 100 as described in detail above. According to the illustrative embodiment, each cell 203 comprises at least one storage manager 140, such that entity manager 201 communicates to and from (i.e., is communicatively coupled to) the respective storage manager(s) 140 configured in each cell 203, as discussed in further detail below. Information management cell(s) 203 may comprise any number of components of an information management system described herein, e.g., any number of client computing devices 102, any number of secondary storage computing devices 106, etc., without limitation; furthermore, cell(s) 203 may be configured hierarchically and each cell 203 may comprise a set of components that differs from the components operating in other cell(s) 203, without limitation. For example, one cell 203 may comprise tape library 108B, whereas another cell 203 may comprise disk library 108A, etc. without limitation. For example, one cell 203 may have data agents 142B configured on every client computing device 102, whereas another cell may have only data agents 142A configured on client computing devices 102, etc. without limitation.

Entity difference manager 201 and storage manager(s) 140 are each configured to communicate electronically with each other via at least a respective communication link 205 according to the illustrative embodiment; they may be in direct electronic communication, e.g., via dedicated lines; or may be indirectly connected, e.g., via public and/or private telecommunications network(s) such as a private intranet and/or the Internet, without limitation. Thus, each storage manager is said to be communicatively coupled to a given entity difference manager 201, though the respective communication link 205 need not be always “on,” and may in some embodiments be an intermittent connection (e.g., on demand, scheduled, etc.). Likewise, a computing device that is and/or hosts manager 201 and/or storage manager(s) 140 is configured to communicate electronically via at least a respective communication link 205 according to the illustrative embodiment.

Optionally, information management cells 203 are communicatively coupled to each other via communication links (not shown) using one or more components in cell(s) 203 that are each configured to communicate electronically, e.g., via management agent(s) 154; they may be in direct electronic communication, e.g., via dedicated lines; or may be indirectly connected, e.g., via public and/or private telecommunications network(s) such as a private intranet and/or the Internet, without limitation.

In alternative embodiments, entity difference management system 200 may be differently configured and arranged than shown in the present figure. For example, a single computing device or a unified virtual computing environment may host storage manager 140 and manager 201 such that a communication link 205 operates as between modules within the same computing device/environment. For example, manager 201 may operate in a “cloud” computing environment that communicates and connects with storage manager(s) 140 via public and/or private telecommunications network(s) such as the Internet; likewise, manager 201 may be located anywhere worldwide, apart from storage manager 140, for example in a centralized configuration that communicates with a plurality of information management cells 203 and their constituent storage manager(s) 140.

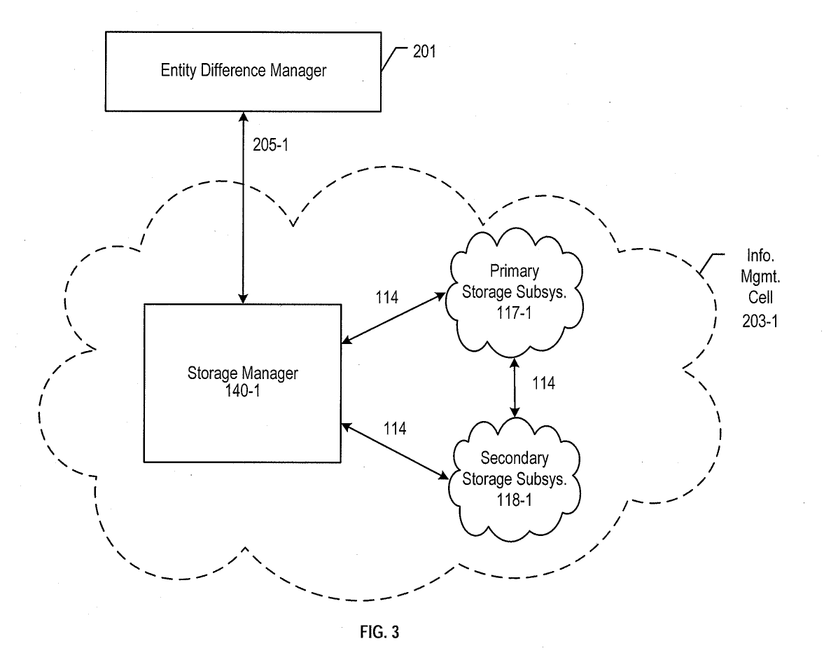

FIG. 3 depicts an illustrative detail view of information management cell 203-1 comprising storage manager 140-1 that is communicatively connected with entity difference manager 201. FIG. 3 depicts: manager 201 and information management cell 203-1, which comprises: storage manager 140-1, primary storage subsystem 117-1, and secondary storage subsystem 118-1, which were described in detail above. Communication link 205-1 between manager 201 and storage manager 140-1 is also depicted. Communication links 114 among storage manager 140-1, primary storage subsystem 117-1, and secondary storage subsystem 118-1, are also depicted. More details regarding entity difference manager 201 and storage manager 140-1 are described in further detail below and in the accompanying figures.

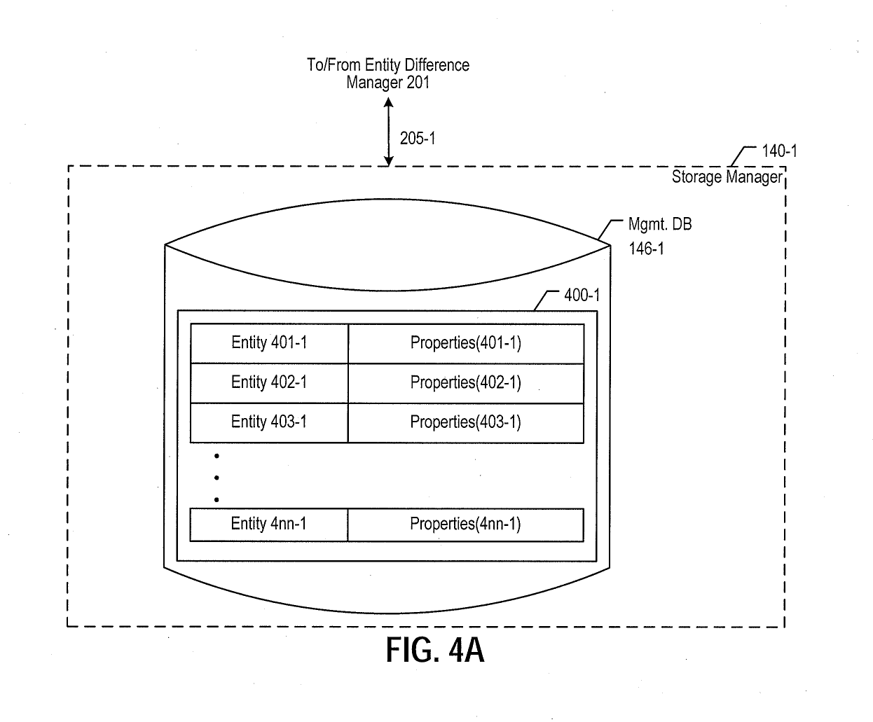

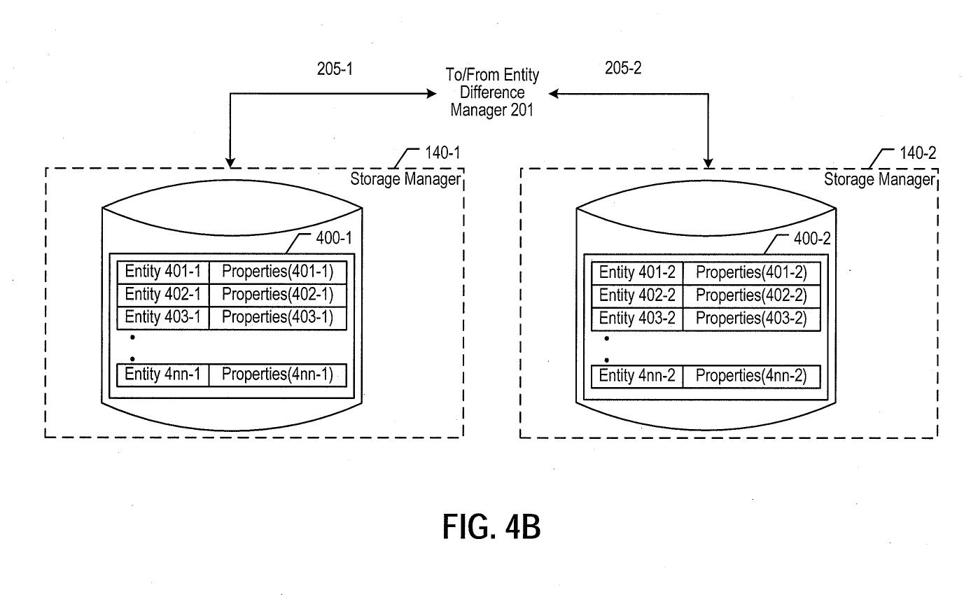

FIG. 4A depicts an illustrative detail view of storage manager 140-1, which is communicatively coupled to entity difference manager 201 via communication link 205-1. Storage manager 140-1 comprises: management database 146-1, which in turn comprises an illustrative data structure 400-1. In some embodiments, data structure 400-1 may not reside in management database 146-1; in some embodiments, data structure 400-1 may be a logical collection of data and data structures that are distributed within storage manager 140-1 and/or stored in an associated data store outside storage manager 140-1; in some embodiments, data structure 400-1 may be a logical collection of data and data structures that are distributed in one or more components of information management cell 203-1, which components may or may not include storage manager 140-1.

Data structure 400-1, according to the illustrative embodiment, comprises information about a plurality of entities managed by storage manager 140-1 and/or operating in information management cell 203-1, including information about each respective entity's one or more operational properties. Accordingly, each type of entity may have a set of one or more appropriate operational properties that are configurable in respect to that particular entity type. For convenience in the present disclosure, this set of operational properties is designated Properties (ID), e.g., entity 401-1 has the set of operational properties designated “Properties (401-1)”; entity 401-2 has the set of operational properties designated “Properties (401-2)”; etc. Each entity may have unique properties that apply only to that type of entity. Thus, a storage policy entity may have different operational properties than a library entity, which may differ from the properties for an information management cell. For example, a storage policy may have an operational property that is a retention time period, e.g., 30 days, 60 days, 10 years, etc. For example, a library entity of a certain type, e.g., disk library, tape library, etc., may have an operational property that is a mount path allocation policy, or a space allocation, or a “spill and fill” mount path property, etc., without limitation. Furthermore, the value of a given operational property may differ from one entity to another, even when the entity is of the same type. For example, a first storage policy may have a 30-day retention property for the backup copy, while a second storage policy may have a 60-day retention property. For example, a “spill and fill” operational property for a library entity may have a value of “yes” when it is enabled, and “no” when “spill and fill” is not to be used.

Illustratively, as depicted in FIG. 4A, data structure 400-1 comprises information about the operational properties of the entities managed by storage manager 140-1. Illustratively, data structure 400-1 comprises the operational properties designated Properties (401-1), which are associated with entity 401-1; likewise, data structure 400-1 further comprises the operational properties designated Properties (401-2), which are associated with entity 401-2; etc. Entity 401-1 may be of the same type as entity 402-1 (e.g., they may both be storage policies or more specifically storage policies for deduplication, etc.) or they may be entities of different types (e.g., 401-1 may be a storage policy and 402-1 may be a media agent, etc.).

FIG. 4B depicts an illustrative detail view of storage managers 140-1 and 140-2, each of which is communicatively coupled to entity difference manager 201 via communication links 205-1 and 205-2, respectively. Illustratively, storage manager 140-1 comprises data structure 400-1 as described in more detail in regard to FIG. 4A; storage manager 140-2 comprises a similar data structure 400-2 that comprises the sets of operational properties for entities 401-2, 402-2, 403-2 . . . 4nn-2, etc., which entities operate in the information management system managed by storage manager 140-2.

According to the illustrative embodiment, data structure 400-1 (or information residing therein) may be electronically communicated by storage manager 140-1 to manager 201 via communication link 205. Likewise, data structure 400-2 (or information residing therein) may be electronically communicated by storage manager 140-2 to manager 201 via communication link 205-2. Likewise with respect to any other storage managers 140 that are communicatively coupled to manager 201. Conversely, in some embodiments, data structure 400-1 may receive information updates and/or data replacements (in whole or in part) from manager 201 via communication link 205-1; likewise, data structure 400-2 may receive information updates and/or data replacements (in whole or in part) from manager 201 via communication link 205-2.

No one-to-one correspondence is required or implied as to the constituent data elements that form a data structure 400. For example, although FIG. 4B depicts entity 401 represented in both data structures 400-1 and 400-2, no such correspondence is required according to the illustrative embodiment. This is because, as noted above, some information management systems may comprise a certain kind of entity, e.g., a tape library 401-1, but another information management system need not comprise the same kinds of entity, e.g., a tape library. Conversely, one information management system may comprise one tape library 401-1, and another information management system may comprise three different tape libraries 401-2a, 401-2b, and 401-2c. The illustrative system 200 comprises the intelligence to classify, categorize, and recognize like entities and entity types (e.g., analogous tape libraries 401) so that it may enforce conformance to a proper model entity. Further, model entity may operate in one information management system, and the enforcement may apply to entities that operate in that same and/or in another information management system(s).

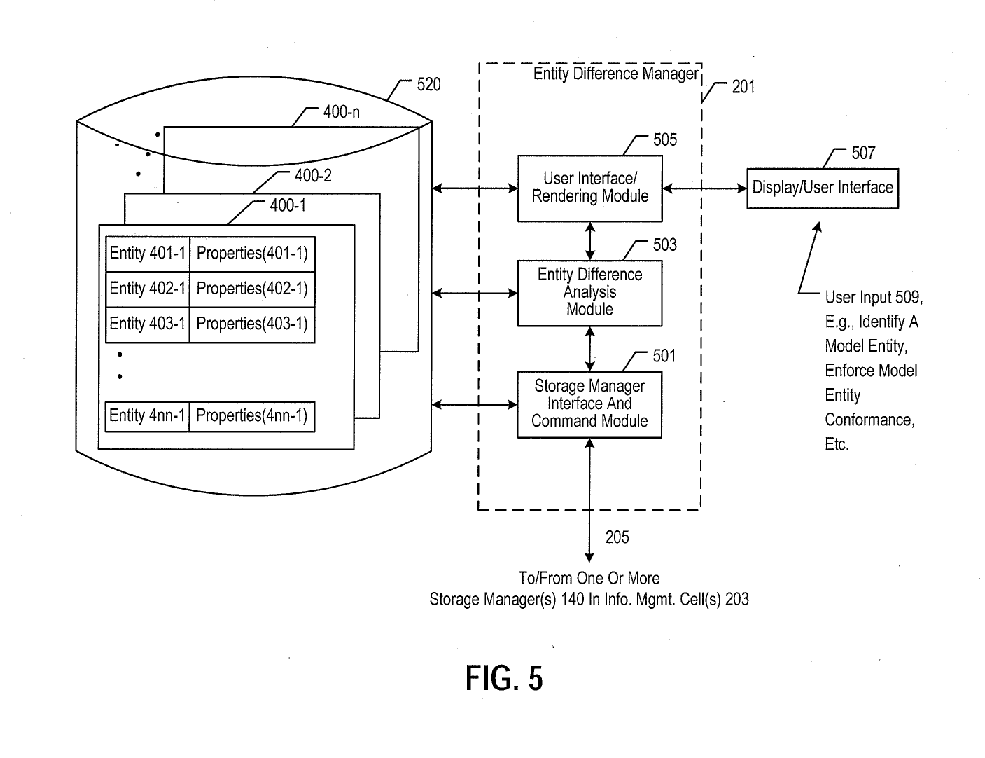

FIG. 5 depicts an illustrative detail view of entity difference manager 201, which is communicatively coupled with one or more storage managers 140 via respective communication links 205. Illustratively, entity difference manager 201 comprises: storage manager interface and command module 501; entity difference analysis module 503; and user interface/rendering module 505; furthermore, entity difference manager 201 is communicatively coupled to an associated data store 520 and to a display unit/user interface 507 that accepts user input 509. Illustratively, entity difference management system 200 comprises the display unit/user interface 507 and data store 520; in some embodiments, one or more of these components are not part of system 200.

Entity difference manager 201 performs one or more of the salient operations of method 600. Moreover, manager 201 interacts functionally with one or more storage managers 140 within the information management cell(s) 203 to effectuate the functionality of entity difference management system 200 described herein. In the exemplary embodiment, the functionality of manager 201 is distributed among a plurality of functional modules 501, 503, and 505. In other embodiments, entity difference manager 201 may be differently configured and organized. For example, the functionality of the depicted modules and/or associated data structure(s) may be sub-divided differently, consolidated (in whole or in art), and may reside within or outside of manager 201 and/or in a distributed, virtualized, or cloud computing environment. For example, entity difference analysis module 503 may comprise the functionality of module 505 and/or module 501.

Storage manager interface and command module 501 exemplarily communicates to/from one or more storage managers 140, and further receives data from storage manager(s) 140 and stores the received data into data store 520 and/or into other data repositories associated with manager 201. Module 501 may further extract information from data store 520 (and/or from other data sources/repositories) and communicate the information to storage manager(s) 140 and to other components of manager 201, e.g., analysis module 503. Module 501 may also generate and/or compose one or more messages for the storage manager(s) 140, e.g., instructions to collect data, instructions to report information, queries for information, scripts and corresponding instructions to execute the scripts, instructions to change one or more properties of an entity to match the operational properties of a model entity (i.e., to transform a non-conforming entity into a model-conforming entity), etc. Furthermore, module 501 may be configured to transmit the generated messages to the appropriate storage manager(s) 140. According to the illustrative embodiment, module 501 performs some of the operations and/or sub-operations of method 600 herein in cooperation with one or more other modules of manager 201 as described in further detail below and in the accompanying figures.

Entity difference analysis module 503 exemplarily determines the salient operational properties of an entity that is identified as a model entity; and further determines which other corresponding entities are operating in one or more information management systems 100 and/or cells 203; and further still it determines whether substantive differences exist between the model entity and the other corresponding entities, i.e., module 503 determines which entities are non-conforming entities; and further still it directs module 501 to compose and transmit instructions to the appropriate storage manager(s) 140 in reference to the non-conforming entities. Module 503 also has access to data store 520 and/or any other data repositories associated with manager 201, whether residing within manager 201 or without. According to the illustrative embodiment, module 503 performs some of the operations and/or sub-operations of method 600 herein in cooperation with one or more other modules of manager 201 as described in further detail below and in the accompanying figures.

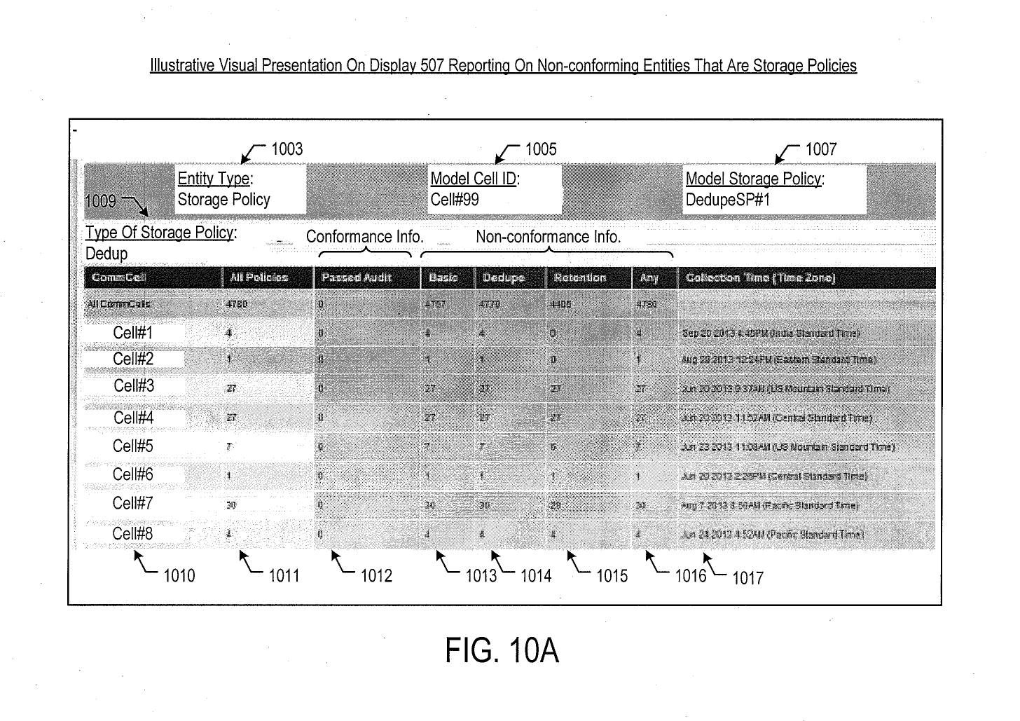

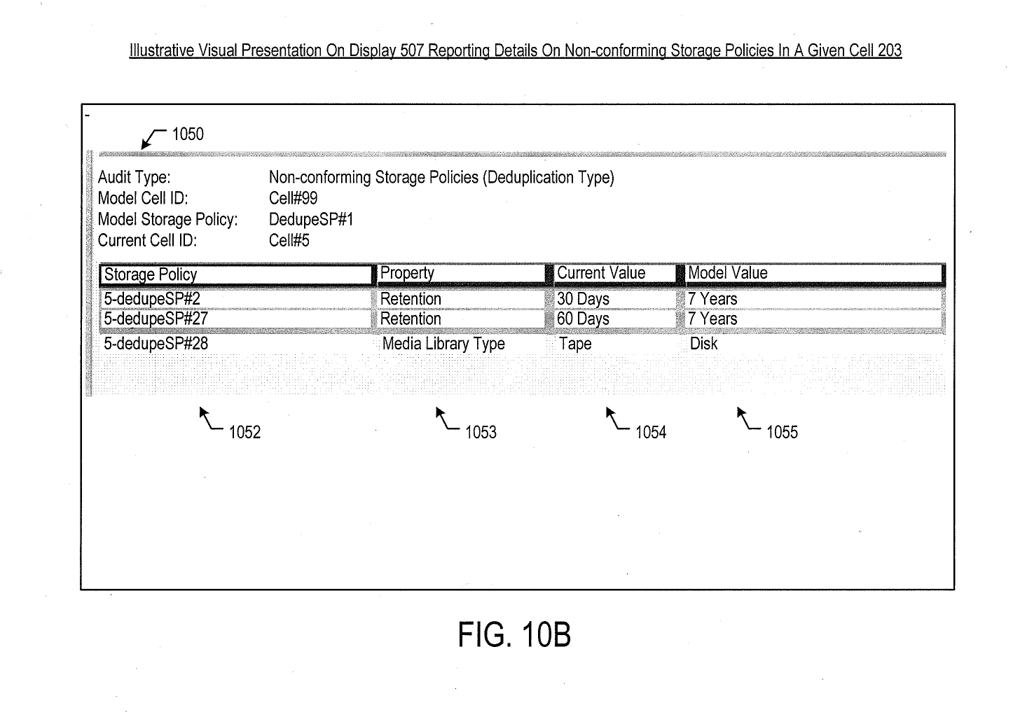

User interface/rendering module 505, according to the present embodiment, performs the user interface interpretation and/or display rendering for the salient tasks of method 600 as described in further detail below. For example, module 505 may receive information from analysis module 503 and render the information into a visual format suitable for presentation to a user on display unit 507 (e.g., as in FIG. 10A, etc.). For example, module 505 receives the user input transmitted by display/user interface 507 and transmits the information to module 503, such as transmitting a user-identified model entity, or transmitting a user command to enforce model entity conformance, etc. According to the illustrative embodiment, module 505 performs some of the operations and/or sub-operations of method 600 herein in cooperation with one or more other modules of manager 201 as described in further detail below and in the accompanying figures.

Display unit/user interface 507 may be any display unit that is known in the art and that is configured to present an interactive user interface to a user of exemplary system 200. For example, display/user interface 507 is capable of receiving user input 509 (e.g., wherein the user identifies a model entity, wherein the user requests model entity enforcement, etc.) and is further capable of transmitting said user input to manager 201. Display/user interface 507 displays information that is presented to a user by manager 201, such as the illustrative examples shown in FIG. 10A, 10B, etc. For example, a user selects from a plurality of entities and identifies a selected entity as the model entity. The analysis and reporting operations that follow according to the illustrative embodiment are based on the properties of the identified model entity and any pertinent differences therefrom. In some embodiments, the model entity is identified in a different way, such as by establishing it as a model via administration of the information management system; as a system default; etc., without limitation.

Enforcing model entity conformance is illustratively triggered when the user pro-actively requests it, so that one or more entities' properties are reconfigured (e.g., changed, adjusted, modified, re-administered, updated, etc.) to match or appropriately conform to the relevant properties of the model entity. Enforcement may be immediately processed, issued, and transmitted to the respective targets to execute the instructed reconfiguration(s); or enforcement may begin, but final execution is deferred to an appropriate starting time, e.g., after system elements have been quiesced, at a fixed time of day, during scheduled down-time, etc.; or a combination thereof, without limitation. Thus, the timing of when enforcement takes effect may differ from the time when a user input is received.

Data store 520 illustratively comprises a copy of data structure 400-1 received from storage manager 140-1, a copy of data structure 400-2 received from storage manager 140-2, etc. Data store 520 provides manager 201 with readily available information from the target information management cells 203 so that manager 201 may perform without burdening the target storage managers 140 or the communication links 205. In some embodiments, data store 520 is a logical collection of the entity and property information required by manager 201. In some embodiments, data store 520 is incorporated in entity difference manager 201.

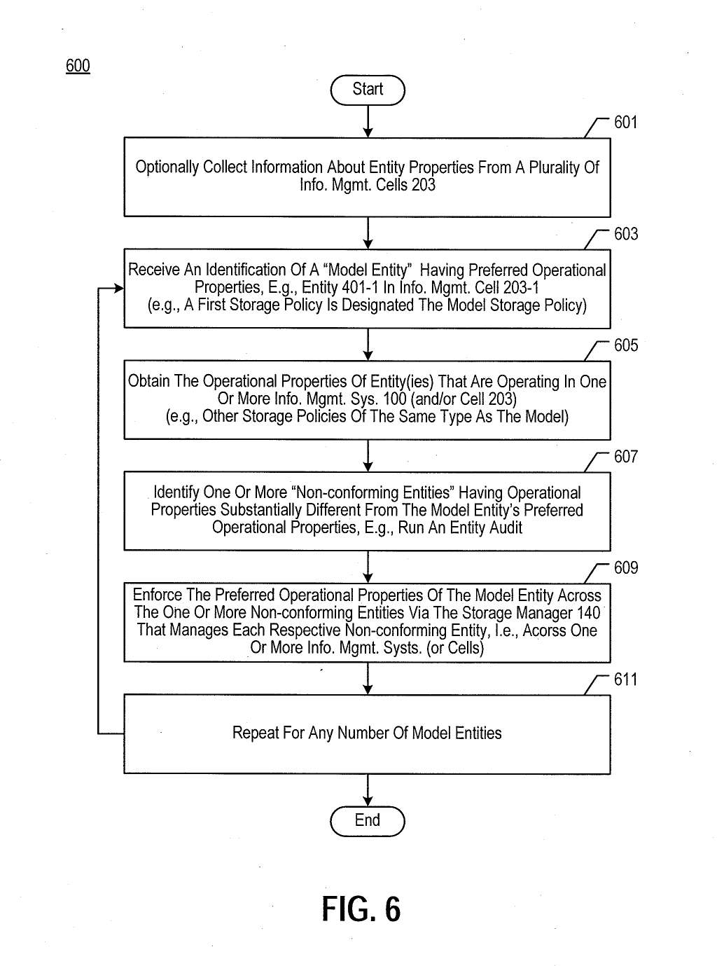

FIG. 6 depicts some salient operations of exemplary method 600 according to an illustrative embodiment. Illustratively, method 600 is performed by entity difference manager 201, including one or more constituent modules thereof.

At block 601, which is optional, manager 201 collects information about the properties of a plurality of entities from a plurality of information management cells 203. For example, the information may be collected from the storage manager 140 that manages the respective information management cell 203. In other embodiments, the information may be collected from one or more entities or from other components of the respective information management cell 203, e.g., from a stand-by storage manager, from an index, from a data agent, from a media agent, from a centralized console, etc., and/or a combination thereof, without limitation. Illustratively, the information is collected by querying the respective components via communication path(s) 205 and/or 114.

Illustratively, the information collected here is stored in data store 520. Illustratively, the information is collected periodically—an automatic operation performed by manager 201 that does not require user input or prompting. Thus, illustratively, manager 201 collects information daily for every entity subject to system 200. In other embodiments, manager 201 collects information on a different schedule and/or for some but not all entities subject to system 200. In some embodiments, manager 201 may launch queries to collect the information; or manager 201 may transmit initial instructions to the respective storage managers 140 (or other target components/entities) instructing them to report information to manager 201 on a regular basis; or the information is collected on demand, as triggered by user input to launch queries; or a combination thereof, without limitation.

At block 603, manager 201 receives an identification of a model entity that has certain preferred operational properties. For example, entity 401-1 in information management cell 203-1 is a storage policy that is designated to be the model entity. As noted earlier, the designation of an entity as the model entity may occur via user input or may be pre-configured into manager 201 and/or into one or more storage managers 140, or any combination thereof, without limitation. For example, a model storage policy may be so designated in a given information management cell 203 at a certain time. As an example, the designated model entity is a storage policy that is directed at producing compliance copies of certain data, e.g., storage policy 148A under rule set 164, as depicted in FIG. 1E and accompanying paragraphs. The relevant operational properties here are the elements of rule set 164, including type “compliance copy,” email subclient 168, tape library 108B, media agent 144B, retention of 10 years, saved to secondary storage quarterly.

At block 605, manager 201 obtains one or more operational properties of one or more entities that correspond to the model entity. For example, if entity 401-1 is the designated model entity, manager 201 obtains operational properties for other like entities operating in the present and/or other information management cells 203, e.g., entity 401-2 in cell 203-2 and entity 401-3 in cell 203-3. According to the example above, manager 201 would obtain operational properties for other storage policies subject to a “compliance copy” rule set. There is no limitation on the number of corresponding or like entities that operate in any given information management cell 203 or the number of corresponding or like entities across a plurality of information management cells 203. Likewise, there is no limitation on the number of properties that may be collected as to any given entity or type of entity. Therefore, any number of properties for any number of entities across any number of information management cells 203 may be collected in this block. Illustrative, though not exhaustive, examples of operational properties that may be associated with a particular type of entity that is subject to audits and/or enforcement by system 200 are shown in the table below, without limitation:

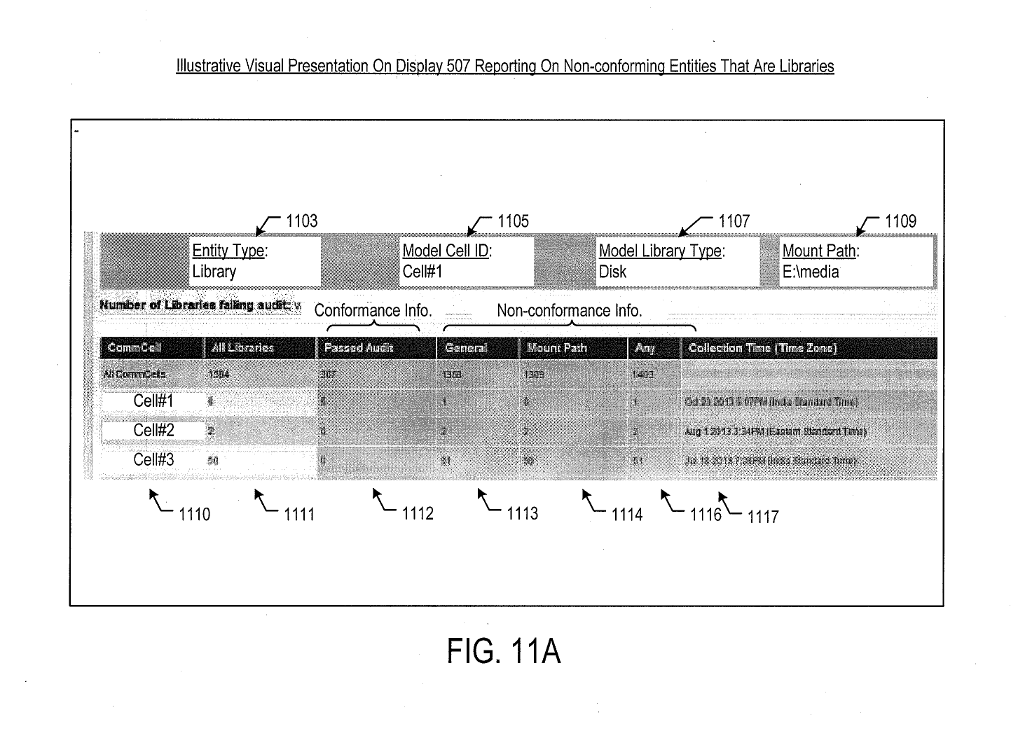

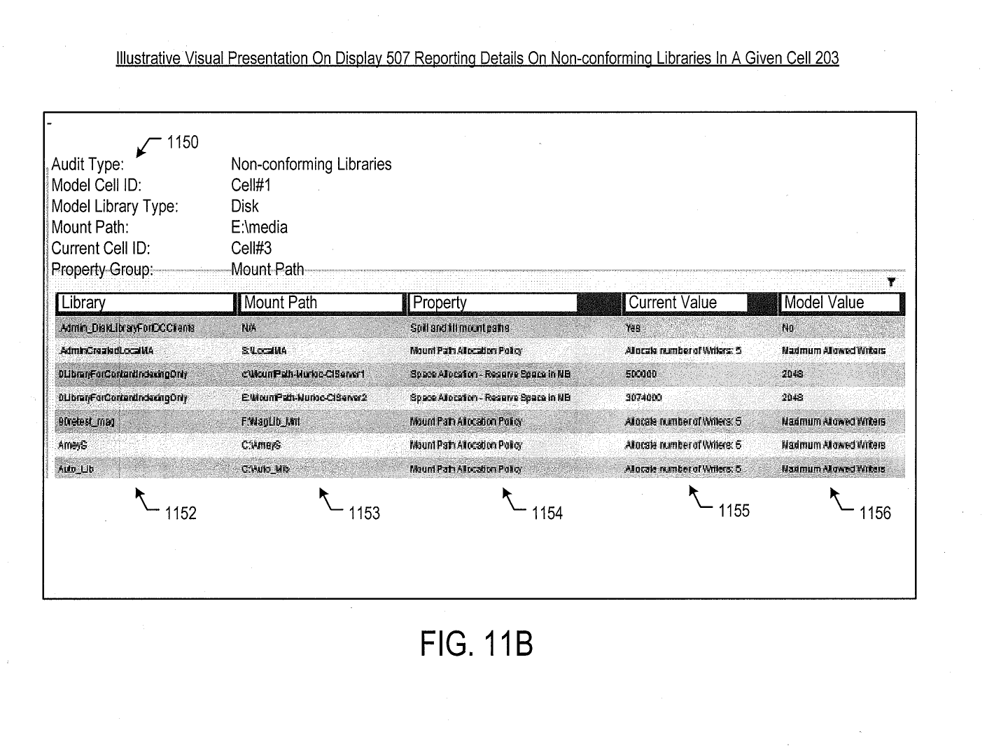

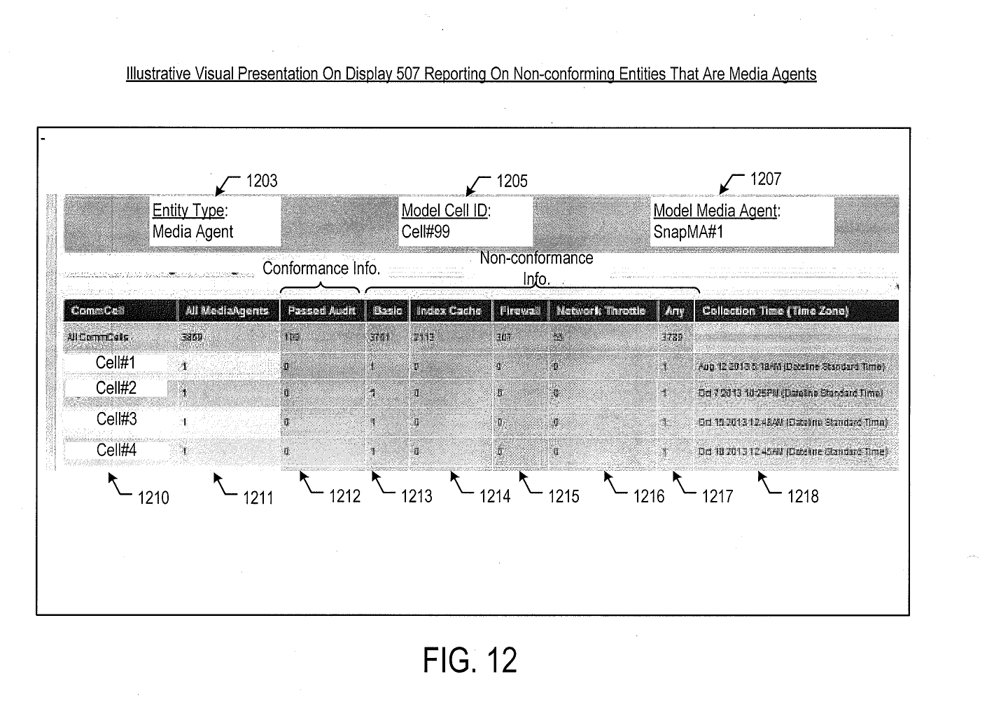

TABLE 1

| | OPERATIONAL |
|---|---|
| ENTITY | PROPERTIES TO AUDIT |
| (illustrative examples | (illustrative examples |
| without limitation) | without limitation) |
| Information | Retry enablement on network errors; retry |
| management | frequency; retry count; version and/or |
| cell(s) and/or | service pack number (release version) for |
| associated storage | one or more elements of the information |
| manager(s) | management cell(s) and/or of the storage |
| | manager, e.g., management database |
| | version, cloud-based database version, |
| | storage manager file system version, |
| | and/or other agents on the storage |
| | manager; firewall configuration; Internet |
| | proxy configuration; etc. |
| Information | Number of device streams; number of |
| management policies, | active copies; use of alternate data paths |
| including without | when resource is busy; media refresh |
| limitation entity type | months after media were written; see also |
| storage policy, | paragraphs [00198], [00211], and [00212] |
| audit policy, and/or | and FIGS. 10A and 10B and |
| provisioning policy, etc. | accompanying paragraphs, etc. |
| Secondary storage | Spill & fill options; mount path allocation |
| devices, including | policy; library enablement; see also |
| without limitation | FIGS. 11A and 11B and accompanying |
| entity type library | paragraphs, etc. |
| Client computing | Retry enablement on network errors; retry |
| devices, including | frequency; retry count; content indexing |
| without limitation | enablement, client-level firewall |
| entity type client | configuration; network throttling; client |
| | version; etc. |
| Sub-client, | Number of data readers; scan options, |
| including without | e.g., change journal, recursive scan, |
| limitation | optimized scan; cataloguing additional file |
| entity type | and system attributes; cataloguing end |
| file system | user access control list; deleting protected |
| | PST files; etc. |
| Data agent, | Office communications server backup |
| including without | enablement; archiving enablement; etc. |
| limitation | |
| entity type file- | |
| system data agent | |
| Media agent | Index cache; firewall; network throttle; |
| | media agent version; whether to use a |
| | native device driver for data transfer to |
| | media; see also FIG. 12 and |
| | accompanying paragraphs; etc. |

Manager 201 illustratively obtains the one or more operational properties from data store 520, i.e., the data has been populated into data store 520, such as via the operations of block 601. In some embodiments, the information may not be available from data store 520 (in whole or in part), and in such a case manager 201 may invoke one or more operations described in block 601 to gather the needed information, e.g., launching queries, transmitting instructions to query and/or to execute scripts, etc.

At block 607, manager 201 analyzes the gathered information pertaining to the various entities and their operational properties, for example by executing an entity audit. As a result of the analysis (e.g., entity audit), manager 201 may identify one or more entities that correspond to the model entity but which are non-conforming in respect to one or more operational properties. For example, the entity audit may identify other storage policies that are subject to a compliance copy rule set, but where the subclient is not an email subclient and/or the retention time is not 10 years and/or the compliance copy is generated annually. When one or more operational properties of an entity substantially differs from the operational properties of the model entity, the entity is said to have failed the entity audit and is determined to be non-conforming relative to the model entity. Block 607 is described in further detail in another figure below.

At block 609, manager 201 enforces the preferred operational properties of the model entity to the one or more non-conforming entities in one or more information management systems and/or cells. The enforcement is illustratively implemented via the storage manager 140 that manages the respective non-conforming entity, e.g., storage manager 140-1 manages entity 402-1, etc. Block 609 is described in further detail in another figure below.

At block 611, control loops back to block 603 to repeat the enumerated operations for any number of other model entities. There is no limit on how many model entities may be enforced by system 200 and likewise no limit on how many information management cells 203 may be audited and managed accordingly.

In alternative embodiments, method 600 may be differently organized, executed, sequenced, sub-divided into sub-operations, consolidated, and/or distributed for execution among different system modules and/or components and/or computing platforms. For example, in some embodiments, method 600 is executed by a storage manager 140; or in part by manager 201 and in part by a storage manager 140; or is hosted by the same computing device/environment that hosts storage manager 140 and entity difference manager 201; etc., without limitation. Any number, variations, and arrangements of the operations, instructions, interactions, and reports described herein may be implemented in connection with entity difference management system 200 within the scope of the present invention.

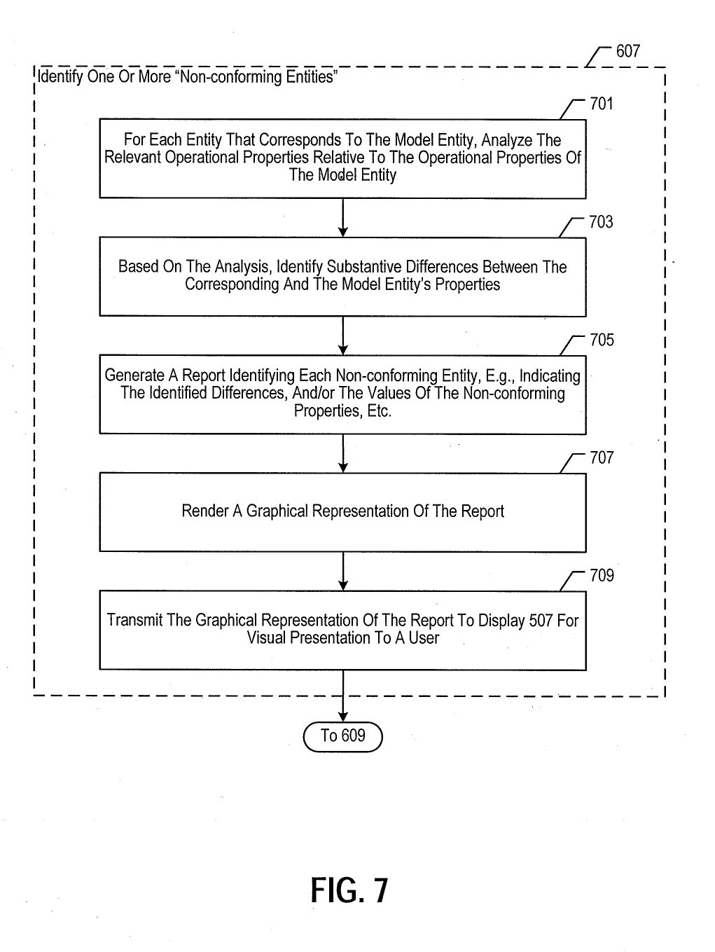

FIG. 7 depicts some salient operations of block 607 in method 600. Illustratively, manager 201 analyzes the gathered information pertaining to the various entities and their operational properties, for example by executing an entity audit to identify one or more non-conforming entities.

At block 701, for each entity that corresponds to the model entity (e.g., other storage policies, other media agents, etc.) manager 201 analyzes the relevant operational properties relative to the operational properties of the model entity, which are the preferred operational properties to be enforced in the respective information management system. For example, in reference to FIG. 1E, if storage policy 148A according to rule set 160 (i.e., a backup copy storage policy) were designated to be the model entity, the relevant operational properties of storage policy 148A might comprise, illustratively, the types of sub-clients covered by the storage policy (e.g., file system sub-client 166 and email sub-client 168), the destination secondary storage device (e.g., disk library 108A) and its type (e.g., a disk library), the respective media agent (e.g., media agent 144A), the retention time (e.g., 30 days), and the scheduling parameters of the backup (e.g., hourly). Corresponding storage policies to be analyzed/audited here might illustratively include other storage policies for generating backup copies; or other storage policies for backup copies having a disk library as a target secondary storage device; or other storage policies for backup copies having a given media agent; etc. without limitation. Notably, some properties, such as the identifying name given the storage policy would not be considered relevant operational properties, because such properties have no bearing on how the storage policy operates.

Accordingly, at block 701 an entity's operational properties are compared against the model entity's preferred operational properties. An illustrative example of storage policies and relevant operational properties to be analyzed by entity difference manager 201 appears in the table below:

TABLE 2

| | | Sub- | Media | Target | | | |
|---|---|---|---|---|---|---|---|
| Entity | Type | clients | Agent | Type | Data Path | Retention | Schedule |
| Model | Backup | File | 1 | Disk | Disk | 30 days | Hourly |
| Entity = | copy | system, | | | library | | |
| storage | | Email | | | 108A | | |
| policy | | | | | | | |
| 148A, | | | | | | | |
| rule set | | | | | | | |
| 160 | | | | | | | |
| Sample-1 | Backup | File | 1 | Disk | Disk | 30 days | Hourly |
| | copy | system | | | library | | |
| | | | | | 108A | | |
| Sample-2 | Backup | Email | 1 | Disk | Disk | 30 days | Hourly |
| | copy | | | | library | | |
| | | | | | 108A | | |
| Sample-3 | Backup | File | 2 | Tape | Tape | 30 days | Hourly |
| | copy | system, | | | library | | |
| | | Email | | | 108B | | |
| Sample-4 | Backup | File | 1 | Disk | Disk | 180 days | Hourly |
| | copy | system, | | | library | | |
| | | Email | | | 108A | | |
| Sample-5 | Backup | File | 1 | Disk | Disk | 30 days | Daily |
| | copy | system, | | | library | | |
| | | Email | | | 108A | | |

Thus, storage policy Sample-1 is compared, operational-property-by-operational-property, against the model entity storage policy 148A (backup copy/rule set 160). Likewise, the other entities are also analyzed. The numbers and kinds of properties of a given entity that manager 201 deems to be a proper operational property for purposes of the present analysis will vary from entity to entity and will further vary among different embodiments of manager 201. For example, in some embodiments, the identity of the media agent associated with a storage policy will be treated as a relevant operational policy to be analyzed at this stage; in alternative embodiments, the identity of the media agent shall not be deemed relevant and shall not be analyzed here.

Illustratively, the information about the operational properties of the entities Sample-1 through Sample-5 (and/or the Model Entity) may be stored in data structure 400-1 in data store 520, as illustratively depicted in FIG. 5 (and/or in other data structures 400). Notably, there is no limitation on the number and types of entities and their operational properties that may be stored in data structure(s) 400 and analyzed here. Other information about the properties of one or more entities may also be stored in data store 520 and/or data structure(s) 400, without limitation. The information is available to entity difference manager 201 and to any of its constituent modules.

At block 703, substantive differences between the model entity and the corresponding entities are identified. Continuing with the example storage polices set forth in Table 2 above, the present analysis would identify substantive difference(s) as between the model storage policy and each one of the other listed storage policies, Sample-1 through Sample-5. For example, Sample-1 differs from the model storage policy by having only a file system as an associated sub-client to backup. Illustratively, this operational property substantially differs from the model storage policy, which backs up file system AND email sub-clients. Sample-2 substantially differs from the model storage policy by having only an email sub-client. Sample-3 substantially differs from the model storage policy by using a different media agent to back up to tape, not disk. Sample-4 substantially differs from the model storage policy by having a longer retention time. Sample-5 substantially differs by having a different backup schedule, e.g., daily instead of hourly.

Based on these analyses, because one or more operational properties of the exemplary storage policy entities substantially differs from the operational properties of the model storage policy entity, each one of entities Sample-1 through Sample-5 is designated a non-conforming entity. Illustratively, if an entity operates according to operational properties substantially the same as the model entity's operational policies, the entity is designated as “conforming.” For example, a storage policy having the same operational properties of the model storage policy in Table 2 would be a conforming storage policy. No conforming entities are shown in Table 2.

At block 705, a report is generated, identifying each divergent (non-conforming) entity. Illustratively, the report further indicates what the differences are between the model entity and the corresponding one or more divergent (non-conforming) entities. An exemplary illustration of such a report as presented to a user may be seen in FIG. 10B. According to the example from Table 2, entities Sample-1 through Sample-5 would be identified in the illustrative report as “divergent entities” or “non-conforming entities” relative to the preferred operational properties of the model entity, e.g., storage policy 148A (backup/rule set 160).

At block 707, a graphical representation of the report is rendered, illustratively by the user interface/rendering module 505 shown in FIG. 5. As is well known in the art, this may include formatting and arranging of data into a visual presentation that may be presented to a user viewing display/user interface unit 507.

At block 709, the rendered graphical representation is transmitted to display/user interface unit 507 for visual presentation to a user. An illustrative visual presentation is shown in FIG. 10A, wherein the number of entities that conform (or are illustratively said to have passed the entity audit) is shown in the “Passed Audit” column. According to the illustration in FIG. 10A, zero entities have passed the entity audit, i.e., none conform with the model entity. Conversely, the numbers of entities that diverge on certain operational properties are shown in some of the other columns to the right of the “Passed Audit” column. More detail may be additionally reported and graphically rendered and presented to a user, as illustratively depicted in FIG. 10B.

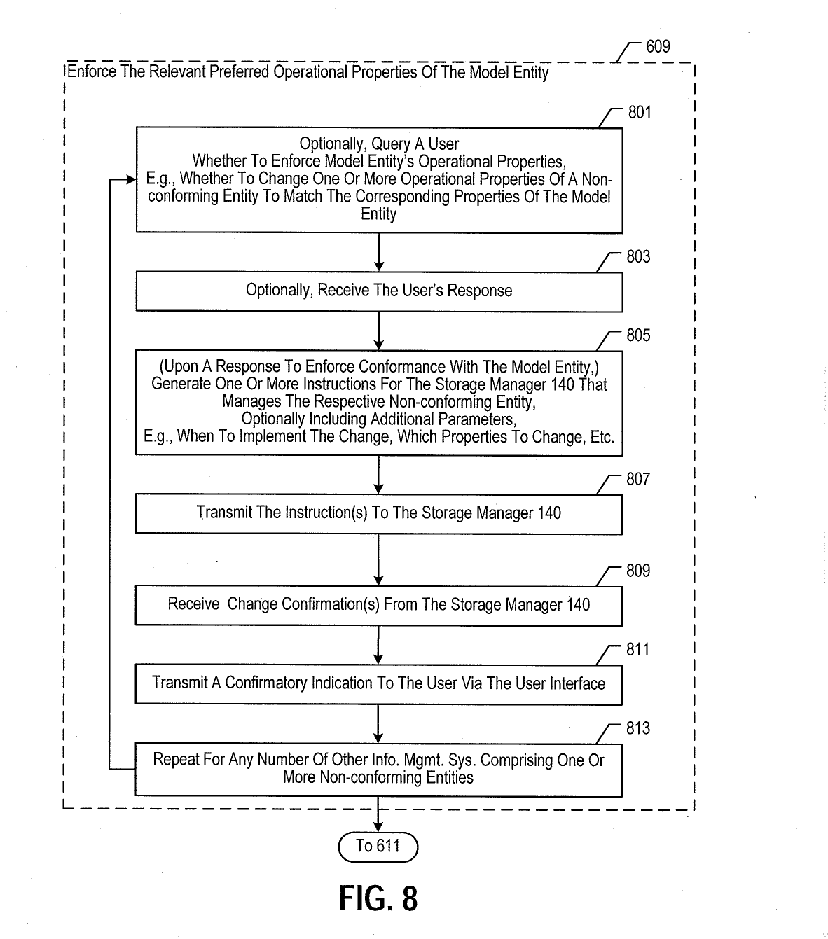

FIG. 8 depicts some salient operations of block 609 in method 600. At block 609, manager 201 enforces the preferred operational properties of the model entity across the one or more non-conforming entities.

At block 801, which is an optional sub-operation, difference entity manager 201 (including one or more constituent modules thereof) queries a user whether to change one or more operational properties of a divergent (non-conforming) entity to match the corresponding preferred operational properties of the model entity, i.e., whether to reconfigure the non-conforming entity. In other words, the user is queried whether to enforce the preferred operational properties of the model entity. In some embodiments, enforcement and control over non-conforming entities is performed automatically without user input, e.g., via an entity audit that identifies and reconfigures non-conforming entities. Illustratively, the user is prompted via display/user interface unit 507.

At block 803, which is an optional sub-operation, difference entity manager 201 receives the user's response to the preceding query. For example, the user's response could be to request enforcement. Alternatively, the user may decline enforcement, and permit the divergent (non-conforming) entity to continue operating according to operational properties that substantially differ from the preferred operational properties of the model entity.

At block 805, manager 201 generates one or more instructions for storage manager 140 that manages the information management system 100 (and corresponding information management cell 203) that comprises the non-conforming entities. This may occur upon receiving a user response to enforce conformance with the model entity or automatically in some embodiments. By virtue of managing the information management system 100 in which the non-conforming entities operate, the storage manager 140 also manages the entities themselves in respect to operations of the information management system (whether directly or indirectly via other components). The instruction(s) direct storage manager 140 to enforce the model entity's one or more preferred operational properties by reconfiguring the non-conforming entities, e.g., by changing operational properties of the respective non-conforming entities. The instruction(s) may direct the receiving storage manager(s) to enforce all or only some of the preferred operational properties of the model entity. For example, in regard to a model entity that is a storage policy, conformance with a retention time may be enforced, but enforcement of a target/data path may not be enforced, etc., without limitation.

The generated instructions may also comprise additional parameters, such as, illustratively, a quiesce command, a time frame for implementing the changed operational properties, an enumeration of the properties to be changed and the nature of the change to achieve conformance, etc. without limitation. The instructions may be entity-specific, property-specific, time frame-specific, or some sub-set or combination thereof, without limitation. In some embodiments, the instruction(s) may incorporate one or more of the model entity's preferred operational properties.

At block 807, the generated instructions are transmitted from the entity difference manager 201 to the storage manager responsible for the respective one or more non-conforming entities. As noted earlier, the entity difference manager 201 and the storage manager(s) 140 are communicatively coupled. They may or may not be permanently communicatively coupled. They may be directly or indirectly connected, e.g., via private and/or public networking.

At block 809, entity difference manager 201 receives confirmatory message(s) from the storage manager 140 that received the instructions. The confirmatory message(s) may acknowledge that the instructed reconfigurations have occurred to comply with the preferred operational properties of the model entity.

At block 811, entity difference manager 201, based on the confirmatory message(s) received from the storage manager 140, generates and transmits a confirmation to the user via display/user interface unit 507 in a manner that is well known in the art. In some embodiments, the confirmation to the user may comprise running an entity audit and presenting updated audit results that indicate conformance as appropriate.

Block 813 represents the iterative nature of block 609, i.e., that any number of non-conforming entities in the present information management system (and/or information management cell 203) and in other information management systems (and/or information management cells 203) may be operated upon according to block 609. Entity difference manager 201 may enforce the preferred operational properties of a model entity in the same or foreign information management systems (and/or information management cells) as the information management system comprising the model entity, without limitation.

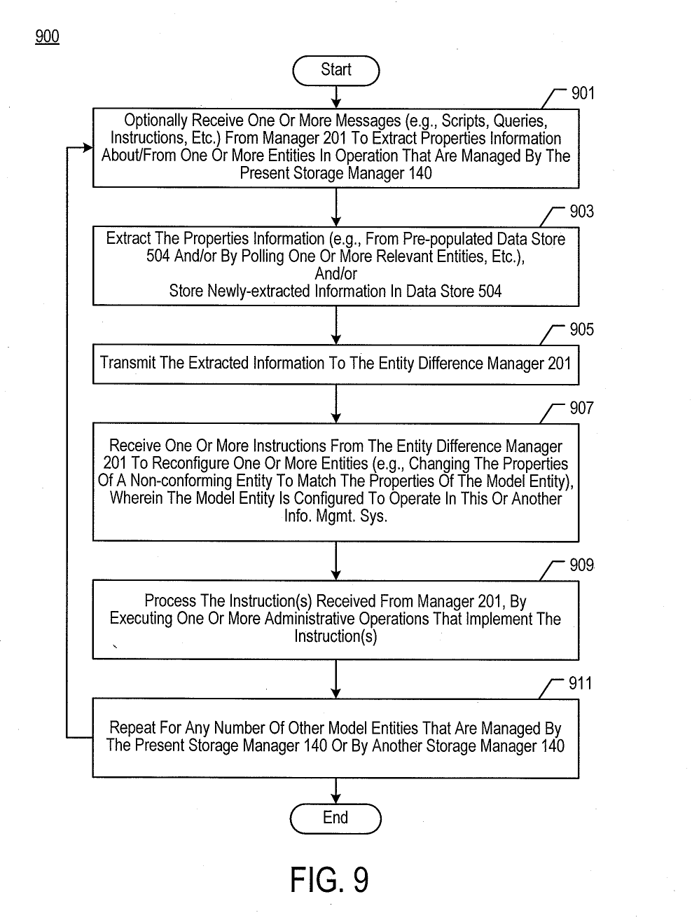

FIG. 9 depicts some salient operations of exemplary method 900 according to an illustrative embodiment. Illustratively, method 900 is performed by a storage manager 140, including one or more constituent modules thereof, wherein the storage manager 140 is communicatively coupled to an entity difference manager 201.

At block 901, storage manager 140 receives one or more messages from entity difference manager 201. The one or more messages may take the form of scripts for storage manager 140 to execute, queries for storage manager 140 to execute/respond to, and/or instructions for storage manager 140 to execute, and/or any combination thereof, without limitation. The message(s) direct the storage manager 140 to extract (or obtain) information about the operational properties of one or more entities operating in the information management system 100 (and/or cell 203) that the storage manager 140 manages. The information may be obtained by polling one or more of the respective entities; polling one or more associated data sources, e.g., indexes; and/or extracting data from other data stores that are associated with various components of the information management system 100 (and/or cell 203) and/or are specifically associated with the storage manager 140.

At block 903, storage manager 140 extracts (obtains) the information about the operational properties according to the received messages, whether by executing scripts, executing queries, polling, searching, data extraction, etc., or any combination thereof, without limitation. The information extracted (obtained) here may be limited to certain operational properties of certain entities, or may be a broader sweep that includes other information for entities that are actively operating and/or are configured in the information management system (or cell). The information extraction operation may be on-demand responsive to prompting by entity difference manager 201, may be performed on a scheduled basis, or a combination thereof, without limitation. Optionally, the extracted information is stored locally in one or more data structures 400, which illustratively reside in storage manager 140, e.g., in management database 146. In some embodiments, the information is stored in data structures that are associated with, but are not stored in, storage manager 140. In some embodiments, the extracted information is transmitted by storage manager 140 to entity difference manager 201 and is not stored locally.

At block 905, the information obtained (extracted) in the previous block is transmitted to entity difference manager 201. The transmission may be on-demand responsive to message(s) from entity difference manager 201, or may be scheduled, or some combination thereof, without limitation. For example, in a scheduled scenario, storage manager 140 may execute scripts received from manager 201 that are executed on a schedule to populate one or more data structures 400. The resultant data structures 400 are then transmitted by storage manager 140 to manager 201, where they are stored in data store 520.

At block 907, storage manager 140 receives one or more instructions from manager 201 directing the storage manager 140 to enforce certain operational properties. The instructions may direct the storage manager to reconfigure certain entities in the information management system, e.g., to change the operational properties of certain entities from a present non-conforming property to a conforming property that matches the preferred operational property of the model entity. For example, in reference to the non-conforming entities Sample-1 through Sample-5 illustrated in Table 2 above, an instruction may direct storage manager 140 to change the retention time of storage policy Sample-4 to 30 days, thus enforcing the retention period of the model entity. For example, an instruction may comprise ALL the operational properties of the model entity, instructing storage manager 140 to reconfigure certain (non-conforming) entities. Any combination of these scenarios also is possible. Thus, the collective instructions from manager 201 to subject storage manager 140 enforce conformance with the model entity.

At block 909, storage manager 140 processes the received instructions and changes the non-conforming entities' operational properties to match the preferred operational properties of the model entity. The change may take the form of changing a property to another property (e.g., change a storage policy from a backup type to a disaster recovery type) and/or changing a non-conforming value of a property to a conforming value (e.g., changing the retention time property from a non-conforming value of 60 days to a conforming value of 30 days). Storage manager 140 thus effectuates the enforcement of the model entity across one or more other entities, whether the model entity is configured to operate in the present information management system 100 (and/or cell 203) or in another (foreign) information management system (and/or cell), and any combination thereof, without limitation.

Block 911 represents the iterative nature of method 900, i.e., that any number of model entities from this or another information management system (and/or cell) may be enforced. Consequently, control may pass back to block 603. In some embodiments, all entities in a certain information management cell are brought into conformance, whereas in some other embodiments, user interaction is required to conduct a more gradual entity-by-entity enforcement operation. In some embodiments, all entities across a plurality of information management cells are brought into conformance, whereas in some other embodiments, enforcement is conducted cell-by-cell and/or entity-by-entity. Any combination of these approaches is also possible within the scope of the present invention.

In alternative embodiments, method 900 may be differently organized, executed, sequenced, consolidated, sub-divided into sub-operations, and/or distributed for execution among different system modules and/or components and/or computing platforms. For example, in some embodiments, method 900 is executed by manager 201; or in part by manager 201 and in part by a storage manager 140; or is hosted by the same computing device/environment that hosts storage manager 140 and entity difference manager 201; or is executed in whole or in part by another component of an information management system, e.g., a secondary storage computing device 106, a client computing device 102; etc., without limitation. Any number, variations, and arrangements of the operations described herein may be implemented in connection with entity difference management system 200 within the scope of the present invention.

FIG. 10A depicts an exemplary visual presentation on display/user interface 507 that reports on an exemplary entity audit of entities that are storage policies, to identify divergences from a model storage policy. The information is illustratively presented in tabular form with additional drill-down detail illustrated in FIG. 10B.

Element 1003 depicts the type of entity being reported on, illustratively storage policies. As noted above, many other entities may be reported on according to the illustrative embodiment, e.g., data agents, media agents, clients, sub-clients, etc., without limitation.

Element 1005 identifies the information management cell 203 that comprises the model entity to be enforced. Illustratively “Cell#99” is the identifier of the cell having the model storage policy.

Element 1007 identifies the name of the model storage policy, e.g., “DedupeSP#1.”

Element 1009 identifies the type of storage policy being audited here. The type of storage policy being audited here is illustratively a deduplication type of policy, i.e., the exemplary audit and resultant report is limited here to storage policies of a certain type. Any number and type of storage policies may be reported on in a format like this one or in any other format; the report need not be segregated by type of storage policy like the format presented here. Likewise, the audit may include any number and types of entities.

Column 1010 lists the identifiers of the various information management cells being reported on, illustratively cell IDs Cell#1 through Cell#8. Notably, all these cells are distinct from the model cell, Cell#99; in other words, the model entity is configured in a different information management cell than the reported-on non-conforming (divergent) cells. In some embodiments, the model entity may be configured in the same information management cell as the non-conforming entity(ies).

Column 1011 provides a count of the number of corresponding entities (illustratively deduplication-type storage policies) that are configured to operate in each of the enumerated information management cells. For example, Cell#1 reportedly comprises 4 deduplication-type storage policies.

Column 1012 reports conformance information relative to the model entity, illustratively as a count of storage policies that underwent the conformance audit and came up as conforming with the model entity, illustratively reported on as having “Passed Audit.” Illustratively, no deduplication-type storage policies have passed the entity audit and therefore a value of zero is reported for every information management cell here.

Columns 1013 through 1017 report divergence (non-conformance) information relative to the model entity. Accordingly, column 1013 provides a count of the number of deduplication-type storage policies in each cell that diverge from the model entity in at least one “basic” operational property, illustratively not relating to deduplication or retention. Examples of “basic” operational properties include without limitation the number of device streams, the number of active copies, the use of alternate data path(s) when a resource is busy, etc. For example, all 27 deduplication-type storage policies in Cell#3 are non-conforming as to one or more “basic” operational properties. Column 1014 provides a count of the number of deduplication-type storage policies in each cell that diverge from the model entity in at least one operational property that relates to deduplication parameters. For example, all 27 deduplication-type storage policies in Cell#3 are non-conforming as to one or more deduplication-related operational properties. Column 1015 provides a count of the number of deduplication-type storage policies in each cell that diverge from the model entity in at least one operational property that relates to retention parameters. For example, 5 of 7 deduplication-type storage policies in Cell#5 are non-conforming as to one or more retention-related operational properties; however, in Cell#1 no divergence is reported as to retention. Column 1016 provides a count of the number of deduplication-type storage policies in each cell that diverge from the model entity in at least one operational property of any nature whatsoever. For example, in Cell#1, 4 deduplication-type storage policies are non-conforming as to one or more operational properties. Column 1017 reports the timestamp of the time when the information about the operational properties was last collected, e.g., by the storage manager 140 that manages the present information management system (and/or cell). As noted above, the information collection may be responsive to messages received from the entity difference manager 201.

Illustratively, the present report in FIG. 10A lacks the detail of an entity-by-entity analysis relative to the model entity. This detail is illustratively depicted in the next figure.

FIG. 10B depicts an exemplary visual presentation on display/user interface 507 that reports entity-by-entity details on non-conforming storage policies in a given information management cell, according to an exemplary entity audit. This report drills down from the one depicted in the previous figure, and provides additional detail regarding non-conforming storage policies in a certain cell.

Title block 1050 illustratively identifies details about the results reported in this presentation, such as the type of audit (“Non-conforming Storage Policies (Deduplication Type)”), Model Cell ID (“Cell#99”), Model Storage Policy (“DedupeSP#1”), and Current Cell ID (“Cell#5”).

Column 1052 lists the storage policies that are non-conforming, illustratively 5-dedupeSP#2, 5-dedupeSP#27, and 5-dedupeSP#28. These three storage policies were identified as non-conforming relative to the model storage policy DedupeSP#1 according to the illustrative audit.

Column 1053 lists the operational property of the non-conforming entity that has been identified as substantially different from the model entity's operational property. Here, “retention” is the operational property shown for storage policies 5-dedupeSP#2 and 5-dedupeSP#27; and “media library type” is the operational property shown for storage policy 5-dedupeSP#28.

Column 1054 lists the current value, i.e., the non-conforming value of the non-conforming operational property. Here, storage property 5-dedupeSP#2 has a value of “30 days” for the “retention” operational property, meaning that the data that is managed according to this storage policy is to be retained for 30 days. Storage policy 5-dedupeSP#27 has a value of “60 days” for the “retention” operational property. Storage policy 5-dedupeSP#28 has a value of “tape” for the property “media library type,” meaning that the type of media library that is specified in this storage policy is “tape.”

Column 1056 lists the model value for the respective non-conforming operational properties. Thus, the model value for the retention property (for this type of storage policy and according to the model storage policy) is “7 years.” The illustrative audit thus determined that 30 days and 60 days substantially differ from the model 7 years and thus flagged these two storage properties and this particular operational property as non-conforming. Likewise, the model value for the media library type for this type of storage policy is “disk.” The illustrative audit thus determined that “tape” substantially differs from the model value of “disk” and consequently flagged this storage policy and this particular operational property as non-conforming.

It is to be understood that FIGS. 10A and 10B depict only one possible example according to an exemplary embodiment, and that any number of variations in content, arrangement, and presentation are possible within the scope of the present invention. For example, in another embodiment there may be a different level of detail, or a different drill-down scheme, or a different way of categorizing the reported information, etc., without limitation.

FIG. 11A depicts an exemplary visual presentation on display/user interface 507 that reports on an exemplary audit of entities that are libraries, to identify divergence from a model library entity. The information is illustratively presented in tabular form with additional drill-down detail illustrated in FIG. 11B.

Element 1103 depicts the type of entity being reported on, illustratively libraries. As noted above, many other entities may be reported on according to the illustrative embodiment, e.g., storage policies, data agents, media agents, clients, sub-clients, etc., without limitation.

Element 1105 identifies the information management cell 203 that comprises the model entity to be enforced, i.e., the “model cell ID.” Illustratively “Cell#1” is the identifier of the cell having the model library.

Element 1107 identifies the name of the model library type, e.g., “disk.”

Element 1009 identifies a mount path that is the identifier for the model library, e.g., “E:\media.”

Column 1110, analogous to column 1010, lists the identifiers of the various information management cells being reported on here, illustratively cell IDs Cell#1 through Cell#3. Notably, Cell#1 is the same as the cell that comprises the model entity, while Cell#2 and Cell#3 are other cells.

Column 1111, analogous to column 1011, provides a count of the number of corresponding entities (illustratively here libraries) that are configured to operate in each of the enumerated information management cells. For example, Cell#1 reportedly comprises 6 libraries.

Column 1112, analogous to column 1012, reports conformance relative to the model entity, illustratively a count of libraries that underwent the conformance/divergence analysis and came up as conforming with the model entity, illustratively reported as having “Passed Audit.” Illustratively, one of the six libraries that are configured in Cell#1 has passed the audit and therefore a value of 1 is reported for Cell#1. Notably, Cell#1 is the information management cell that comprises the model entity, so the fact that only one entity is conforming means that the one conforming entity is one and the same with the model entity, and other library entities in this cell are non-conforming relative to (i.e., are divergent from) the model entity.

Columns 1113, 1114, 1116, and 1117, which are analogous to columns 1013, 1014, 1016, and 1017, respectively, report non-conformance relative to the model entity. Accordingly, column 1113 provides a count of the number of libraries configured in each cell that diverge from the model entity in at least one “general” operational property, illustratively not relating to mount path, which has its own column 1114. Examples of “general” operational properties include without limitation a low watermark percentage, a warning watermark percentage, whether a storage policy is to be automatically created for a new data path, whether to enable the library, etc. For example, 2 libraries in Cell#2 are non-conforming as to one or more “basic” operational properties. Column 1114 provides a count of the number of libraries in each cell that diverge from the model entity in regard to the mount path. For example, no libraries in Cell#1 are reported non-conforming as to mount path, and 2 libraries in Cell#2 are reported non-conforming as to the mount path. Column 1116 provides a count of the number of libraries in each cell that diverge from the model entity in at least one operational property of any nature whatsoever. For example, in Cell#1, 1 library is non-conforming as to one or more operational properties. Column 1117 reports the timestamp of the time when the information about the operational properties was last collected, e.g., by the storage manager that manages the present information management system (and/or cell). As noted above, the information collection may be responsive to messages received from the entity difference manager 201.

Illustratively, the present report in FIG. 11A lacks the detail of an entity-by-entity analysis relative to the model entity. This detail is illustratively depicted in the next figure.

FIG. 11B depicts an exemplary visual presentation on display/user interface 507 that reports entity-by-entity details on non-conforming libraries in a given information management cell, according to an exemplary entity audit. This report drills down from the one depicted in the previous figure, and provides additional detail regarding divergent (non-conforming) libraries in a certain cell.

Title block 1150, analogous to title block 1050, illustratively identifies details about the results reported in this presentation, such as the type of audit (“Non-conforming Libraries”), Model Cell ID (“Cell#1”), Model Library Type (“Disk”), Mount Path of the model entity (“E:\media), Current Cell ID (“Cell#3”) and Property Group (“Mount Path”). The latter, Property Group type Mount Path, indicates that the present drill-down report is particularly directed to Mount Path-related operational properties.

Column 1152, analogous to 1052, lists the library entities that are non-conforming, as shown. These seven libraries were identified as non-conforming from the model library according to the illustrative entity audit.

Column 1153 lists the mount path that is configured for each of the non-conforming libraries.

Column 1154 lists the operational property associated with the reported-on library that the audit identified as non-conforming relative to the model entity.

Column 1155 lists the current value, i.e., the non-conforming value, of the non-conforming operational property. For example, as to the first library, the “spill and fill mount paths” property is configured to a value of “yes,” which is reported as non-conforming from the model value of “no” shown in column 1156. In other words, “spill and fill” should not be used according to the model entity.

Column 1156 lists the model value for the respective non-conforming operational properties. Thus, the model value for the first reported-on library's spill and fill property is “no,” which is different from the configured value of “yes” shown in column 1155.

It is to be understood that FIGS. 11A and 11B depict only one possible example according to an exemplary embodiment, and that any number of variations in content, arrangement, and presentation are possible within the scope of the present invention. For example, in another embodiment there may be a different level of detail, or a different drill-down scheme, or a different way of categorizing the reported information, etc., without limitation.

FIG. 12 depicts an exemplary visual presentation on display/user interface 507 that reports on an exemplary audit of entities that are media agents, to identify divergence from a model media agent entity. The information is illustratively presented in tabular form.

Element 1203 depicts the type of entity being reported on, illustratively media agent. As noted above, many other entities may be reported on according to the illustrative embodiment, e.g., storage policies, data agents, libraries, clients, sub-clients, etc., without limitation.

Element 1205 identifies the information management cell 203 that comprises the model entity to be enforced, i.e., the “model cell ID.” Illustratively “Cell#99” is the identifier of the cell having the model media agent.

Element 1207 identifies the name of the model media agent type, e.g., “SnapMA#1.”

Column 1210, analogous to column 1010, lists the identifiers of the various information management cells being reported on here, illustratively cell IDs Cell#1 through Cell#4. Notably, Cell#99 that comprises the model entity is different from the reported-on cells.

Column 1211, analogous to column 1011, provides a count of the number of corresponding entities (illustratively here media agents) that are configured to operate in each of the enumerated information management cells. For example, Cell#1 reportedly has 1 media agent configured, as do all the other reported-on cells.

Column 1212, analogous to column 1012, reports conformance relative to the model entity, illustratively a count of media agents that underwent the conformance/divergence analysis and came up as conforming with the model entity, illustratively reported as having “Passed Audit.” Illustratively, none of the audited media agents are conforming.

Columns 1213 through 1218 report divergence information relative to the model entity. Accordingly, column 1213 provides a count of the number of media agents configured in each cell that diverge from the model entity in at least one “basic” operational property, illustratively not relating to index cache, firewall, or network throttle, each of which has its own column 1214, 1215, and 1216, respectively. Examples of “basic” operational properties include without limitation whether to use a native device driver for data transfer for media, the media agent version, etc. For example, every media agent is non-conforming as to one or more “basic” operational properties. Column 1214 provides a count of the number of media agents in each cell that diverge from the model entity in regard to the index cache (e.g., none are reported non-conforming). Column 1215 provides a count of the number of media agents in each cell that diverge from the model entity in regard to the firewall (e.g., none are reported non-conforming). Column 1216 provides a count of the number of media agents in each cell that diverge from the model entity in regard to the network throttle settings (e.g., none are reported non-conforming). Column 1217 provides a count of the number of libraries in each cell that diverge from the model entity in at least one operational property of any nature whatsoever (e.g., every media agent). Column 1218 reports the timestamp of the time when the information about the operational properties was last collected, e.g., by the storage manager that manages the present information management system (and/or cell). As noted above, the information collection may be responsive to messages received from the entity difference manager 201.

It is to be understood that FIG. 12 depicts only one possible example according to an exemplary embodiment, and that any number of variations in content, arrangement, and presentation are possible within the scope of the present invention. For example, in another embodiment there may be a different level of detail, or an associated drill-down scheme, or a different way of categorizing the reported information, etc., without limitation. Furthermore, any number of variations on the reporting scheme associated with the conformance/divergence analysis described herein may be devised, all within the scope of the present invention.

Moreover, although a user-controlled enforcement protocol is not illustrated in the figures herein, it is to be understood that enforcing conformance with respect to one or more model entities may be implemented according to user input and/or may be automatically based on the outcome of an entity audit, the audit executing automatically and/or executing on demand according to user input. Thus, a user may configure one or more information management cells and/or information management systems that are managed by a respective storage manager to execute an entity audit at a periodic interval and to flag non-conformances to be reviewed and approved by a user. In some embodiments, it may be possible that the nature of some divergences (e.g., retention time) is such that they may be automatically reconfigured to comply with a model entity without user intervention. Some divergences may require pro-active user intervention and should not be automatically reconfigured. In some embodiments, the user may activate an automatic enforcement protocol via the entity difference manager 201. In some embodiments, the user may activate enforcement on demand on a cell-by-cell basis, on an entity-by-entity basis, or according to groupings of entities, operational properties, information management systems (and/or cells), and/or any combination thereof. Many variations of implementing the enforcement of a model entity's relevant operational properties across one or more information management cells may be devised within the scope of the present invention, with many degrees of user involvement in setting up, triggering, and/or approving the necessary reconfigurations of entities to achieve conformance with the model entity(ies).

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other suitable interfaces.

Further, the processing of the various components of the illustrated systems can be distributed across multiple machines, networks, and other computing resources. In addition, two or more components of a system can be combined into fewer components. Various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flow chart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application, in either this application or in a continuing application.

What is claimed is:

1. A method comprising:
controlling a plurality of entities that operate in an information management system, by a storage manager that manages the information management system, to operate according to preferred operational properties of a model entity, wherein the controlling is based on a determination, by an entity difference manager that is communicatively coupled to the storage manager, that prior to the determination the plurality of entities were operating in the information management system according to one or more respective operational properties that substantially differed from the operational properties of the model entity; and
wherein the controlling comprises:
receiving, by the storage manager from the entity difference manager, one or more instructions directing the storage manager to reconfigure the plurality of entities to operate according to the operational properties of the model entity, and
reconfiguring, by the storage manager in response to the one or more instructions, the plurality of entities to operate according to the operational properties of the model entity.

2. The method of claim 1 wherein the model entity is configured to operate in one of (i) the information management system, and (ii) another information management system that is managed by a second storage manager that is communicatively coupled to the entity difference manager.

3. The method of claim 1 wherein after the reconfiguring, the second entity operates according to the same operational properties as the model entity.

4. The method of claim 1 wherein the model entity is an information management cell that comprises the storage manager.

5. The method of claim 1 wherein the model entity is a storage manager other than the storage manager that managers the information management system.

6. The method of claim 1 wherein the model entity is an information management policy.

7. The method of claim 1 wherein the model entity is a storage policy.

8. The method of claim 1 wherein the information management system comprises a secondary storage subsystem, and further wherein the model entity is an element of the secondary storage subsystem.

9. The method of claim 1 wherein the model entity is a secondary storage device.

10. The method of claim 1 wherein the model entity is a client.

11. The method of claim 1 wherein the model entity is a sub-client.

12. The method of claim 1 wherein the model entity is a data agent.

13. A method comprising:
reconfiguring, by a storage manager as instructed by an entity difference manager, a second entity in an information management system, wherein the information management system is managed by the storage manager and comprises a secondary storage subsystem;
wherein the reconfiguring is based on a first operational property of a first entity that is designated a model entity;
wherein the reconfiguring comprises:
receiving, by the storage manager, an instruction from the entity difference manager directing the storage manager to reconfigure the second entity, and
based on the received instruction, changing, by the storage manager, a second operational property of the second entity to match the first operational property of the model entity; and
wherein the model entity is configured to operate in one of (i) the information management system, and (ii) another information management system that is managed by another storage manager that is communicatively coupled to the entity difference manager.

14. The method of claim 13 wherein the reconfiguring further comprises:
extracting, by the storage manager, based on one or more messages received from the entity difference manager, information about one or more operational properties of the second entity, and
transmitting, by the storage manager, the extracted information to the entity difference manager.

15. The method of claim 14 wherein the extracting comprises polling the second entity for the information about the one or more operational properties of the second entity.

16. The method of claim 13 wherein the model entity is an element of the secondary storage subsystem.

17. A system comprising:
an entity difference manager that is communicatively coupled to one or more storage managers, wherein each storage manager manages a respective information management system that comprises a secondary storage subsystem;
a data store associated with the entity difference manager, wherein the data store comprises information about one or more operational properties of one or more entities that are operating in the one or more respective information management systems;
wherein the entity difference manager comprises an analysis module that is configured to:
designate a first entity as a model entity that is configured to operate according to one or more preferred operational properties,
obtain, from the data store, one or more operational properties of a second entity that has been operating in the information management system, and
determine that the second entity is a non-conforming entity that has been operating in the respective information management system according to one or more operational properties that substantially differ from the one or more preferred operational properties of the model entity; and
wherein the entity difference manager is configured to direct the storage manager that manages the information management system comprising the non-conforming entity that the non-conforming entity is to be reconfigured to operate according to the one or more preferred operational properties of the model entity.

18. The system of claim 17 further comprising a user interface unit that is communicatively coupled to the entity difference manager, wherein, based on a user input received via the user interface unit, the analysis module is configured to designate the first entity as the model entity.

19. A system comprising:
an entity difference manager;
a storage manager that manages an information management system comprising a secondary storage subsystem, wherein the storage manager is communicatively coupled to the entity difference manager;
wherein the entity difference manager is configured to:
determine that the information management system comprises a non-conforming entity that operates according to operational properties that substantially differ from preferred operational properties of a model entity, and
instruct the storage manager to reconfigure the non-conforming entity to operate according to the preferred operational properties of the model entity; and
wherein the storage manager is configured to change the one or more operational properties of the non-conforming entity to match the one or more preferred operational properties of the model entity in response to one or more instructions received from the entity difference manager.

20. The system of claim 19 wherein the model entity is configured to operate in a different information management system from the information management system that comprises the non-conforming entity.
